(19) United States
(12) Patent Application Publication
(10) Pub. No.: US 2011/0311738 A1
(43) Pub. Date: Dec. 22, 2011

(54) Process of producing cellulose acylate film, cellulose acylate film, polarizing plate liquid crystal display device and optical compensation film

(75) Inventors: Shigeaki Nimura, Kanagawa (JP); Ryo Nakamura, Kanagawa (JP); Hiroko Kamee, Kanagawa (JP); Kentaro Toyooka, Kanagawa (JP); Hiroshi Sato, Kanagawa (JP); Megumi Sekiguchi, Kanagawa (JP); Yukito Saitoh, Kanagawa (JP); Akira Yamamoto, Kanagawa (JP); Michio Nagai, Kanagawa (JP)

(73) Assignee: FUJIFILM Corporation, Tokyo (JP)

(21) Appl. No.: 13/067,673

(22) Filed: Jun. 20, 2011

(30) Foreign Application Priority Data
Jun. 21, 2010 (JP) 2010-140195
Aug. 27, 2010 (JP) 2010-190814
Dec. 1, 2010 (JP) 2010-268493

(51) Int. Cl. C09K 19/00; G02B 5/30; C08B 3/00; B29D 7/01; C08K 5/05

(52) U.S. Cl. 428/1.31; 264/212; 428/1.3; 524/379; 536/63; 359/489.07

(57) ABSTRACT

A process of producing a cellulose acylate film is disclosed. The process comprises a forming step of forming a web of a fluid, comprising a cellulose acylate, aromatic group-containing oligomer and solvent, by casting the fluid onto a support, a stretching step of stretching the web, thereby to align molecules of the aromatic group-containing oligomer along the stretching direction, and a heat-treatment step of subjecting the stretched web to a heat treatment, thereby to at least increase the alignment degree of molecules of the aromatic group-containing oligomer.

### CROSS-REFERENCE TO RELATED APPLICATIONS

The present application claims the benefit of priorities from Japanese Patent Application Nos. 2010-140195, filed on Jun. 21, 2010, 2010-190814, filed on Aug. 27, 2010, and 2010-268493, filed on Dec. 1, 2010, the contents of which are herein incorporated by reference in their entirety.

### BACKGROUND OF THE INVENTION

1. Field of the Invention

The present invention relates to a process of producing cellulose acylate films. The cellulose acylate films, prepared according to the process, show high Re and Rth by being subjected to a stretching treatment with a low stretching ratio, which are useful as optical elements in liquid crystal displaying devices employing any mode.

2. Background Art

Cellulose acylate films have been used as an optical element in liquid crystal displaying devices such as a support of an optical compensation film and a protective film of a polarizing plate. Controlling optical anisotropy of the film to be used as the optical element is important. On the other hand, the optical properties achieved by cellulose acylate alone may be limited, and practically, high Re and Rth have been achieved by carrying out addition of any Re enhancer and any stretching treatment. However, in the method, the stretching treatment with a high stretching ratio is necessary for achieving high Re and Rth, which may result in lowering the surface or axis properties of the films. Furthermore, for carrying out the method, a large amount of equipment investment such as an on-line stretching machine may be necessary. And usually, the additive is selected from low-molecular weight compounds, and such the additive is sometimes volatilized or exuded from the films during the preparing process when the stretching temperature is raised for a stretching treatment with a high stretching ratio.

Films to be used in optical applications are required to show not only good optical properties but also good surface properties without surface unevenness. For achieving the improvement in the surface properties of the cellulose acylate films, phosphoric plasticizers such as triphenyl phosphate have been used. However, the phosphoric plasticizers are sometimes exuded from the films during the preparing process. JP-A-2010-107960 discloses a process of preparing a transparent polymer film whose retardation is controlled by addition of the plasticizer having the number-averaged molecular weight of from 500 to 1000. The process contains the step of performing the heat treatment at a temperature equal to or higher than the crystallization temperature of the film which is not subjected to the heat treatment yet.

### SUMMARY OF THE INVENTION

As described in JP-A-2010-107960, [0174] or the like, according to the process described in the document, retardation of the polymer film is controlled by performing the heat treatment at a temperature equal to or higher than Tc (the crystallization temperature), and promoting the crystallization of the cellulose acylate. For controlling retardation by crystallization of cellulose acylate, it is necessary to perform the heat treatment at a high temperature equal to or higher than the crystallization temperature. However, there is the limitation of the temperature in the inline operation, and therefore, sometimes, it is difficult to prepare the films having high Re and Rth according to the process

One object of the present invention is to provide a novel process for producing cellulose acylate films, whose retardation is controlled, without any step of stretching treatment with a high-stretching ratio and any step of the crystallization of the cellulose acylate, and to provide also a cellulose acylate film prepared according to the process, and a polarizing plate, liquid crystal displaying device and optical compensation film having the same.

Under the above circumstances, the present inventors conducted various studies, and as a result, they found that, by using an aromatic group-containing oligomer as a plasticizer and by using the alignment of the oligomer molecules positively, a cellulose acylate film having the optical properties which were not obtained easily was prepared stably. On the basis of this finding, the present invention was made.

The means for achieving the object are as follows.

[1] A process of producing a cellulose acylate film comprising a forming step of forming a web of a fluid, comprising a cellulose acylate, aromatic group-containing oligomer and solvent, by casting the fluid onto a support, a stretching step of stretching the web, thereby to align molecules of the aromatic group-containing oligomer along the stretching direction, and a heat-treatment step of subjecting the stretched web to a heat treatment, thereby to at least increase the alignment degree of molecules of the aromatic group-containing oligomer.
[2] The process of [1], wherein the aromatic group-containing oligomer is a polycondensation ester comprising a residue of aromatic dicarboxylic acid and a residue of aliphatic diol.
[3] The process of [1] or [2], wherein the number-averaged molecular weight of the aromatic group-containing oligomer is from 500 to 2000.
[4] The process of any one of [1]-[3], wherein the fluid comprises the aromatic group-containing oligomer in an amount of from 3 to 20 parts by mass with respect to 100 parts by mass of the cellulose acylate.
[5] The process of any one of [1]-[4], wherein, in the stretching step, the web having a residual solvent content of from 20 to 300% by mass is stretched at a film-surface temperature of from −30 to 80 degrees Celsius.
[6] The process of any one of [1]-[5], wherein, in the heat-treatment step, the web having a residual solvent amount of from 10 to 120% by mass is subjected to a heat treatment at a film-surface temperature of from 40 to 200 degrees Celsius.
[7] The process of any one of [1]-[6], wherein, in the stretching step, the web is stretched at a stretching ratio of from 1 to 50%.
[8] The process of any one of [1]-[7], wherein the fluid is cast onto a surface of a drum.
[9] The process of any one of [1]-[8], wherein, in the stretching step, the web is stretched along a casting direction and a direction perpendicular to the casting direction.
[10] The process of any one of [1]-[9], wherein the web is not subjected to any stretching treatment after the stretching step.
[11] The process of any one of [1]-[10], wherein the fluid comprises a retardation-controlling agent having an absorption peak at a wavelength of from 250 to 400 nm in an amount of from 0.2 to 20% by mass.
[12] The process of [11], wherein the retardation-controlling agent is a merocvanine compound represented by formula (IX):

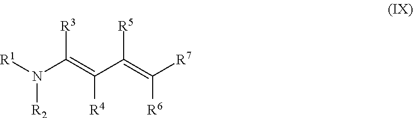

where, in formula (IX), N represents a nitrogen atom; and R¹-R⁷ respectively represents a hydrogen atom or substituent.

[13] The process of [12], wherein the merocyanine compound represented by formula (IX) is used as a mixture with any compound(s) represented by formula (IXa-a), (IXa-b), (IXa-c) or (IXa-d):

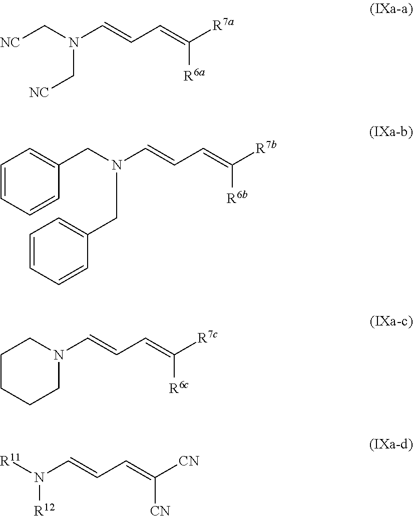

where, in formula (IXa-a), R^{6a} and R^{7a} respectively represent a hydrogen atom or substituent; in formula (IXa-b), R^{6b} and R^{7b} respectively represent a hydrogen atom or substituent; in formula (IXa-c), R^{6c} and R^{7c} respectively represent a hydrogen atom or substituent; in formula (IXa-d), R¹¹ and R¹² respectively represent an alkyl, aryl, cyano, or COOR¹³ where R¹³ represents an alkyl group, aryl group or heterocyclic group; or R¹¹ and R¹² may bond to each other to form a ring containing a nitrogen atom.

[14] The process of any one of [1]-[13], wherein the fluid comprises a triazine compound represented by formula (II).

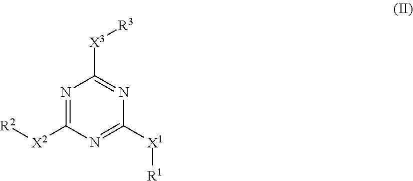

where, in formula (II), X¹ represents —NR⁴—, —O— or —S—; X² represents —NR⁵—, —O— or —S—; X³ represents —NR⁶—, —O— or —S—; R¹, R², and R³ respectively represent an alkyl group, an alkenyl group, an aryl group or a heterocyclic group; and R⁴, R⁵ and R⁶ respectively represent a hydrogen atom, an alkyl group, an alkenyl group, an aryl group or a heterocyclic group.

[15] A cellulose acylate film produced according to process of any one of [1]-[14], of which retardation in plane at 550 nm wavelength, Re(550)m, is from 5 to 50 nm and retardation along the thickness direction at 550 nm wavelength, Rth(550), is from 90 to 150 nm.
[16] A cellulose acylate film produced according to process of any one of [1]-[14], of which retardation in plane at 550 nm wavelength, Re(550)m, is from 5 to 20 nm and retardation along the thickness direction at 550 nm wavelength, Rth(550), is from 90 to 150 nm.
[17] The cellulose acylate film of [15] or [16], having a long direction, in which cellulose acylate molecules are aligned along the long direction.
[18] The cellulose acylate film of any one of [15] to [17], of which retardation along the thickness direction at 550 nm wavelength, Rth(550)ₘ, and retardation along the thickness direction at 450 nm wavelength, Rth(450), fulfill the condition of (1) below:

0.90<Rth(450)/Rth(550)≦1.5 (1)

[19] A polarizing plate comprising a polarizer and a cellulose acylate film of any one of [15]-[18].
[20] The polarizing plate of [19], wherein an absorption axis of the polarizer is perpendicular to a slow axis of the cellulose acylate film.
[21] A liquid crystal displaying device comprising a cellulose acylate film of any one of [15]-[18] and/or a polarizing plate of [19] or [20].
[22] The liquid crystal displaying device of [21], employing a twisted alignment or vertical alignment mode.
[23] An optical compensation film comprising a cellulose acylate film of any one of [15]-[18], and an optically anisotropic layer formed of a composition comprising a polymerizable liquid crystal compound.

### BRIEF DESCRIPTION OF THE DRAWINGS

FIG. 1 is a schematic cross-sectional view of one example of the twisted alignment-mode liquid crystal display device having the cellulose acylate film of the invention.

FIG. 2 is a schematic cross-sectional view of one example of the vertical alignment-mode liquid crystal display device having the cellulose acylate film of the invention.

In the drawing, the reference numerals and signs have the following meanings.
10, 10′ Liquid crystal cell
12a, 12b Optically anisotropic layer
14a, 14a′, 14b, 14b′ Inner protective film of Polarizing plate
16a, 16b Optical compensation film
18a, 18b Linear polarizing film
20a, 20b Outer protective film of Polarizing plate
22a, 22b Elliptical polarizing plate

### DETAILED DESCRIPTION OF THE INVENTION

The process of producing cellulose acylate films of the invention and the cellulose acylate film produced according to the process are described in detail hereinunder. The scope of the present invention is, not limited to the specific embodiments described below even if the following description is on the basis of the specific embodiment. In this description, the numerical range expressed by the wording “a number to another number” means the range that falls between the former number indicating the lowermost limit of the range and the latter number indicating the uppermost limit thereof.

In this description, Re(λ) and Rth(λ) are retardation (nm) in plane and retardation (nm) along the thickness direction, respectively, at a wavelength of λ. And if there is no specific indication, “Re” and “Rth” represent Re(550) and Rth (550) respectively.

### 1. Process of Producing Cellulose Acylate Film

One embodiment of the process of the invention comprises:

a forming step of forming a web of a fluid, comprising a cellulose acylate, aromatic group-containing oligomer and solvent, by casting the fluid onto a support,

a stretching step of stretching the web, of which residual solvent content C1 is from 20 to 300% by mass, thereby to align molecules of the aromatic group-containing oligomer along the stretching direction, and a heat-treatment step of subjecting the stretched web, of which residual solvent content C2 (C1<C2) is from 10 to 120% by mass, to a heat treatment at a film-surface temperature of from 40 to 200 degrees Celsius, thereby to increase the alignment degree of molecules of the aromatic group-containing oligomer and align molecules of the cellulose acylate along the stretching direction.

According to the process of the invention, in the stretching step, molecules of the aromatic group-containing oligomer are aligned along the stretching direction; and in the heat-treatment step, molecules of the cellulose acylate are aligned along the stretching direction with increasing the alignment degree of molecules of the aromatic group-containing oligomer while the crystallization of the cellulose acylate is suppressed. Although the films, having high Re and Rth, can not be prepared easily according to the previous method controlling retardation by promoting the crystallization of the cellulose acylate or by promoting the alignment of the retardation enhancer with the in-line stretching treatment, such films can be prepared stably according to the process of the invention.

Heating at a certain high temperature for a long period is necessary for the crystallization of the cellulose acylate. Therefore, the previous method promoting the crystallization of the cellulose acylate is inefficient in terms of the energy consumption, or suffers from volatilization of the additive(s). According to the process of the invention, the crystallization of the cellulose acylate is not needed, and the heat-treatment is carried out for increasing the alignment degree of the oligomer molecules, which have been aligned in the stretching step, while suppressing the crystallization. Therefore, the heat-treatment may be carried out at a temperature lower than that in the previous method promoting the crystallization. The present invention may be efficient in terms of the energy consumption, and may not suffer from volatilization of the additive(s).

Each of the steps included in the process of the invention is described in detail.

### Casting Step:

According to the present invention, a fluid (occasionally referred to as “dope” hereinafter) containing a cellulose acylate, aromatic group-containing oligomer and solvent is prepared, and is cast onto a support to form a web. According to the process of the invention, the cellulose acylate film containing the cellulose acylate as a main ingredient and the aromatic group-containing oligomer as an additive is produced. The cellulose acylate and aromatic group-containing oligomer which can be used in the invention will be described in detail later. And, in the description, the term “web” means a cellulose acylate film, containing any solvent in a certain amount, which is obtained till the solvent therein is removed completely after the casting step.

In the casting step, for example, the dope extruded from a slit of a ca sting die is cast onto a support. The support may have a belt- or drum-form. The dope may be cast onto the surface of the support moving along the ca sting direction. In the casting step, the force along the casting direction is applied to the dope, and, therefore, molecules of the cellulose acylate and the aromatic group-containing oligomer in the dope tend to align along the casting direction in a certain degree. The degree of the force applied to the molecules during casting can be known by using the value (referred to as “PIT-draw” (unit:%)), calculated by the following equation defined with the belt- or drum-rotation rate (support rate) and the feeding rate of the web (web-forming rate), as an indicator.

PIT-draw=the web-forming rate/the support rate

According to the process of the invention, in the stretching step, the oligomer is aligned along the stretching direction. Therefore, in the embodiment in which the casting direction (occasionally referred to as “machine direction” or “MD” in the description) is not same as the stretching direction, or, for example, in the embodiment in which the casting direction is perpendicular to the stretching direction, preferably, the casting step is carried out under the condition which allows the force applied to the material to be lowered. More specifically, the PIT-draw is preferably from about 101% to about 110%, or more preferably from about 101% to about 105%. On the other hand, in the embodiment in which the casting direction is same as the stretching direction, the PIT-draw is not limited.

The support onto which the dope is cast is preferably a metal support such as a metal band and a metal drum. According to the invention, it is possible to produce the film having the preferred optical properties with a high productivity by using a drum as a support.

In the casting step, the dope may be cast onto the support in a single-layered form, or, if desired, one or more kinds of the dopes may be cast onto the support in a multi-layered form. In the latter embodiment, the above-described dope and one or more kinds of other dopes may be extruded from a plurality of casting slots that is separated from each other with a distance along the moving direction of the support, and be cast onto the support in a multi-layered form. The casting may be performed according to the method described in JP-A No. 61-158414, 1-122419, or 11-198285. The above-described dope and one or more kinds of other dopes may be extruded from a plurality of casting slits, and be cast onto the support in a multi-layered form. The casting may be carried out according to the method described in JPB No. syo 60-27562, JPA Nos. syo 61-94724, syo 61-947245, syo 61-104813, syo 61-158413 or hei 6-134933. Further, the embodiment in which a flow of a highly viscous polymer solution is enclosed in a polymer solution having a lower viscosity and in which the polymer solutions of high and low viscosities are simultaneously extruded is preferable. The method is described in JPA No. syo 56-162617. Another preferable embodiment relates to that a solution for the outer layer has a larger content of an alcoholic component, which is a poor solvent, than a solution for the inner layer has, as described in JP-A Nos. 61-94724 and 61-94725. The embodiment using two casting slits may be used, wherein a film formed on a metal support through a first casting port is peeled off, and casting is then carried out through a second casting port onto the film on the side thereof previously in contact with the metal support. The method is described, for example, in JP-A No. 44-20235.

In the embodiment wherein the dopes are cats onto the support in a multi-layered form, each of the dopes may be selected depending on the function of each of the layers for allowing each of the layers to show the function. The dopes to form functional layers such as an adhesive layer, dye layer, antistatic layer, anti-halation layer, UV absorption layer and polarizing layer may be cast at the same time.

In the embodiment wherein a plurality of dopes are cast through the casting slits, it possible to extrude a high-viscosity solution at the same time onto the support, and this not only made it possible to fabricate an excellent planar film improved in the planarity, but also to reduce drying load through use of the dense dope, to thereby raise the production speed.

In the embodiment employing a co-casting, the thicknesses of the inner and outer layers are not limited. The thickness of the outer layer is preferably from 1 to 50% or more preferably from 2 to 30% with respect to the total thickness of the web.

For any web having three or more layers prepared according to a co-casting method, the thickness of the outer layer is defined as the total thickness of the layer adjacent to a support and the layer adjacent to the air. In the embodiment employing a co-casting, the dopes in which an amount of the additive such as the predetermined plasticizer, any UV absorber and any matting agent is different from each other may be co-cast to form a multi-layered cellulose acylate film. For example, a cellulose acylate film having a configuration of skin layer/core layer/skin layer may be produced. For example, a larger amount of the matting agent may be contained in the skin layer, or it may be contained only in the skin layer. Larger amounts of the plasticizer and the UV absorber may be contained in the core layer than in the skin layer, and they may be contained only in the core layer. Species of the UV absorber may be varied between the core layer and the skin layer. For example, the skin layer may be added with a low-volatile plasticizer and/or UV absorber, and the core layer may be added with a plasticizer excellent in plasticity or with a UV absorber excellent in UV absorption property. Also addition of a releasing agent only to the skin layer on the metal substrate side is a preferable embodiment. In the cooling drum process, it is also allowable to add a larger amount of alcohol, which is a poor solvent, to the skin layer than to the core layer, in order to cool the metal support to thereby gellate the solution. The skin layer and the core layer may have different Tg values, wherein it is preferable that Tg of the core layer is lower than Tg of the skin layer. Also viscosity of the solution containing cellulose acylate during casting may differ between the skin layer and the core layer, wherein the viscosity of the skin layer is preferably smaller than the viscosity of the core layer, but the viscosity of the core layer may be smaller than the viscosity of the skin layer.

### Stretching Step:

Next, the web is stretched, thereby to align at least molecules of the aromatic group-containing oligomer along the stretching direction. In the stretching step, the residual solvent content, C1, of the web is preferably from 20 to 300% by mass. The residual solvent content of a web can be calculated according to the following formula. The residual solvent content in the heat-treatment step, described below, can be calculated in the same manner.

Residual Solvent Content (% by mass)={(M−N)/N}×100

[In the formula, M means the mass of the web just before inserted into the stretching zone; and N means the mass of the web just before inserted into the stretching zone, dried at 120 degrees Celsius for 2 hours].

By stretching the web having the residual solvent content C1 falling within the above described range and containing a large amount of solvent, the oligomer, which is contained in the web as an additive, is aligned on some level so that the long axes of the molecules are along with the stretching direction. If the residual solvent content C1 is more than 300% by mass, the molecules of the oligomer tend not to be aligned, or if the residual solvent content C1 is less than 20% mass, stretching the web becomes difficult due to hardness of the web. The residual solvent content C1 is preferably from 20 to 250% by mass, or more preferably from 20 to 150% by mass.

In the heat-treatment described later, the alignment degree of molecules of the oligomer is increased, and therefore, the stretching ratio in the stretching step may be decided so as to align molecules of the oligomer in some level. In the embodiment stretching the web along the direction perpendicular to the casting direction, the stretching ratio is preferably from 1 to 50%, or more preferably from 1 to 20%. In the embodiment stretching the web along the casting direction, the stretching ratio is preferably from 1 to 300%, or more preferably from 1 to 200%.

The “stretching ratio (%)” as referred to herein means one obtained according to the following formula. However, the calculation method is not limited to methods measuring the length directly, and other methods may be used as far as the obtained data are almost equal to those obtained according to the following formula.

Stretching Ration (%)=100×{(length after stretching)−(length before stretching)}/(length before stretching).

The temperature in the stretching step is not limited. The stretching step is preferably carried out under condition capable of promoting the alignment of the oligomer molecules along the stretching direction. Usually, the stretching step is preferably carried out at the film-surface temperature of from −30 to 80 degrees Celsius, or more preferably from 25 to 80 degrees Celsius.

According to the process of the invention, the direction of the alignment of the cellulose acylate molecules and the oligomer molecules (or the slow axis of the film) is decided depending on the stretching direction in the stretching step. In the embodiment producing a long cellulose acylate film continuously, the casting direction is the long direction. If the stretching is carried out along the direction perpendicular to the casting direction (occasionally the direction perpendicular to the casting direction is referred to as “TD”), the cellulose acylate molecules and the oligomer molecules are aligned along the direction perpendicular to the long direction, and therefore, the long film having the slow axis perpendicular to the long axis can be produced. If the stretching is carried out along the casting direction, the cellulose acylate molecules and the oligomer molecules are aligned along the long direction, and therefore, the long film having the slow axis along the long axis can be produced.

The TD stretching may be performed according to the manner that both edges of the web are grasped with pins and stretched in the width direction. The MD stretching may be performed by the PIT-draw. The stretching treatment may be carried out in one stage or two stages.

If a long film is combined with a long polarizing film (usually, having a transmission axis) to give a polarizing plate, the film having the slow axis along the direction perpendicular to the long axis is preferably used. Therefore, in the embodiment producing a long cellulose acylate to be combined with a polarizing film according to a roll-to-roll manner, the stretching along direction perpendicular to the casting direction is preferable. However, in the embodiment producing a long cellulose acylate to be combined with a polarizing film according to another manner such as a batch manner, combining can be performed with the preferred relation between the axes by using any long film stretched along any direction.

### Heat-Treatment Step:

Next, the stretched web is subjected to a heat treatment. The alignment degree of the oligomer molecules is increased by the heat-treatment. The heat-treatment may be carried out under any condition as far as the alignment degree is increased. Major factors influencing the alignment of the oligomer molecules during the heat-treatment are the film-surface temperature of the web at the heat-treatment and the residual solvent content of the web at the heat-treatment. One example of the condition under which the heat-treatment is carried out to increase the alignment degree of the oligomer molecules stably is that the residual solvent content C2 is from 10 to 120% by mass and the film-surface temperature is from 40 to 200 degrees Celsius. The residual solvent content C2 is preferably from 10 to 120% by mass on the basis that the residual solvent content C2 at the heat-treatment is smaller than the residual solvent content C1 at the stretching step, or on the basis that the relation of C2≦C1 is satisfied. If the residual solvent content C2 is more than 120% by mass or less than 10% by mass, the alignment degree of the oligomer molecules is increased hardly, which may not achieve the desired retardation. The residual solvent content C2 is preferably from 20 to 80% by mass, or more preferably from 20 to 60% by mass.

Preferably, the heat-treatment is carried out while suppressing the crystallization of the cellulose acylate. Therefore, preferably, the heat-treatment is carried out at the temperature lower than that of the heat-treatment for promoting the crystallization of the cellulose acylate; and more specifically, the heat-treatment is preferably carried out at the film-surface temperature of the web of from 40 to 100 degrees Celsius or more preferably from 60 to 100 degrees Celsius.

For suppressing the crystallization of the cellulose acylate, the film-surface temperature at the heat-treatment is preferably less than the temperature at which the web before being subjected to the heat-treatment starts to be crystallized.

The heat-treatment may be carried out as follows: the web is allowed to go through the zone which is kept at a predetermined temperature while the web is fed; the web is applied with heat-wind at a predetermined temperature; the web is irradiated with heat ray; or the web is allowed to contact a roll having a predetermined temperature.

According to the invention, cellulose acylate films having the above-described optical properties can be produced without any stretching step after the heat-treatment step, and therefore, long films can be produced continuously with a few numbers of steps for a short period by using a drum as a casting support. According to the invention, films may be produced also in the in-line manner, which may improve the productivity remarkably.

According to one example, cellulose acylate films having high Re and Rth can be produced in the in-line manner with the PIT-draw of from 101 to 200% and with the support rate of from 50 to 200 m/minute, without addition of any additive influencing the optical properties other than the oligomer.

After the heat-treatment, the cellulose acylate film may be subjected to at least one treatment such as a stretching treatment, another heat-treatment and surface treatment as far as the effect of the invention is not lowered.

Next, preparation of the dope to be used in the casting step is described in detail.

The dope to be used in the casting step contains cellulose acylate, aromatic group-containing oligomer and solvent. The cellulose and the oligomer are preferably dissolved in the solvent. The concentration of the cellulose acylate in the dope is preferably from 5 to 40% by mass, more preferably from 10 to 30% by mass or even more preferably from 15 to 30% by mass. The concentration of the cellulose acylate may be adjusted to the preferred range when the cellulose acylate is dissolved in the solvent. A solution having a low concentration (for example from 4 to 14% by mass) may be prepared once, and then, the solution may be condensed by evaporation of the solvent. Or a solution having a high concentration may be prepared once, and then, the solution may be diluted. The concentration of the oligomer is preferably from 0.5 to 4% by mass, or more preferably from 1 to 3% by mass.

Next, each of the ingredients which can be used in the invention is de scribed in detail.

### Solvent:

For preparing the dope to be used in the casting step, one or more kinds of solvents may be used. The main solvent to be used for preparing the dope is preferably selected from the good organic solvents for the cellulose acylate(s). Such an organic solvent preferably has the boiling point of equal to or lower than 80 degrees Celsius in terms of reducing burden during drying. Preferably, the boiling point of the solvent is from 10 to 80 degrees Celsius, or of from 20 to 60 degrees Celsius. In some cases, the main solvent may be selected from the organic solvents having the boiling point of from 30 to 45 degrees Celsius. In the invention, a solvent system containing a solvent having a small degree of vaporization and capable of being gradually concentrated and having a boiling point of not lower than 95 degrees Celsius along with a halogenated hydrocarbon therein in an amount of from 1 to 15% by mass, preferably from 1 to 10% by mass, more preferably from 1.5 to 8% by mass of all the solvent system is preferably used. The solvent having a boiling point of not lower than 95 degrees Celsius is preferably a poor solvent for cellulose acylate. Specific examples of the solvent having a boiling point of not lower than 95 degrees Celsius include those having a boiling point of not lower than 95 degrees Celsius of the solvents to be mentioned below as the specific examples of “Organic Solvent to be Combined with the Main Solvent”. Above all, preferred are butanol, pentanol and 1,4-dioxane. More preferably, the solvent for the dope contains an alcohol. In case where the “solvent having a boiling point of not lower than 95 degrees Celsius” is an alcohol such as butanol, its content may be counted as the alcohol content referred to herein.

Examples of the main solvent include halogenated hydrocarbons, esters, ketones, ethers, alcohols and hydrocarbons, which may have a branched structure or a cyclic structure. The main solvent may have two or more functional groups of any of esters, ketones, ethers and alcohols (i.e., —O—, —CO—, —COO—, —OH). Further, the hydrogen atoms in the hydrocarbon part of these esters, ketones, ethers and alcohols may be substituted with a halogen atom (especially, fluorine atom). Regarding the main solvent of the polymer solution to be used in producing the cellulose acylate film produced by the method for producing it of the invention, when the solvent of the solution is a single solvent, then it is the main solvent, but when the solvent is a mixed solvent of different solvents, then the main solvent is the solvent having the highest mass fraction of all the constitutive solvents. The main solvent is preferably a halogenated hydrocarbon.

Examples of the ester include methyl formate, ethyl formate, methyl acetate, and ethyl acetate.

Examples of the ketone include acetone, and methyl ethyl ketone.

Examples of the ether include diethyl ether, methyl-tert-butyl ether, diisopropyl ether, dimethoxymethane, 1,3-dioxolane, 4-methyl dioxolane, tetrahydrofuran, methyl tetrahydrofuran, and 1,4-dioxane.

Examples of the alcohol include methanol, ethanol, and 2-propanol.

Examples of the hydrocarbon include n-pentane, cyclohexane, n-hexane, benzene, and toluene.

The organic solvent that may be combined with the major solvent includes halogenated hydrocarbons, esters, ketones, ethers, alcohols and hydrocarbons, which may have a branched structure or a cyclic structure. The organic solvent may have two or more functional groups of any of esters, ketones, ethers and alcohols (i.e., —CO—, —COO—, —OH). Further, the hydrogen atoms in the hydrocarbon part of these esters, ketones, ethers and alcohols may be substituted with a halogen atom (especially, fluorine atom).

Preferable examples of the organic solvent to be used along with the major solvent include those exemplified as the preferable examples of the main solvent. Furthermore, preferable examples of the organic solvent to be used along with the major solvent include also those described below.

Examples of the ester include propyl formate, pentyl formate, and pentyl acetate.

Examples of the ketone include diethyl ketone, diisobutyl ketone, cyclopentanone, cyclohexanone, and methylcyclohexanone.

Examples of the ether include dimethoxyethane, anisole and phenetole.

Examples of the alcohol include 1-propanol, 2-butanol, tert-butanol, 1-pentanol, 2-methyl-2-butanol, cyclohexanol, 2-fluoroethanol, 2,2,2-trifluoroethanol, 2,2,3,3-tetrafluoro-1-propanol. C₁₋₄ alcohols are preferable; methanol, ethanol, and butanol are more preferable; and methanol and butanol are especially preferable.

Examples of the hydrocarbon include xylene.

The organic solvent having two or more different types of functional groups includes, for example, 2-ethoxyethyl acetate, 2-methoxyethanol, 2-butoxyethanol, methyl acetoacetate.

The cellulose acylate contained in the dope has a hydrogen-bonding functional group such as hydroxyl group, ester, ketone and the like, and therefore, the solvent preferably contains an alcohol in an amount of from 5 to 30% by mass, more preferably from 7 to 25% by mass, even more preferably from 10 to 20% by mass of the entire solvent from the viewpoint of reducing the film peeling load from the casting support.

Controlling the alcohol content may make it easy to control Re and Rth expression in the cellulose acylate film produced according to the production method of the invention.

In the method, adding a small amount of water to the dope is also effective for controlling the solution viscosity, for increasing the wet film strength in drying, and for increasing the dope strength in casting on drum; and for example, water may be added to the solution in an amount of from 0.1 to 5% by mass of all the dope, more preferably from 0.1 to 3% by mass, even more preferably from 0.2 to 2% by mass.

Preferable examples of the combination of the organic solvents which can be used for preparing the dope include, but are not limited, the combinations of (1)-(31) described in JP-A-2009-262551. The numerical data of the ratio are in terms of part by mass.

If necessary, any non-halogen organic solvent may be used as a main solvent, and the details of a case where a non-halogen organic solvent is the main solvent are described in Hatsumei Kyokai Disclosure Bulletin (No. 2001-1745, published by the Hatsumei Kyokai on Mar. 15, 2001), and they may be suitably referred to herein.

### Cellulose Acylate:

According to the invention, cellulose acylate is used as main ingredient.

Here, the term “includes as a main ingredient” means the cellulose acylate when one kind of cellulose acylate is used as a material of the cellulose acylate film, and means the cellulose acylate contained in a highest ratio when plural kinds of cellulose acylates are used as a material of the film. One or more kinds of cellulose acylates may be used in the invention. Cellulose acylates having one kind of the acyl-substitution such as acetyl may be used, or cellulose acylates having two or more kinds of the acyl-substitution may be used.

Cellulose ester is an ester of cellulose and acid. The acid in the ester is preferably selected from organic acids, more preferably selected from carboxylic acids, even more preferably selected from C₂₋₂₂ aliphatic acids, or even much more preferably from C2-4 lower aliphatic acids.

Cellulose acylate is an ester of cellulose and carboxylic acid. In the cellulose acylate, all or a part of the hydrogen atoms of the hydroxyl groups existing at the 2-, 3- and 6-positions of the glucose unit constituting the cellulose are substituted with an acyl group. Examples of the acyl group are acetyl, propionyl, butyryl, isobutyryl, pivaloyl, heptanoyl, hexanoyl, octanoyl, decanoyl, dodecanoyl, tridecanoyl, tetradecanoyl, hexadecanoyl, octadecanoyl, cyclohexanecarbonyl, oleoyl, benzoyl, naphthylcarbonyl and cinnamoyl. The acyl group is preferably acetyl, propionyl, butyryl, dodecanoyl, octadecanoyl, pivaloyl, oleoyl, benzoyl, naphthylcarbonyl, cinnamoyl, and most preferably acetyl, propionyl, butyryl. The cellulose ester may be an ester of cellulose with different carboxylic acids.

The cellulose ester may be any ester of cellulose and a plurality of different acids. The cellulose acylate may be substituted with different acyl groups.

For the cellulose acylate film produced by the producing method of the invention, expression in Re and humidity dependency of retardation may be controlled by adjusting SA and SB. The SA represents a substitution degree of acetyl group (having 2 carbon atoms) which are substituted for hydroxyl group of cellulose of cellulose acylate; and the SB represents a substitution degree of acyl group having 3 or more carbon atoms which are substituted for hydroxyl group of cellulose, respectively. The humidity dependency of the retardation is reversible retardation variation according to the humidity.

In accordance with the necessary optical properties of the film, the cellulose acylate film produced according to the production method of the invention, SA+SB is suitably controlled. Preferably 2.70≦SA+SB≦3.00, more preferably 2.80≦SA+SB≦2.97, or even more preferably 2.83≦SA+SB≦2.89.

By controlling SB, the humidity dependence of the retardation of the cellulose acylate film produced according to the production method of the invention may be controlled. By increasing SB, the humidity dependence of the retardation of the film may be reduced, and the melting point of the film may lower. In consideration of the balance between the humidity dependence of retardation of the film and the lowering of the melting point thereof, the range of SB is preferably 0<SB≦3.0, more preferably 0<SB≦1.0, even more preferably SB=0. In case where all the hydroxyl groups of cellulose are substituted, the above mentioned degree of substitution is 3.

The cellulose acylate may be prepared according to any known method. Regarding a method for synthesizing cellulose acylate, its basic principle is described in Wood Chemistry by Nobuhiko Migita et al., pp. 180-190 (Kyoritsu Publishing, 1968). One typical method for synthesizing cellulose acylate is a liquid-phase acylation method with carboxylic acid anhydride-carboxylic acid-sulfuric acid catalyst. Concretely, a starting material for cellulose such as cotton linter or woody pulp is pretreated with a suitable amount of a carboxylic acid such as acetic acid, and then put into a previously-cooled acylation mixture for esterification to synthesize a complete cellulose acylate (in which the overall substitution degree of acyl group in the 2-, 3- and 6-positions is nearly 3.00). The acylation mixture generally includes a carboxylic acid serving as a solvent, a carboxylic acid anhydride serving as an esterifying agent, and sulfuric acid serving as a catalyst. In general, the amount of the carboxylic acid anhydride to be used in the process is stoichiometrically excessive over the overall amount of water existing in the cellulose that reacts with the carboxylic acid anhydride and that in the system.

Next, after the acylation, the excessive carboxylic acid anhydride still remaining in the system is hydrolyzed, for which, water or water-containing acetic acid is added to the system. Then, for partially neutralizing the esterification catalyst, an aqueous solution that contains a neutralizing agent (e.g., carbonate, acetate, hydroxide or oxide of calcium, magnesium, iron, aluminium or zinc) may be added thereto. Then, the resulting complete cellulose acylate is saponified and ripened by keeping it at 20 to 90 degrees Celsius in the presence of a small amount of an acylation catalyst (generally, sulfuric acid remaining in the system), thereby converting it into a cellulose acylate having a desired substitution degree of acyl group and a desired polymerization degree. At the time when the desired cellulose acylate is obtained, the catalyst still remaining in the system is completely neutralized with the above-mentioned neutralizing agent; or the catalyst therein is not neutralized, and the polymer solution is put into water or diluted acetic acid (or water or diluted acetic acid is put into the polymer solution) to thereby separate the cellulose acylate, and thereafter this is washed and stabilized to obtain the intended product, cellulose acylate.

Preferably, the polymerization degree of the cellulose acylate is from 150 to 500 as the viscosity-average polymerization degree thereof, more preferably from 200 to 400, even more preferably from 220 to 350. The viscosity-average polymerization degree may be measured according to a description of limiting viscosity method by Uda et al. (Kazuo Uda, Hideo Saito; Journal of the Fiber Society of Japan, vol. 18, No. 1, pp. 105-120, 1962). The method for measuring the viscosity-average polymerization degree is described also in JP-A-9-95538.

Cellulose acylates where the amount of low-molecular components is small may have a high mean molecular weight (polymerization degree), but its viscosity may be lower than that of ordinary cellulose acylate. Such cellulose acylates where the amount of low-molecular components is small may be obtained by removing low-molecular components from cellulose acylate synthesized in an ordinary method. The removal of low-molecular components may be attained by washing cellulose acylate with a suitable organic solvent. Cellulose acylate where the amount of low-molecular components is small may be obtained by synthesizing it. In case where cellulose acylate where the amount of low-molecular components is small is synthesized, it is desirable that the amount of the sulfuric acid catalyst in acylation is controlled to be 0.5 to 25 parts by mass relative to 100 parts by mass of cellulose. When the amount of the sulfuric acid catalyst is controlled to fall within the range, then cellulose acylate having a preferable molecular weight distribution (uniform molecular weight distribution) can be synthesized. The polymerization degree and the distribution of the molecular weight of the cellulose acylate can be measured by the gel penetration chromatography (GPC), etc.

The starting material, cotton for cellulose ester and methods for synthesizing it are described also in Hatsumei Kyokai Disclosure Bulletin (No. 2001-1745, issued on Mar. 15, 2001, Hatsumei Kyokai), pp. 7-12.

The cellulose acylate to be used as the starting material in producing the cellulose acylate film may be a powdery or granular one, or may also be pelletized one. The water content of the cellulose acylate to be used as the starting material is preferably equal to or less than 1.0% by mass, more prefer ably equal to or less than 0.7% by mass, most preferably equal to or less than 0.5% by mass. As the case may be, the water content is preferably equal to or less than 0.2% by mass. In case where the water content of the cellulose acylate is not within the preferred range, it is desirable that the cellulose acylate is dried with dry air or by heating and then used in the invention.

### Aromatic Group-Containing Oligomer:

According to the invention, one or more aromatic group-containing oligomers are used as a plasticizer. The plasticizer may have a function contributing to accelerating the volatilization rate of the solvent and lowering the content of the residual solvent. The number-averaged molecular weight of the oligomer is preferably from 500 to 2000, or more preferably from 500 to 1500 in terms of the plasticizer ability. An amount of the oligomer is preferably equal to or smaller than 20 parts by mass, or more preferably equal to or smaller than 15 parts by mass, with respect to 100 parts by mass of the cellulose acylate, in terms of exuding of the oligomer or in terms of handling-properties of the web. An amount of the oligomer is also preferably equal to or larger than larger than 3 parts by mass, or more preferably equal to or smaller than 5 parts by mass, with respect to 100 parts by mass of the cellulose acylate, in terms of drying rate of the web.

One aromatic group-containing oligomer or two or more aromatic group-containing oligomers may be used.

The aromatic group-containing oligomer may be liquid or solid at the environmental temperature and humidity (usually, at the room temperature, or 25 degrees Celsius and the relative humidity of 60%). The less color oligomers are more preferable, and especially, colorless oligomers are preferable. The more heat-stable oligomers are preferable, and the decomposition temperature, at which the decomposition starts, is preferably equal to or higher than 150 degrees Celsius, more preferably equal to or higher than 200 degrees Celsius, or even more preferably equal to or higher than 250 degrees Celsius.

One feature of the aromatic group-containing oligomer which can be used in the invention resides in having an aromatic group. By having the aromatic group in the repeating unit regularly, the alignment degree of the oligomer molecules is increased effectively during the heat-treatment. The aromatic group-containing oligomer is preferably selected from polycondensation esters having at least one residue of dicarboxylic acid and at least one residue of diol. The aromatic group may be contained in the carboxylic residue or in the diol residue. The aromatic group-containing oligomer is preferably selected from polycondensation esters having the aromatic residue in the dicarboxylic acid residue. More specifically, the aromatic group-containing oligomer is preferably selected from polycondensation esters having at least one residue of aromatic dicarboxylic acid and at least one residue of aliphatic diol.

Next, the polycondensation esters which can be used as the aromatic group-containing oligomer in the invention are described in detail.

### Polycondensation Ester:

According to the invention, the polycondensation ester prepared by reaction of at least one aromatic dicarboxylic acid and at least one aliphatic glycol is preferably used as the aromatic group-containing oligomer. For both terminals of the product, no treatment may be performed, or any blocking treatment of reacting with monocarboxylic acid or monoalcohol may be performed. The terminal blocking treatment may be performed effectively for avoiding free carboxylic acid contained therein, in terms of preservation stability.

The dicarboxylic acid used for preparation of the polycondensation ester is preferably selected from aromatic dicarboxylic acids, or more preferably selected from C₈₋₁₂ aromatic carboxylic acids.

The glycol used for preparation of the polycondensation ester is preferably selected from aliphatic glycols, or more preferably selected from C₂₋₁₂ aliphatic glycols. Examples of the aliphatic glycol include alicyclic glycols.

Examples of the C₈₋₁₂ aromatic carboxylic acid include phthalic acid, terephthalic acid, 1,5-naphthalene dicarboxylic acid, and 1,4-naphthalene dicarboxylic acid. Among these, terephthalic acid is preferable in terms of high ability of enhancing Re. One or two or more kinds of the C₈₋₁₂ aromatic carboxylic acid may be used.

The polycondensation ester may contain at least one residue of an aliphatic dicarboxylic acid. Examples of the residue of the aliphatic dicarboxylic acid include C₄₋₁₂ aliphatic dicarboxylic acid residues. Examples of the C₄₋₁₂ aliphatic dicarboxylic acid include succinic acid, maleic acid, fumaric acid, glutaric acid, adipic acid, azelaic acid, sebacic acid, dodecanedicarboxylic acid and 1,4-cyclohexanedicarboxylic acid.

Examples of the C₂₋₁₂ aliphatic glycol include ethylene glycol, 1,2-propylenglycol, 1,3-propylenglycol, 1,2-butanediol, 1,3-butanediol, 2-methyl-1,3-propanediol, 1,4-butanediol, 1,5-pentanediol, 2,2-dimethyl-1,3-propanediol(neopentyl glycol), 2,2-diethyl-1,3-propanediol(3,3-dimethyrol pentane), 2-n-butyl-2-ethyl-1,3-propanediol(3,3-dimethyrol heptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, and 1,12-octadecanediol; and one or more selected from these may be used.

Preferably, the polycondensation ester is protected with a monoalcohol residue or a monocarboxylic acid residue in order that both ends of the polycondensation ester are not a carboxylic acid. In this case, the monoalcohol residue described in JP-A 2009-262551 is preferably usable.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or, an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are described in JP-A 2009-262551. One or more of these may be used either singly or as combined.

The specific examples of the polycondensation ester and method for synthesizing the polycondensation ester and commercial products thereof are, for example, described in JP-A 2009-262551.

Examples of the polycondensation ester which can be used in the invention include, but are not limited to, those described below.

PP-1: Condensation product (the number-averaged molecular weight: 1000) of ethanediol/terephthalic acid (molar ratio: 1/1)

PP-2: Condensation product (the number-averaged molecular weight: 1000) of 1,2-propanediol/terephthalic acid (molar ratio: 1/1)

PP-3: Condensation product (the number-averaged molecular weight: 1000) of ethanediol/1,2-propanediol/terephthalic acid (molar ratio: 0.5/0.5/1)

PP-4: Condensation product (the number-averaged molecular weight: 1000) of ethanediol/1,2-propanediol/terephthalic acid/succinic acid (molar ratio: 0.5/0.5/0.7/0.3)

PP-5: Condensation product (the number-averaged molecular weight: 1000) of ethanediol/1,2-propanediol/terephthalic acid/succinic acid (molar ratio: 0.5/0.5/0.55/0.45)

PP-6: Condensation product (the number-averaged molecular weight: 1000) of ethanediol/1,2-propanediol/terephthalic acid/succinic acid (molar ratio: 0.5/0.5/0.7/0.3)

PP-7: Condensation product (the number-averaged molecular weight: 1500) of 1,3-propanediol/1,5-naphthalene dicarboxylic acid (molar ratio: 1/1)

PP-8: Condensation product (the number-averaged molecular weight: 1200) of 2-methyl-1,3-propanediol/isophthalic acid (molar ratio: 1/1)

PP-9: Condensation product (the number-averaged molecular weight: 1500) of 1,3-propanediol/terephthalic acid (molar ratio: 1/1) with both terminals blocked by benzyl ester

PP-10: Condensation product (the number-averaged molecular weight: 1500) of 1,3-propanediol/1,5-naphthalene dicarboxylic acid (molar ratio: 1/1) with both terminals blocked by propyl ester

PP-11: Condensation product (the number-averaged molecular weight: 1200) of 2-methyl-1,3-propanediol/isophthalic acid (molar ratio: 1/1) with both terminals blocked by butyl ester

### Agent for Controlling Retardation Wavelength Dispersion:

The dope to be used in the invention may contain at least one agent for controlling the retardation wavelength dispersion.

The agent for controlling the retardation wavelength dispersion may be selected from compounds having the absorption peak at a wavelength of from 250 to 400 nm, preferably from 300 to 400 nm, or more preferably from 360 to 400 nm. By adding the compound having such properties to the dope, the film having the desired wavelength dispersion characteristics of retardation may be produced. The agent for controlling the retardation wavelength dispersion may be selected from compound having also another absorption peak at a wavelength falling without the range of from 250 to 400 nm.

The agent for controlling the retardation wavelength dispersion is preferably selected from compounds not to be vaporized in all steps of the process for producing films. The agent for controlling the retardation wavelength dispersion may be used singularly or in combination. An amount of the agent for controlling the retardation wavelength dispersion may be varied depending on the desired optical properties of the film. Generally, an amount of the agent is preferably from 0.2 to 20% by mass, more preferably from 0.2 to 10% by mass, or even more preferably from 0.5 to 5% by mass. The agent for controlling the retardation wavelength dispersion may be added to the dope before the casting step.

The agent for controlling the retardation wavelength dispersion which can be used in the invention is preferably selected from compounds represented by formulas (I)-(VIII). Among those, the compound represented by formula (I) is more preferable.

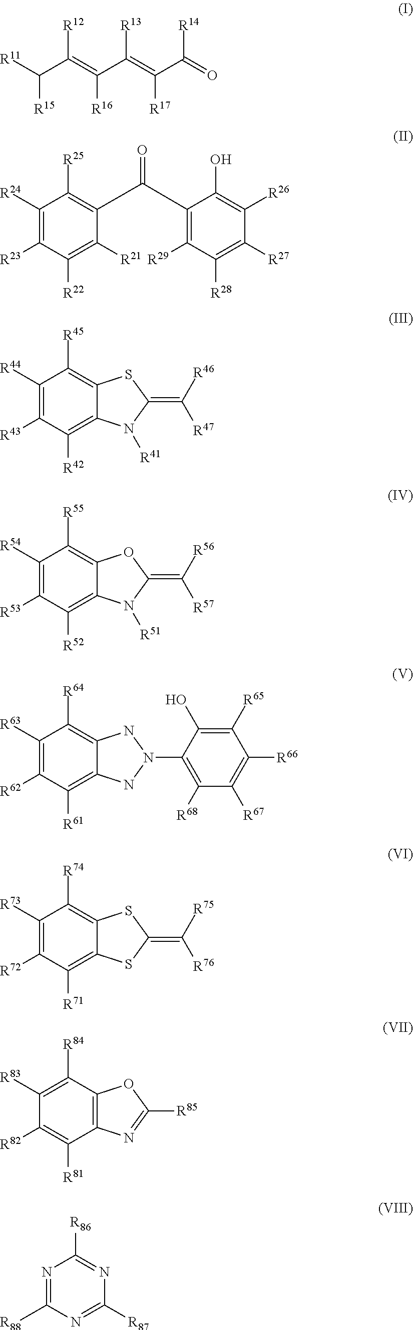

R¹¹, R¹², R¹³, R¹⁴, R¹⁵, R¹⁶, and R¹⁷ in formula (I), R²¹, R²², R²³, R²⁴, R²⁵, R²⁶, R²⁷, R²⁸, and R²⁹ in formula (II), R⁴¹, R⁴², R⁴³, R⁴⁴, R⁴⁵, R⁴⁶, and R⁴⁷; in formula (III), R⁵¹, R⁵², R⁵³, R⁵⁴, R⁵⁵, R⁵⁶, and R⁵⁷ in formula (IV), R⁶¹, R⁶², R⁶³, R⁶⁴, R⁶⁵, R⁶⁶, R⁶⁷, and R⁶⁸ in formula (V), R⁷¹, R⁷², R⁷³, R⁷⁴, R⁷⁵ and R⁷⁶ in formula (VI), R⁸¹, R⁸², R⁸³, R⁸⁴ and R⁸⁵ in formula (VII), and R⁸⁶, R⁸⁷ and R⁸⁸ in formula (VIII) respectively represent a hydrogen atom or substituent.

In formulas (I)-(VIII), the substituents are preferably combined so that the compound has the molecular long axis along the horizontal direction (right and left direction) in plane of paper.

Preferable examples of the substituent include:

a halogen atom (for example, a fluorine atom, a chlorine atom, a bromine atom, an iodine atom), an alkyl group (preferably an alkyl group having from 1 to 30 carbon atoms, more preferably from 1 to 10 carbon atoms, for example, a methyl group, an ethyl group, an n-propyl group, an isopropyl group, a tert-butyl group, an n-octyl group, a 2-ethylhexyl group), a cycloalkyl group (preferably a substituted or un-substituted cycloalkyl group having from 3 to 30 carbon atoms, more preferably from 3 to 10 carbon atoms, for example, a cyclohexyl group, a cyclopentyl group, a 4-n-dodecylcyclohexyl group), a bicycloalkyl group (preferably a substituted or unsubstituted bicycloalkyl group having from 5 to 30 carbon atoms, more preferably from 5 to 10 carbon atoms, or that is, a monovalent group derived from a bicycloalkane preferably having from 5 to 30 carbon atoms, more preferably from 5 to 10 carbon atoms, by removing one hydrogen atom from it, for example, a bicyclo[1.2.2]heptan-2-yl group, a bicyclo[2.2.2]octan-3-yl group), an alkenyl group (preferably a substituted or unsubstituted alkenyl group having from 2 to 30 carbon atoms, more preferably from 2 to 10 carbon atoms, for example, a vinyl group, an allyl group), a cycloalkenyl group (preferably a substituted or unsubstituted cycloalkenyl group having from 3 to 30 carbon atoms, more preferably from 3 to 10 carbon atoms, of that is, a monovalent group derived from a cycloalkene preferably having from 3 to 30 carbon atoms, more preferably from 3 to 10 carbon atoms, by removing one hydrogen atom from it, for example, a 2-cyclopenten-1-yl group, a 2-cyclohexen-1-yl group), a bicycloalkenyl group (a substituted or unsubstituted bicycloalkenyl group, preferably a substituted or unsubstituted bicycloalkenyl group having from 5 to 30 carbon atoms, more preferably from 5 to 10 carbon atoms, or that is, a monovalent group derived from a bicycloalkene having one double bond, by removing one hydrogen atom from it, for example, a bicyclo[2.2.2]hept-2-en-1-yl group, a bicyclo[2.2.2]oct-2-en-4-yl group), an alkynyl group (preferably a substituted or unsubstituted alkynyl group having from 2 to 30 carbon atoms, more preferably from 2 to 10 carbon atoms, for example, an ethynyl group, a propargyl group), an aryl group (preferably a substituted or unsubstituted aryl group having from 6 to 30 carbon atoms, more preferably from 6 to 10 carbon atoms, for example, a phenyl group, a p-tolyl group, a naphthyl group), a heterocyclic group (preferably a monovalent group derived from a 5- or 6-membered, substituted or unsubstituted, aromatic or non-aromatic heterocyclic compound, by removing one hydrogen atom from it, more preferably a 5- or 6-membered aromatic heterocyclic group having from 3 to 30 carbon atoms, even more preferably having from 3 to 10 carbon atoms, for example, a 2-furyl group, a 2-thienyl group, a 2-pyrimidinyl group, a 2-benzothiazolyl group), a cyano, a hydroxyl group, a nitro group, a carboxyl group, an alkoxy group (preferably a substituted or unsubstituted alkoxy group having from 1 to 30 carbon atoms, more preferably from 1 to 10 carbon atoms, for example, a methoxy group, an ethoxy group, an isopropoxy group, a tert-butoxy group, an n-octyloxy group, a 2-methoxyethoxy group), an aryloxy group (preferably a substituted or unsubstituted aryloxy group having from 6 to 30 carbon atoms, more preferably from 6 to 10 carbon atoms, for example, a phenoxy group, a 2-methylphenoxy group, a 4-tert-butylphenoxy group, a 3-nitrophenoxy group, a 2-tetradecanoylaminophenoxy group), a silyloxy group (preferably a silyloxy group having from 3 to 20 carbon atoms, more preferably from 3 to 10 carbon atoms, for example, a trimethylsilyloxy group, a tert-butyldimethylsilyloxy group), a heterocyclic-oxy group (preferably a substituted or unsubstituted heterocyclic-oxy group having from 2 to 30 carbon atoms, more preferably from 2 to 10 carbon atoms, for example, a 1-phenyltetrazol-5-oxy group, a 2-tetrahydropyranyloxy group), an acyloxy group (preferably a formyloxy group, a substituted or unsubstituted alkylcarbonyloxy group having from 2 to 30 carbon atoms, more preferably from 2 to 10 carbon atoms, a substituted or unsubstituted arylcarbonyloxy group having from 6 to 30 carbon atoms, more preferably from 6 to 10 carbon atoms, for example, an acetyloxy group, a pivaloyloxy group, a stearoyloxy group, a benzoyloxy group, a p-methoxyphenylcarbonyloxy group), a carbamoyloxy group (preferably a substituted or unsubstituted carbamoyloxy group having from 1 to 30 carbon atoms, more preferably from 1 to 10 carbon atoms, for example, an N,N-dimethylcarbamoyloxy group, an N,N-diethylcarbamoyloxy group, a morpholinocarbonyloxy group, an N,N-di-n-octylaminocarbonyloxy group, an N-n-octylcarbamoyloxy group), an alkoxycarbonyloxy group (preferably a substituted or unsubstituted alkoxycarbonyloxy group having from 2 to 30 carbon atoms, more preferably from 2 to 10 carbon atoms, for example, a methoxycarbonyloxy group, an ethoxycarbonyloxy group, a tert-butoxycarbonyloxy group, an n-octylcarbonyloxy group), an aryloxycarbonyloxy group (preferably a substituted or unsubstituted aryloxycarbonyloxy group having from 7 to 30 carbon atoms, more preferably from 7 to 10 carbon atoms, for example, a phenoxycarbonyloxy group, a p-methoxyphenoxycarbonyloxy group, a p-n-hexadecyloxyphenoxycarbonyloxy group), an amino group (preferably, an amino group, a substituted or unsubstituted alkylamino group having from 1 to 30 carbon atoms, more preferably from 1 to 10 carbon atoms, or a substituted or unsubstituted anilino group having 6 to 30 carbon atoms, more preferably from 6 to 10 carbon atoms, for example, a methylamino group, a dimethylamino group, an anilino group, an N-methylanilino group, a diphenylamino group), an acylamino group (preferably a formylamino group, a substituted or unsubstituted alkylcarbonylamino group having from 1 to 30 carbon atoms, more preferably from 1 to 10 carbon atoms, or a substituted or unsubstituted arylcarbonylamino group having from 6 to 30 carbon atoms, more preferably from 6 to 10 carbon atoms, for example, an acetylamino group, a pivaloylamino group, a lauroylamino group, a benzoylamino group), an aminocarbonylamino group (preferably a substituted or unsubstituted aminocarbonylamino group having from 1 to 30 carbon atoms, more preferably from 1 to 10 carbon atoms, for example, a carbamoylamino group, an N,N-dimethylaminocarbonylamino group, an N,N-diethylaminocarbonylamino group, a morpholinocarbonylamino group), an alkoxycarbonylamino group (preferably a substituted or unsubstituted alkoxycarbonylamino group having from 2 to 30 carbon atoms, more preferably from 2 to 10 carbon atoms, for example, a methoxycarbonylamino group, an ethoxycarbonylamino group, a tert-butoxycarbonylamino group, an n-octadecyloxycarbonylamino group, an N-methyl-methoxycarbonylamino group), an aryloxycarbonylamino group (preferably a substituted or unsubstituted aryloxycarbonylamino group having from 7 to 30 carbon atoms, more preferably from 7 to 10 carbon atoms, for example, a phenoxycarbonylamino group, a p-chlorophenoxycarbonylamino group, an m-n-octyloxyphenoxycarbonylamino group), a sulfamoylamino group (preferably a substituted or unsubstituted sulfamoylamino group having from 0 to 30 carbon atoms, more preferably from 0 to carbon atoms, for example, a sulfamoylamino group, an N,N-dimethylaminosulfonylamino group, an N-n-octylaminosulfonylamino group), an alkyl and arylsulfonylamino group (preferably a substituted or unsubstituted alkylsulfonylamino group having from 1 to 30 carbon atoms, more preferably from 1 to 10 carbon atoms, or a substituted or unsubstituted arylsulfonylamino group having from 6 to 30 carbon atoms, more preferably from 6 to 10 carbon atoms, for example, a methylsulfonylamino group, a butylsulfonylamino group, a phenylsulfonylamino group, a 2,3,5-trichlorophenylsulfonylamino group, a p-methylphenylsulfonylamino group), a mercapto group, an alkylthio group (preferably a substituted or unsubstituted alkylthio group having from 1 to 30 carbon atoms, more preferably from 1 to 10 carbon atoms, for example, a methylthio group, an ethylthio group, an n-hexadecylthio group), an arylthio group (preferably a substituted or unsubstituted arylthio group having from 6 to 30 carbon atoms, more preferably from 6 to 10 carbon atoms, for example, a phenylthio group, a p-chlorophenylthio group, a m-methoxyphenylthio group), a heterocyclic-thio group (preferably a substituted or unsubstituted heterocyclic-thio group having from 2 to 30 carbon atoms, more preferably from 2 to 10 carbon atoms, for example, a 2-benzothiazolylthio group, a 1-phenyltetrazol-5-ylthio group), a sulfamoyl group (preferably a substituted or unsubstituted sulfamoyl group having from 0 to 30 carbon atoms, more preferably from 0 to 10 carbon atoms, for example, an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, an N—(N′-phenylcarbamoyl)sulfamoyl group), a sulfo group, an alkyl and arylsulfinyl group (preferably a substituted or unsubstituted alkylsulfinyl group having from 1 to 30 carbon atoms, more preferably from 1 to 10 carbon atoms, or a substituted or unsubstituted arylsulfinyl group having from 6 to 30 carbon atoms, more preferably from 6 to 10 carbon atoms, for example, a methylsulfinyl group, an ethylsulfinyl group, a phenylsulfonyl group, a p-methylphenylsulfinyl group), an alkyl and arylsulfonyl group (preferably a substituted or unsubstituted alkylsulfonyl group having from 1 to 30 carbon atoms, more preferably from 1 to 10 carbon atoms, or a substituted or unsubstituted arylsulfonyl group having from 6 to 30 carbon atoms, more preferably from 6 to 10 carbon atoms, for example, a methylsulfonyl group, an ethylsulfonyl group, a phenylsulfonyl group, a p-methylphenylsulfonyl group), an acyl group (preferably a formyl group, a substituted or unsubstituted alkylcarbonyl group having from 2 to 30 carbon atoms, more preferably from 2 to 10 carbon atoms, or a substituted or unsubstituted arylcarbonyl group having from 7 to 30 carbon atoms, more preferably from 7 to 10 carbon atoms, for example, an acetyl group, a pivaloyl group, a benzoyl group), an aryloxycarbonyl group (preferably a substituted or unsubstituted aryloxycarbonyl group having from 7 to 30 carbon atoms, more preferably from 7 to 10 carbon atoms, for example, a phenoxycarbonyl group, an o-chlorophenoxycarbonyl group, an m-nitrophenoxycarbonyl group, a p-tert-butylphenoxycarbonyl group), an alkoxycarbonyl group (preferably a substituted or unsubstituted alkoxycarbonyl group having from 2 to 30 carbon atoms, more preferably from 2 to 10 carbon atoms, for example, a methoxycarbonyl group, an ethoxycarbonyl group, a tert-butoxycarbonyl group, an n-octadecyloxycarbonyl group), a carbamoyl group (preferably a substituted or unsubstituted carbamoyl group having from 1 to 30 carbon atoms, more preferably from 1 to 10 carbon atoms, for example, a carbamoyl group, an N-methylcarbamoyl group, an N,N-dimethylcarbamoyl group, an N,N-di-n-octylcarbamoyl group, an N-(methylsulfonyl)carbamoyl group), an aryl and heterocyclic-azo group (preferably a substituted or unsubstituted arylazo group having from 6 to 30 carbon group, more preferably from 6 to 10 carbon atoms, or a substituted or unsubstituted heterocyclic-azo group having from 3 to 30 carbon atoms, more preferably from 3 to 10 carbon atoms, for example, a phenylazo group, a p-chlorophenylazo group, a 5-ethylthio-1,3,4-thiadiazol-2-ylazo group), an imide group (preferably an N-succinimide group, an N-phthalimide group), a phosphino group (preferably a substituted or unsubstituted phosphino group having from 2 to 30 carbon atoms, more preferably from 2 to 10 carbon atoms, for example, a dimethylphosphino group, a diphenylphosphino group, a methylphenoxyphosphino group), a phosphinyl group (preferably a substituted or unsubstituted phosphinyl group having from 2 to 30 carbon atoms, more preferably from 2 to 10 carbon atoms, for example, a phosphinyl group, a dioctyloxyphosphinyl group, a diethoxyphosphinyl group), a phosphinyloxy group (preferably a substituted or unsubstituted phosphinyloxy group having from 2 to 30 carbon atoms, more preferably from 2 to 10 carbon atoms, for example, a diphenoxyphosphinyloxy group, a dioctyloxyphosphinyloxy group), a phosphinylamino group (preferably a substituted or unsubstituted phosphinylamino group having from 2 to 30 carbon atoms, more preferably from 2 to 10 carbon atoms, for example, a dimethoxyphosphinylamino group, a dimethylaminophosphinylamino group), a silyl group (preferably a substituted or unsubstituted silyl group having from 3 to 30 carbon atoms, more preferably from 3 to 10 carbon atoms, for example, a trimethylsilyl group, a tert-butyldimethylsilyl group, a phenyldimethylsilyl group).

Of the above substituents, those having a hydrogen atom may be further substituted with any of the above-mentioned substituents by removing the hydrogen atom. Examples of the functional group are an alkylcarbonylaminosulfonyl group, an arylcarbonylaminosulfonyl group, an alkylsulfonylaminocarbonyl group, an arylsulfonylaminocarbonyl group. Concretely, they include a methylsulfonylaminocarbonyl group, a p-methylphenylsulfonylaminocarbonyl group, an acetylaminosulfonyl group, a benzoylaminosulfonyl group.

Among those, a halogen atom, alkyl group, aryl group, alkoxy group, cyano, hydroxyl, carboxyl and arylsulfonyl group are more preferable; and an alkyl group, alkoxy group, hydroxy, carboxyl and phenylsulfonyl are even more preferable.

The compounds having two or more substituents which are same or different from each other may be used. If possible, they may bond each other to form a ring (including the condensed ring of the ring contained in each of the formulas).

The molecular-weight of the agent for controlling the retardation wavelength dispersion is preferably from 100 to 5000, more preferably from 150 to 3000, or even more preferably from 200 to 2000.

### (Merocyanine Compound)

Examples of the agent for controlling the retardation wavelength dispersion which can be used in the invention include merocyanine compounds represented by formula (IX). Among those, the merocyanine compounds whose λmax satisfies the relation of 370 nm≦λmax≦400 nm are preferable.

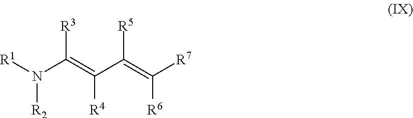

In formula (IX), N represents a nitrogen atom; and R¹-R⁷ respectively represents a hydrogen atom or substituent. In formula (IX) the substituents are preferably combined so that the compound has the molecular long axis along the horizontal direction (right and left direction) in plane of paper.

Examples of the substituent represented by R¹-R⁷ include those exemplified above as the substituent represented by R¹¹ in formula (I).

In formula (IX), preferably, R¹ and R² respectively represent a substituted or non-substituted alkyl group, or may bond to each other to form a ring containing a nitrogen atom; R⁶ and R⁷ respectively represent a substituent having a Hammett's op value of 0.2 or more, or bond to each other to form a cyclic active methylene structure; and R³, R⁴ and R⁵ are hydrogen atoms. The alkyl represented by R¹ or R² is preferably a C₁₋₂₀ alkyl (more preferably C₁₋₁₀ alkyl, or even more preferably C₁₋₅ alkyl) such as methyl, ethyl and propyl. The alkyl may be a linear or branched chain. The alkyl may have at least one substituent. Examples of the substitutent include a halogen atom (e.g., fluorine atom, chlorine atom, bromine atom, iodine atom), an aryl group (e.g., phenyl, naphthyl), a cyano, a carboxyl group, an alkoxycarbonyl group (e.g., methoxycarbonyl), an aryloxycarbonyl group (e.g., phenoxycarbonyl), a substituted or unsubstituted carbamoyl group (e.g., carbamoyl, N-phenylcarbamoyl, N,N-dimethylcarbamoyl), an alkylcarbonyl group (e.g., acetyl), an arylcarbonyl group (e.g., benzoyl), a nitro group, a substituted or unsubstituted amino group (e.g., amino, dimethylamino, anilino), an acylamino group (e.g., acetamide, ethoxycarbonylamino), a sulfonamide group (e.g., methanesulfonamide), an imide group (e.g., succinimide, phthalimide), an imino group (e.g., benzylideneamino), a hydroxyl group, an alkoxy group (e.g., methoxy), an aryloxy group (e.g., phenoxy), an acyloxy group (e.g., acetoxy), an alkylsulfonyloxy group (e.g., methanesulfonyloxy), an arylsulfonyloxy group (e.g., benzenesulfonyloxy), a sulfo group, a substituted or unsubstituted sulfamoyl group (e.g., sulfamoyl, N-phenylsulfamoyl), an alkylthio group (e.g., methylthio), an arylthio group (e.g., phenylthio), an alkylsulfonyl group (e.g., methanesulfonyl), an arylsulfonyl group (e.g., benzenesulfonyl), a heterocyclic group (e.g., pyridyl, morpholino), etc. The substituent may be further substituted. In case where the compound has multiple substituents, they may be the same or different, or the substituents may bond to form a ring.

R¹ and R² may bond to each other to form a ring containing the nitrogen atom. The ring is preferably a saturated ring, more preferably a saturated 6-membered ring, even more preferably a piperidine ring.

Preferably, R¹ and R² respectively represent a non-substituted alkyl, cyano, or an alkyl substituted with a phenyl group, or they bond to each other to form a piperidine ring.

R⁶ and R⁷ each may be a substituent having a Hammett substituent constant σp of at least 0.2, or R⁶ and R⁷ may bond to each other to form a ring. The Hammett substituent constant σp is described. The Hammett equation is a rule of thumb proposed by L. P. Hammett in 1935 for qualitatively discussing the influence of a substituent on the reaction or equilibrium of benzene derivatives, and now its reasonability is widely accepted in the art. The substituent constant developed by the Hammett equation includes σp and σm; and these data are found in a large number of general literature. For example, these are described in detail in J. A. Dean “Lange's Handbook of Chemistry”, Ver. 12, 1979 (McGraw-Hill); “Field of Chemistry”, extra edition, No. 122, pp. 96-103, 1979 (Nanko-do); Chem. Rev., 1991, Vol. 91, pp. 165-195, etc. The substituent having a Hammett substituent constant up of at least 0.2 in the present invention is an electron-attractive group. σp of the substituent is preferably at least 0.25, more preferably at least 0.3, even more preferably at least 0.35.

Examples of R⁶ and R⁷ include a cyano group (0.66), a carboxyl group (—COOH: 0.45), an alkoxycarbonyl group (—COOMe: 0.45), an aryloxycarbonyl group (—COOPh: 0.44), a carbamoyl group (—CONH₂: 0.36), an alkylcarbonyl group (—COMe: 0.50), an arylcarbonyl group (—COPh: 0.43), an alkylsulfonyl group (—SO₂Me: 0.72), or an arylsulfonyl group (—SO₂Ph: 0.68), etc. In this description, Me means a methyl group, Ph means a phenyl group. The data in the parenthesis are the σp value of the typical substituent, as extracted from Chem., Rev., 1991, Vol. 91, pp. 165-195.

R⁶ and R⁷ may bond to each other to form a cyclic active methylene compound structure. “Active methylene compound” means a series of compounds each having a methylene group (—CH₂—) sandwiched between two electron-attractive groups. Preferably, the carbon atom to which R⁶ and R⁷ bond is active methylene.

Of the above merocyanine compounds, those of the following formula (IXa) are preferred.

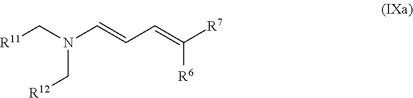

In the formula (IXa), R¹¹ and R¹² each represent an alkyl group, an aryl group, a cyano group or —COOR¹³, or they bond to each other to form a ring containing the nitrogen atom; R⁶ and R⁷ each represent a cyano group, —COOR¹⁴, or —SO₂R₁₅, or they bond to each other to form any of the following cyclic active methylene structures (IXa-1) to (IXa-6); R¹³, R¹⁴ and R¹⁵ each represent an alkyl group, an aryl group, or a heterocyclic group.

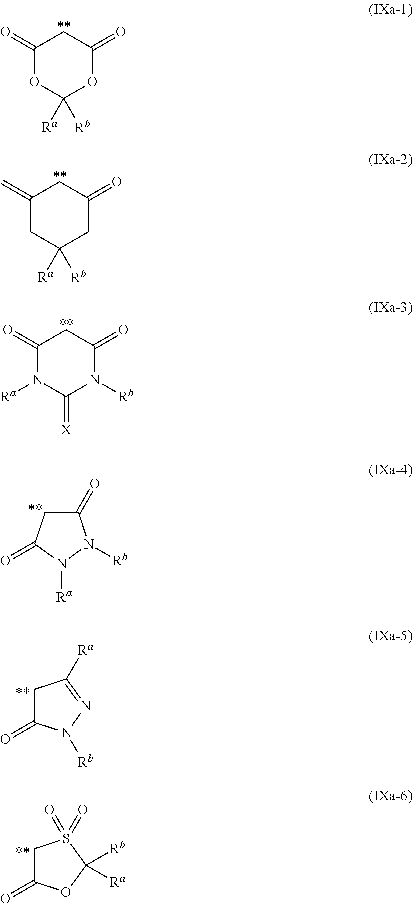

In the formulae (IXa-1)-(IXa-6), “**” indicates the position at which the group bonds to the formula (IXa); R^{a} and R^{b} each represent a hydrogen atom, or a C₁-C₂₀ (preferably C₁-C₂₀, more preferably C₁-C₅) alkyl group; X represents an oxygen atom or a sulfur atom.

The alkyl group to be represented by R¹¹ and R¹² may be unsubstituted or may have a substituent. Examples of the substituent are the same as those of the substituent to be represented by R¹ and R². The alkyl group preferably has from 1 to 20 carbon atoms, more preferably from 1 to 15 carbon atoms, even more preferably from 1 to 6 carbon atoms.

The aryl group to be represented by R¹¹ and R¹² may be unsubstituted or may have a substituent. Examples of the substituent are the same as those of the substituent to be represented by R¹ and R². The aryl group is preferably a phenyl group, more preferably an unsubstituted phenyl group.

In —COOR¹³ represented by R¹¹ or R¹², R¹³ is preferably an alkyl group, more preferably an unsubstituted alkyl group. The alkyl group preferably has from 1 to 20 carbon atoms, more preferably from 1 to 15 carbon atoms, even more preferably from 1 to 6 carbon atoms.

The ring to be formed by R¹¹ and R¹² bonding to each other is preferably a saturated ring, more preferably a 6-membered saturated ring, even more preferably a piperidine ring.

Preferably, R¹¹ and R¹² are both a cyano group or an unsubstituted phenyl group, or they bond to each other to form a piperidine group, and even more preferably, the two are both a cyano group or an unsubstituted phenyl group.

In —COOR¹⁴ represented by R⁶ or R⁷, R¹⁴ is preferably an alkyl group, more preferably an unsubstituted alkyl group. The alkyl group preferably has from 1 to 20 carbon atoms, more preferably from 5 to 15 carbon atoms.

In —SO₂R¹⁵ represented by R⁶ or R⁷, R¹⁵ is preferably an aryl group, more preferably a phenyl group.

Of examples of the cyclic active methylene structure to be formed by R⁶ and R⁷ bonding to each other, preferred are those of the formula (IXa-1) or (IXa-4), and more preferred are those of the formula (IXa-1).

Preferably, at least one of R⁶ and R⁷ is a cyano group, or they bond to each other to form any of the above-mentioned, cyclic active methylene structure (IXa-1) to (IXa-6); more preferably, at least one of these is a cyano group, or they bond to each other to form the above-mentioned, cyclic active methylene structure (IXa-1) or (IXa-4); and even more preferably, both the two are a cyano group, or bond to each other to form the above-mentioned, cyclic active methylene structure (IXa-1) or (IXa-4).

Preferred examples of the merocyanine compound of the formula (I) include compounds of the following formulae (IXa-a), (IXa-b), (IXa-c) and (IXa-d). More preferred are the compounds of the following formulae (IXa-a), (IXa-b) and (IXa-d).

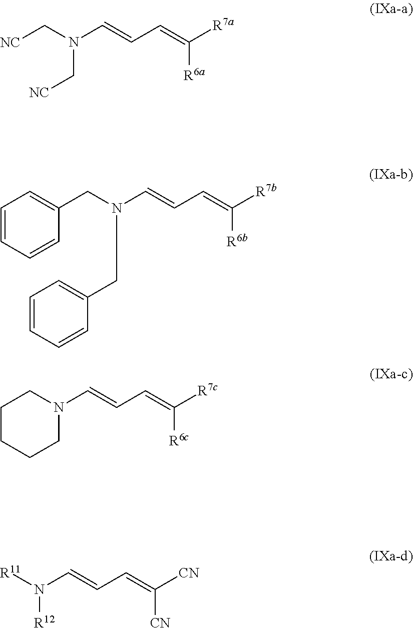

In formula (IXa-a), R^{6a} and R^{7a} have the same meanings as R⁶ and R⁷ in formula (IXa), respectively, and their preferred range is also the same as that of the latter. Above all, compounds in which the substituents form any of the cyclic active methylene structures (IXa-1) to (IXa-6) are preferred from the viewpoint of the ability thereof to prevent discoloration and to secure lightfastness.

In formula (Ixa-b), R^{6b} and R^{7b} have the same meanings as R⁶ and R⁷ in formula (IXa), respectively, and their preferred range is also the same as that of the latter. Above all, compounds in which the substituents are both a cyano group, or form any of the cyclic active methylene structures (IXa-1) to (IXa-6) (more preferably, (IXa-1) or (IXa-4), even more preferably (IXa-1)) are preferred from the viewpoint of the ability thereof to prevent discoloration and to secure lightfastness. Especially preferred are the compounds where the two substituents are both a cyano group.

In formula (Xa-c), R^{6c} and R^{7c} have the same meanings as R⁶ and R⁷ in formula (IXa), respectively, and their preferred range is also the same as that of the latter. Above all, compounds in which one of the substituents is a cyano group and the other is —COOR¹⁴ (the definition and the preferred range of R¹⁴ are the same as above), or the substituents form any of the cyclic active methylene structures (IXa-1) to (IXa-6) are preferred.

In formula (Xa-d), R¹¹ and R¹² have the same meanings as those in formula (IXa), respectively, and their preferred range is also the same as that of the latter.

The compound represented by formula (IXa-a), (IXa-b), (IXa-c), or (IXa-d) has a function improving the lightfastness of the compound represented by formula (IX); and using the compound represented by any one of formulas (IXa-a), (IXa-b), (IXa-c) and (IXa-d) in combination with the merocyanine compound represented by formula (IX) or (IXa) is preferable in terms of the improvement of the lightfastness. The ratio of mixing the compound represented by formula (Ix) and the compound represented by formula (IXa-a), (IXa-b), (IXa-c) or (IXa-d) is preferably from 10/90 to 90/10, more preferably from 30/70 to 70/30, or even more preferably from 40/60 to 60/40.

An amount of the agent for controlling the retardation wavelength dispersion is preferably from 1.0 to 20% by mass, more preferably from 1.0 to 10% by mass, even more preferably from 1.5 to 8.0% by mass, or even much more preferably from 2.0 to 6.0% by mass, with respect to the amount of the cellulose acylate.

Preferable examples of the compound represented by formula (IXa-a), (IXa-b), (IXa-c) or (IXa-d) include, but are not limited to, those described below.

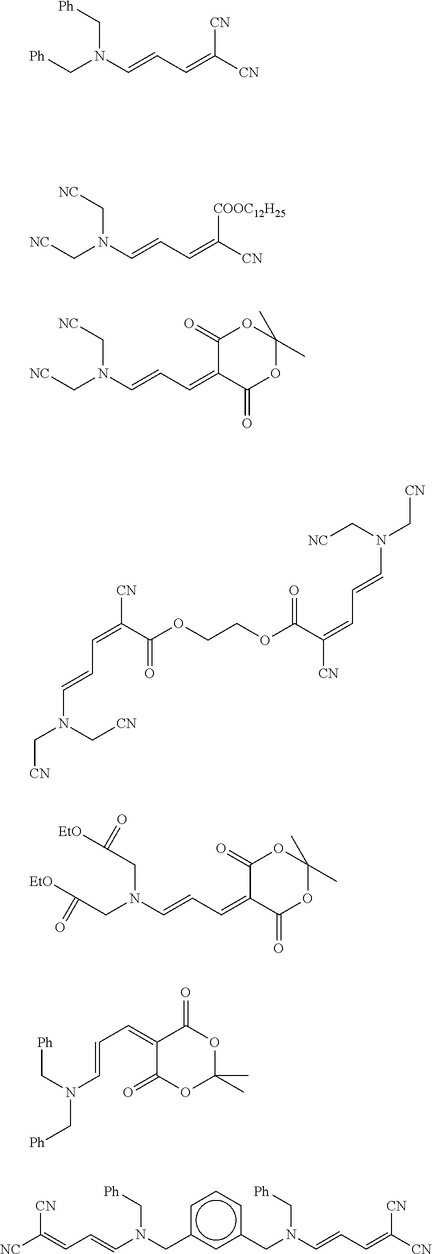

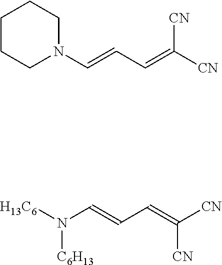

Preferably, the dope to be used in the invention further contains a triazine compound represented by formula (II).

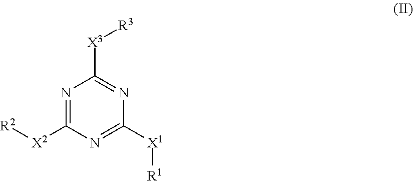

In formula (II), X¹ represents —NR⁴—, —O— or —S—; X² represents —NR^{S}—, —O— or —S—; X³ represents —NR⁶—, —O— or —S—; R¹, R², and R³ respectively represent an alkyl group, an alkenyl group, an aryl group or a heterocyclic group; and R⁴, R⁵ and R⁶ respectively represent a hydrogen atom, an alkyl group, an alkenyl group, an aryl group or a heterocyclic group.

In formula (II), R¹, R², and R³ respectively represent an alkyl group, an alkenyl group, an aryl group or a heterocyclic group, and preferably represent an aryl group or a heterocyclic group. The aryl group represented by formula R¹, R² or R³ is preferably phenyl or naphthyl, or more preferably phenyl.

In the formula, R¹, R², and R³ may have at least one substituent in the aryl or heterocyclic group. Examples of the substituent include halogen atoms, hydroxyl, cyano, nitro, carboxyl, alkyls, alkenyls, aryls, alkoxys, alkenyloxys, aryloxys, acyloxys, alkoxycarbonyls, alkenyloxycarbonyls, aryloxycarbonyls, sulfamoyls, alkyl-substituted sulfamoyls, alkenyl-substituted sulfamoyls, aryl-substituted sulfamoyls, sulfonamides, carbamoyls, alkyl-substituted carbamoyls, alkenyl-substituted carbamoyls, aryl-substituted carbamoyls, amides, alkylthios, alkenylthios, arylthios and acyls.

The heterocyclic group represented R¹, R² or R³ is preferably aromatic. Usually, an aromatic heterocycle belongs to unsaturated heterocycles, and the heterocycle in the heterocyclic group is preferably selected from unsaturated heterocycles having the maximum number of double bonds. The heterocycle is preferably a 5-, 6- or 7-membered ring, more preferably a 5- or 6-membered ring, or even more preferably 6-membered ring. The hetero atom embedded in the heterocycle is preferably a nitrogen atom. Examples of the aromatic heterocycle include pyridine rings (as the heterocyclic group, 2-pyridyl or 4-pyridyl is preferable). The heterocyclic group may have at least one substituent. Examples of the substituent are same as those exemplified above. These substituents may have at least one substituent selected from them.

The alkyl represented by R⁴, R⁵ or R⁶ may be a cycloalkyl or chain-like alkyl; the chain-like alkyl is preferable; and the linear chain-like alkyl is preferred to the branched chain-like alkyl. The number of carbon atoms in the alkyl is preferably from 1 to 30, more preferably from 1 to 20, even more preferably from 1 to 8, or even much more preferably from 1 to 6. The alkyl may have at least one substituent. Examples of the substituent include halogen atoms, alkoxyls such as methoxy and ethoxy, and acyloxys such as acryloyloxy and methacryloyloxy.

The alkenyl represented by R⁴, R⁵ or R⁶ may be a cycloalkenyl or chain-like alkenyl; the chain-like alkenyl is preferable; and the linear chain-like alkenyl is preferred to the branched chain-like alkenyl. The number of carbon atoms in the alkenyl is preferably from 2 to 30, more preferably from 2 to 20, even more preferably from 2 to 8, or even much more preferably from 2 to 6. The alkenyl may have at least one substituent. Examples of the substituent are same as those exemplified above as the substituent of the alkyl.

The aryl or heterocyclic group represented by R⁴, R⁵ or R⁶ is defined same as that represented by R¹, R² or R³; and the preferable examples are same as those of that represented by R¹, R² or R³. The aryl or heterocyclic group may have at least one substituent, and examples of the substituent include those exemplified above as the substituent of the aryl or heterocyclic group represented by R¹, R² or R³.

Preferable examples of the triazine compound represented by formula (II) include, but are not limited to, those described below.

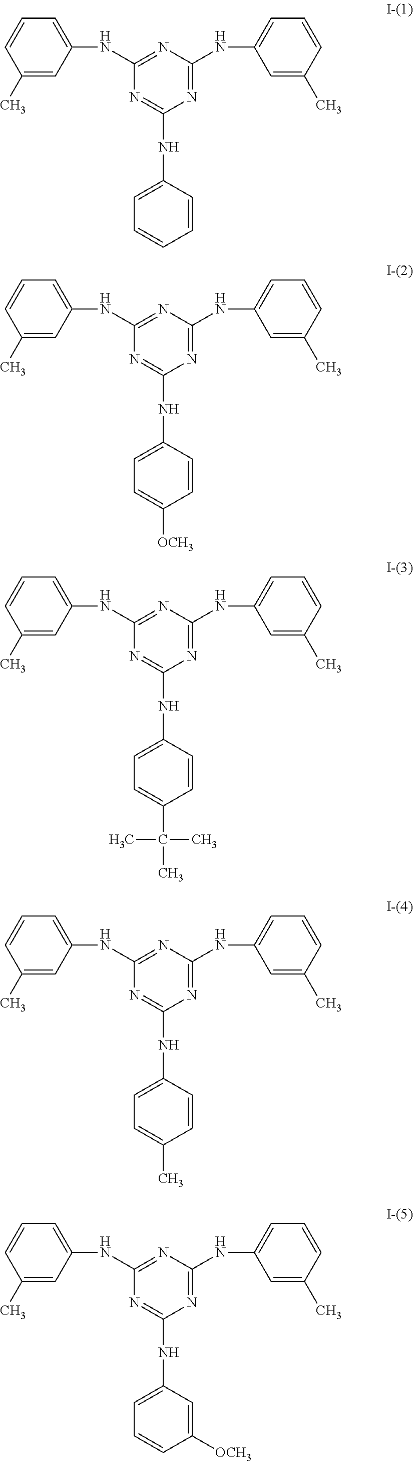

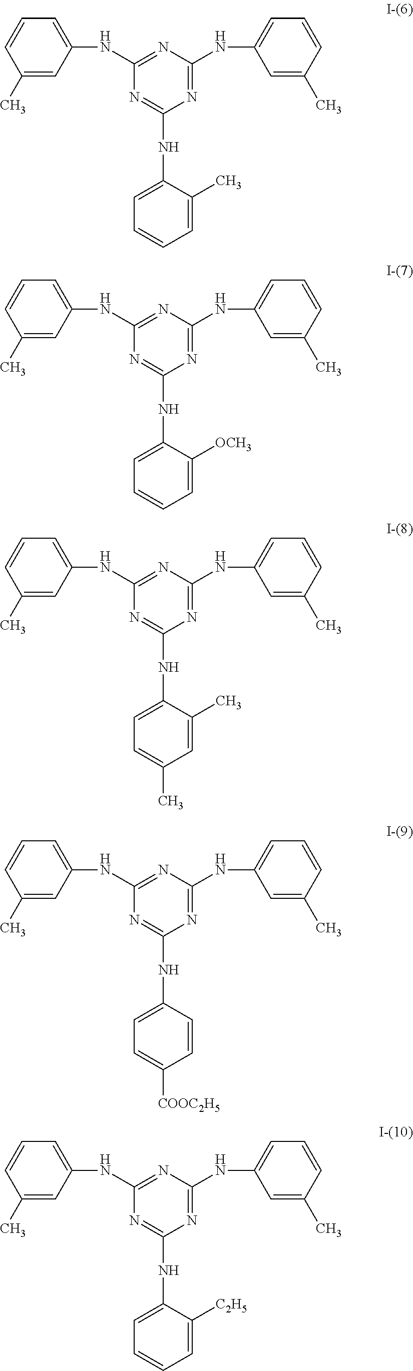

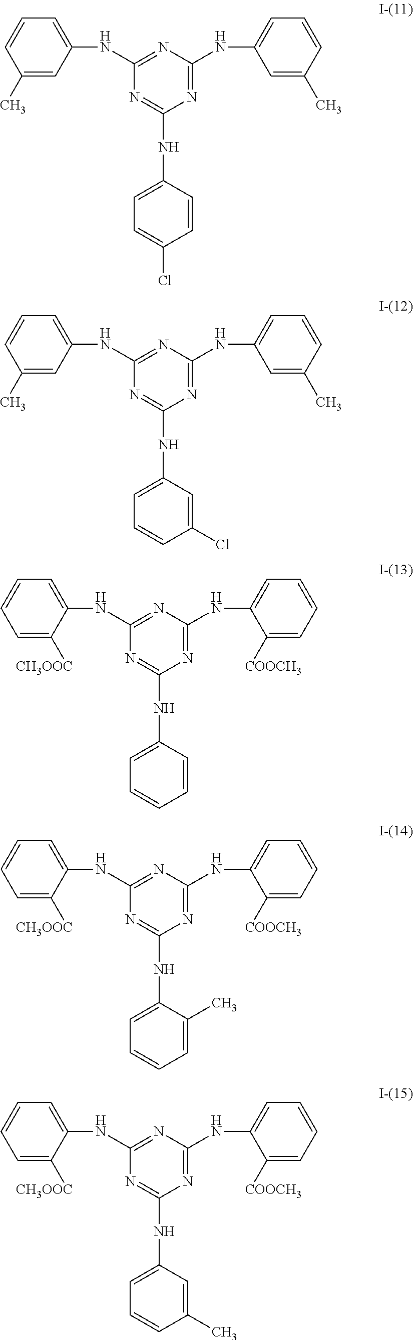

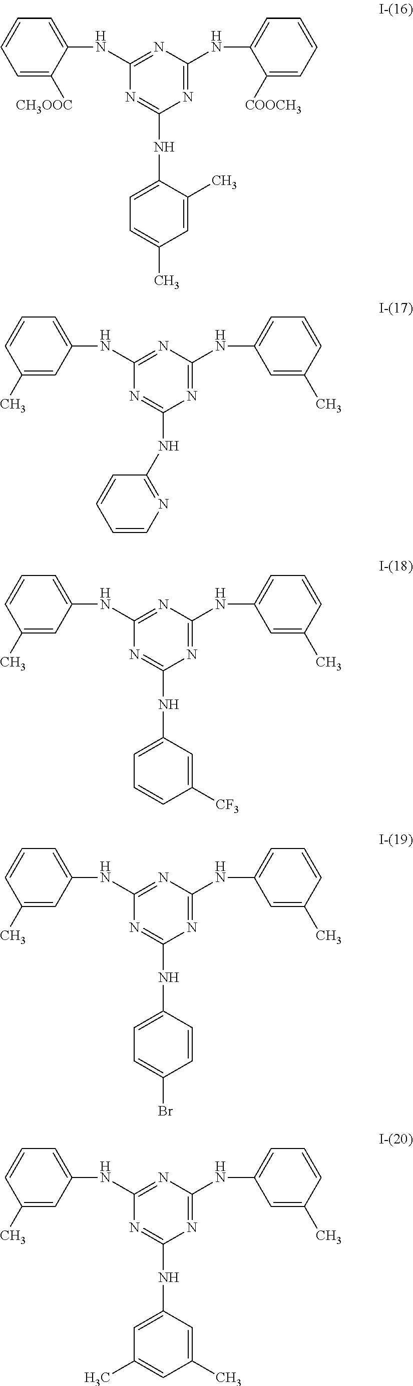

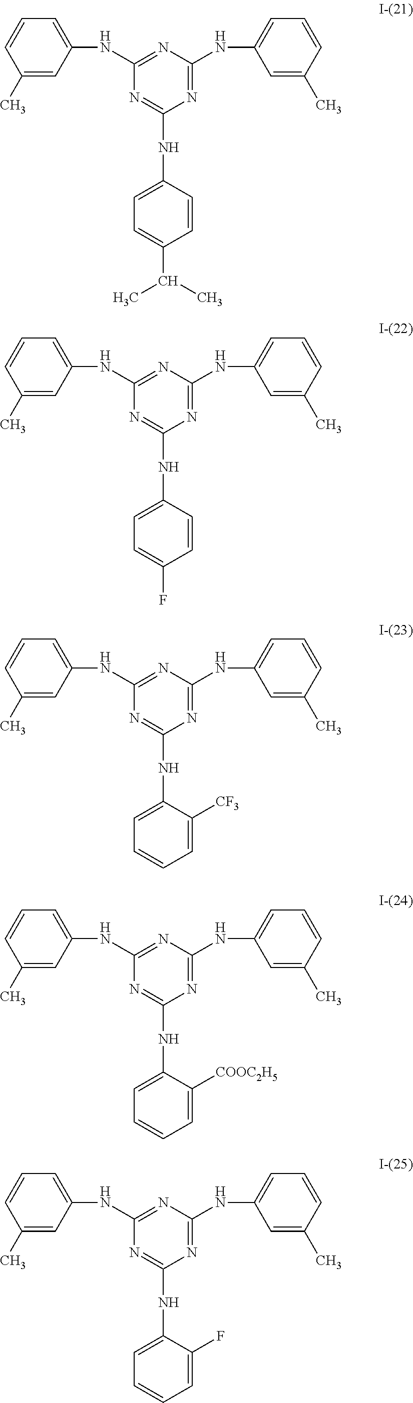

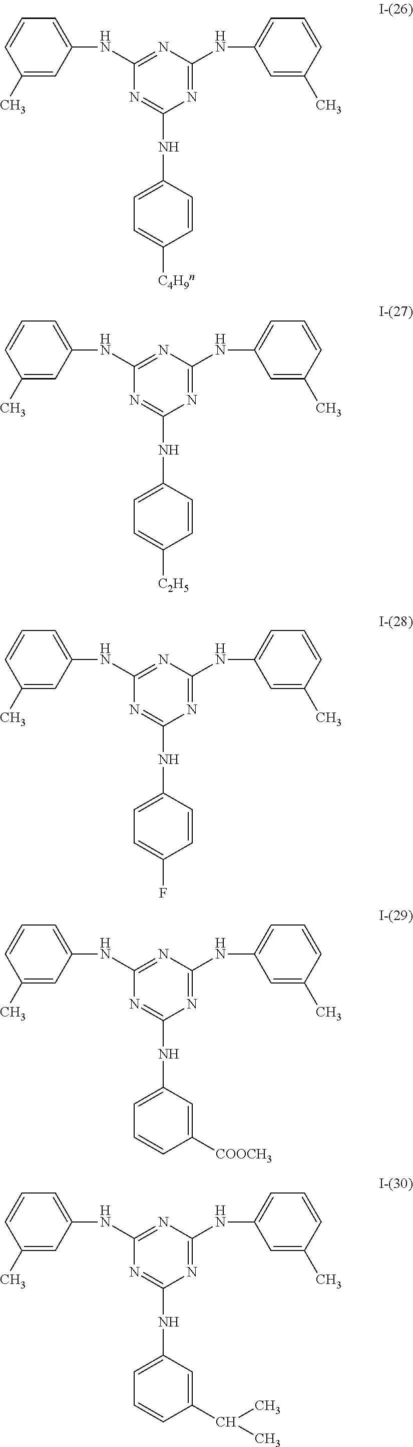

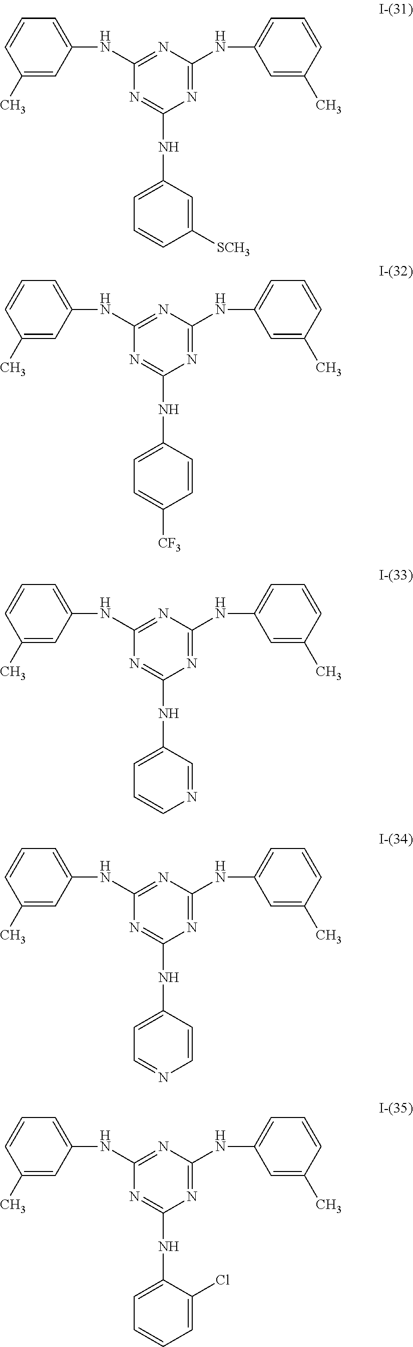

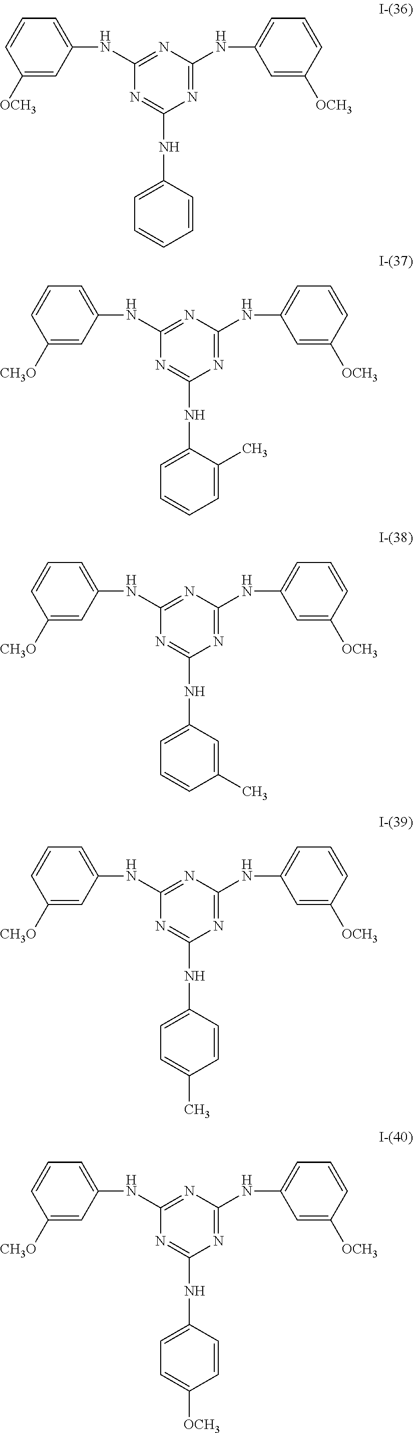

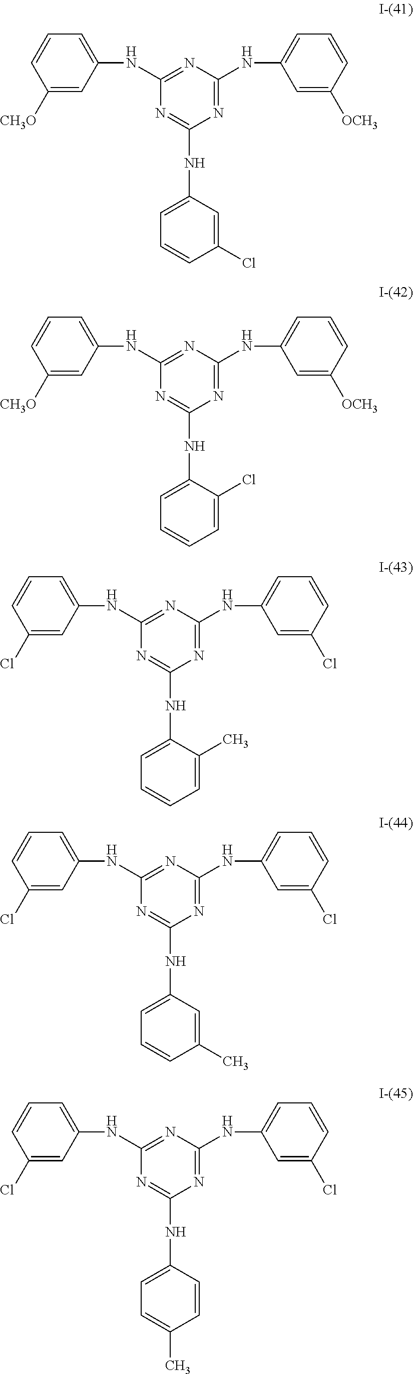

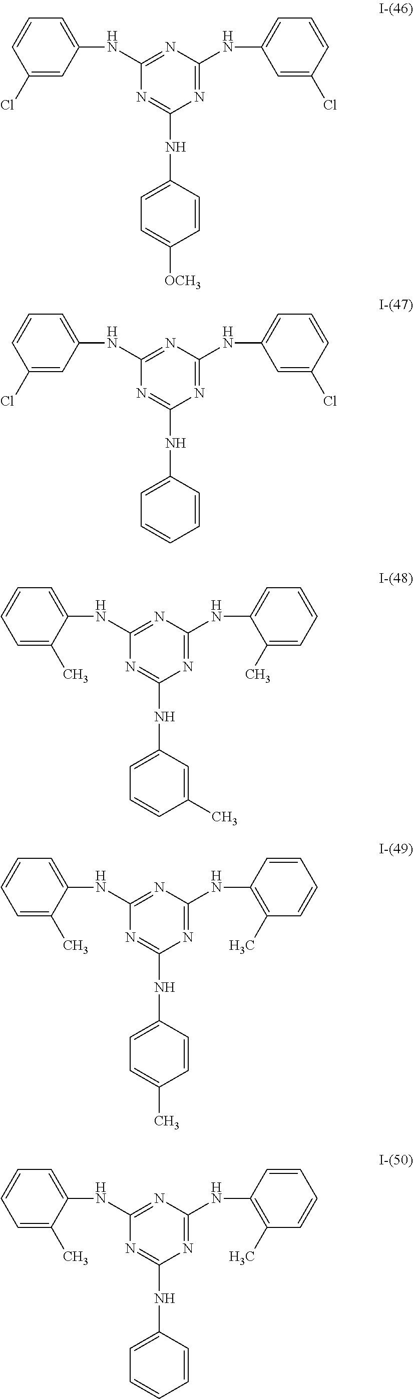

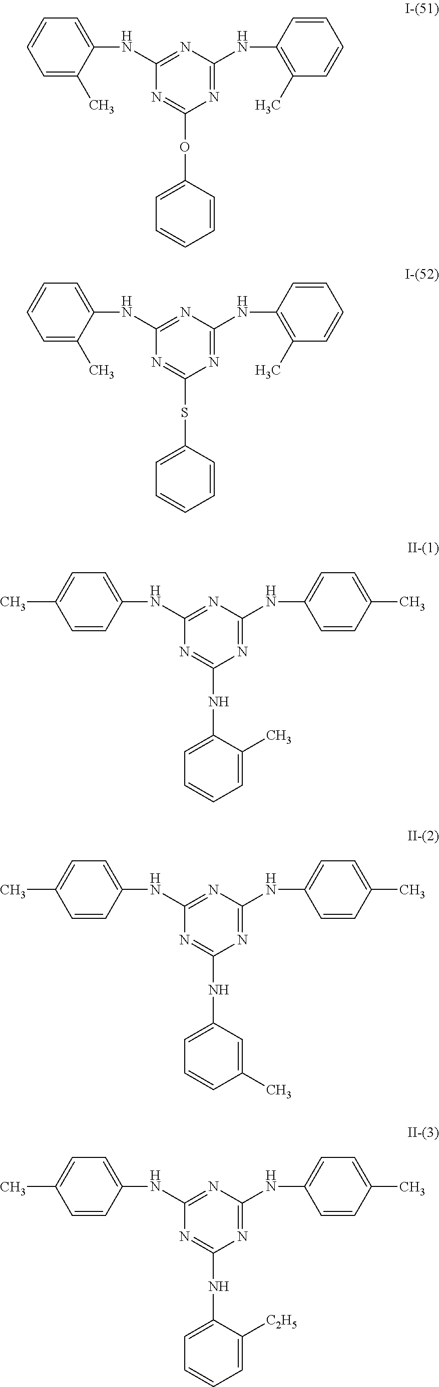

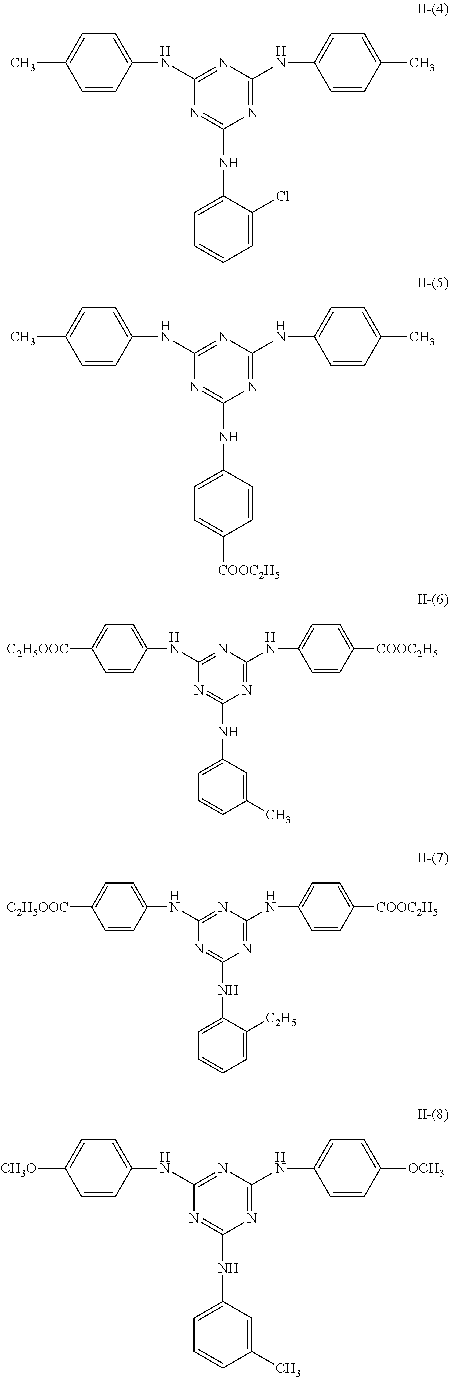

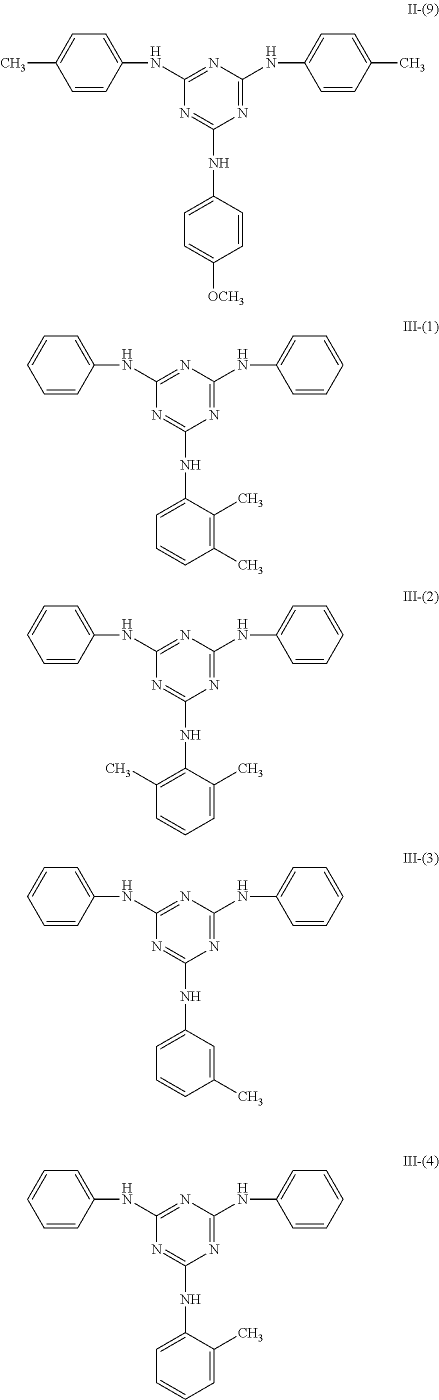

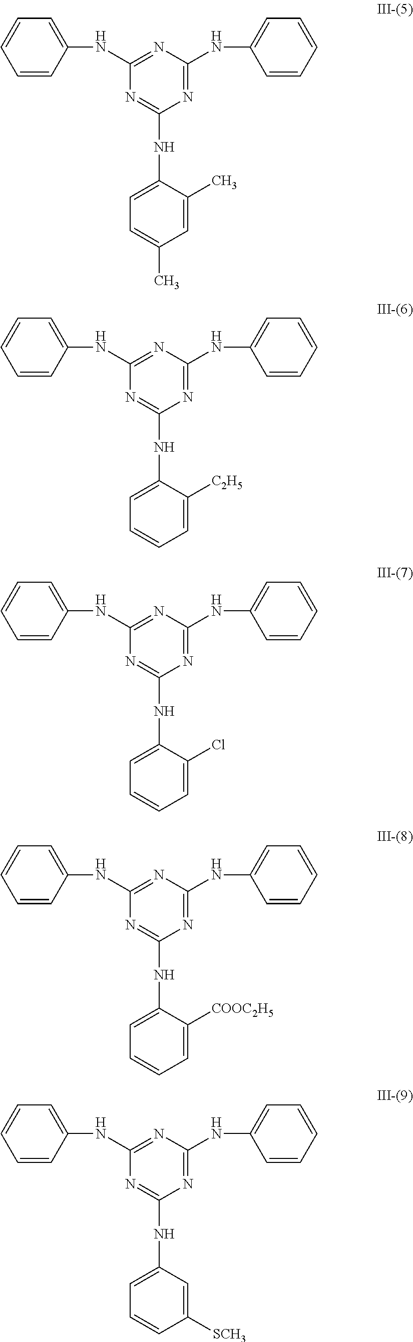

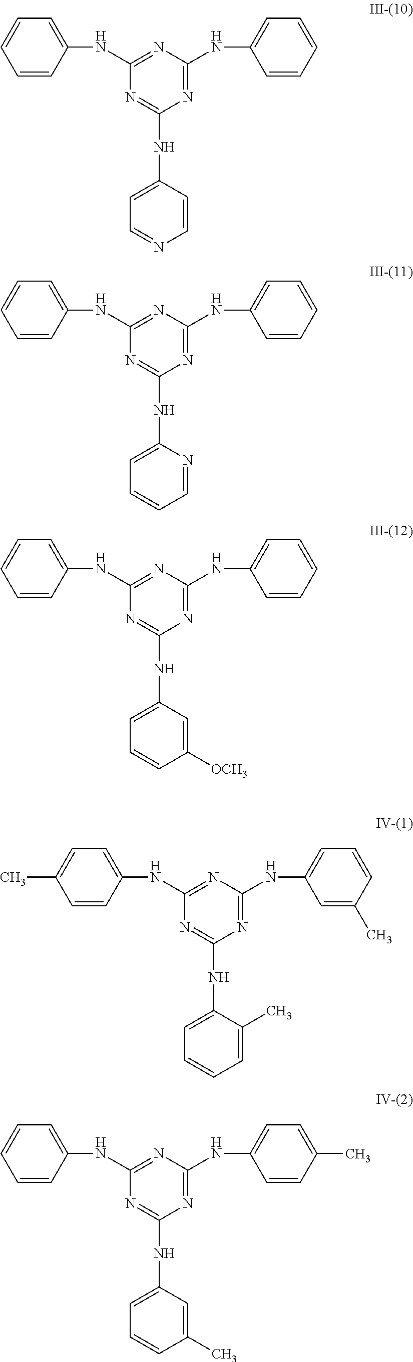

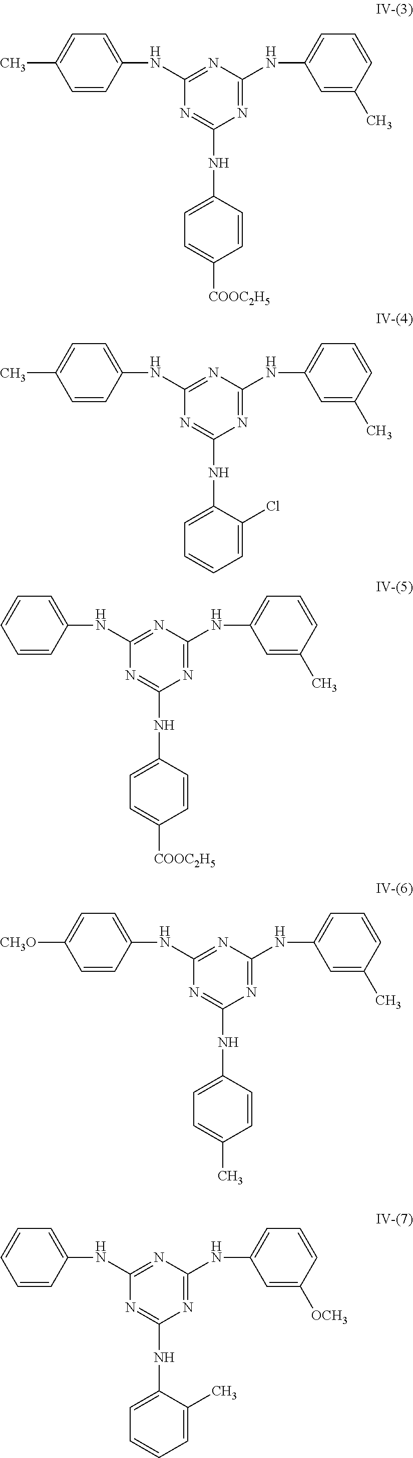

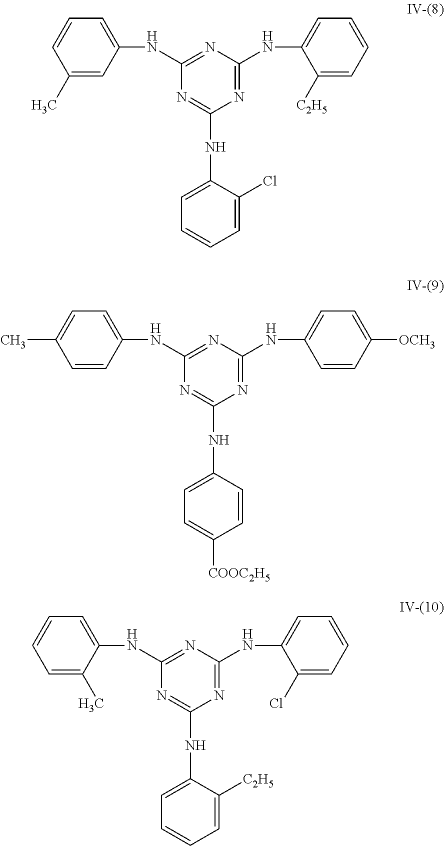

The agent for controlling wavelength dispersion characteristics of retardation or the triazine compound may be added in advance at the time of preparing a solution mixture of the cellulose acylate, or may be added at any time during the course from preparing in advance a dope of the cellulose acylate to casting. In the case of latter, to add and mix in-line a dope solution in which the cellulose derivative is dissolved in a solvent, and a solution in which the chromatic dispersion controlling agent and a small amount of the cellulose derivative are dissolved, an in-line mixer such as, for example, a static mixer (manufactured by Toray Engineering Co., Ltd.), an SWJ (a Toray static in-line mixer, Hi-Mixer) or the like is favorably used. To the agent for controlling wavelength dispersion characteristics of retardation being added later, a matting agent may be added at the same time, or additives such as the retardation controlling agent, plasticizer (e.g., triphenyl phosphate or biphenyl phosphate), anti-deterioration agent, peeling accelerator and the like may also be added. In the case of using an in-line mixer, it is preferable to dissolve at high concentration under high pressure, and the type of the pressurizing vessel is not particularly limited, as long as the vessel can endure the predetermined pressure, and heating and stirring can be performed under high pressure. The pressurizing vessel is also appropriately equipped with measuring gauges such as a barometer, a thermometer and the like. Pressurization may be performed by injecting an inert gas such as nitrogen gas or the like, or by increasing the vapor pressure of the solvent by heating. Heating is preferably performed externally, and for example, a jacketed type of heater is easy and preferable for temperature control. The heating temperature after adding a solvent is at or above the boiling point of the solvent used, and preferably at a temperature in which the solvent does not boil; for example, it is suitable to set the temperature to the range of 30 to 150 degrees Celsius. Also, the pressure is adjusted so that the solvent does not boil at the set temperature. After dissolution, the dope is removed from the vessel while cooling, or the solution is extracted from the vessel by a pump or the like and then cooled by a heat exchanger or the like, and the resultant is supplied for film formation. Herein, the cooling temperature may be lowered to room temperature, but it is preferable to cool the dope to a temperature 5 to 10 degrees Celsius lower than the boiling point, and to perform casting at that temperature, in view of reducing the dope viscosity.

The agent for controlling wavelength dispersion characteristics of retardation or the triazine compound may be used singularly respectively, or they may be used as a mixture of two or more types thereof respectively.

An amount of the agent for controlling wavelength dispersion characteristics of retardation to be added to the cellulose acylate is preferably from 1.0 to 20% by mass, more preferably from 1.0 to 10% by mass, even more preferably from 1.5 to 8.0% by mass, or even much more preferably from 2.0 to 6.0% by mass, with respect to the amount of the cellulose acylate.

An amount of the triazine compound represented by formula (II) contained in the film is preferably from 10% by mass (0.1 time) to 1000% by mass (10 times), or more preferably from 20% by mass (0.2 time) to 750% by mass (7.5 times), with respect to the amount of the agent for controlling wavelength dispersion characteristics of retardation.

One example of the method of adding the agent for controlling wavelength dispersion characteristics of retardation or the triazine compound represented by formula (II) is as follows. The agent for controlling wavelength dispersion characteristics of retardation or the triazine compound represented by formula (II) is dissolved in an organic solvent such as dioxolane, and then the solution is added to a cellulose acylate solution (dope). Or they are directly added to the dope.

The triazine compound represented by formula (II) may suppress the decomposition of the merocyanine compound represented by formula (IX), and improve the lightfastness of the merocyanine compound. Therefore, the triazine compound represented by formula (II) is preferably used in combination with the merocyanine compound represented by formula (IX).

### Stabilizer:

The stabilizer may be added to the polymer film for the purpose of preventing the polymer from discoloring or thermally degrading in film formation.

The stabilizer is a compound having the ability to prevent the polymer itself from decomposing and denaturing, and is selected from antioxidant, radical inhibitor, peroxide decomposing agent, metal inactivator, acid scavenger, and light stabilizer. In the invention, any of these stabilizers are employable. Of those stabilizers, preferred for use in the invention are antioxidant and radical inhibitor, and more preferred is antioxidant.

An amount of the stabilizer is preferably almost equal to the amount of the agent for controlling wavelength dispersion characteristics of retardation, and is preferably from 0.2 to 20% by mass with respect to the amount of the cellulose acylate.

As the antioxidant, preferred are phosphorous acid skeleton-having phosphoric acid compounds, thioether structure-having sulfur compounds, pentaerythritol skeleton structure-having phosphate compounds, lactone structure-having lactone compounds; and as the radical inhibitor, preferred are hydroxyl group-substituted aromatic ring-having phenolic compounds, substituted or unsubstituted amino group-having amine compounds; as the peroxide decomposing agent, preferred are phenolic compounds, amine compounds; as the metal inactivator, preferred are amide bond-having amide compounds; as the acid scavenger, preferred are epoxy group-having epoxy compounds; and as the light stabilizer, preferred are amine compounds.

One or more different types of those stabilizers may be used here either singly or as combined; or compounds having two or more different functions in one molecule are also usable here.

Preferably, the volatility of the stabilizer is fully low at high temperatures. Preferably, at least one stabilizer having a molecular weight of at least 500 is in the polymer film. More preferably, the molecular weight of the stabilizer is from 500 to 4000, even more preferably from 530 to 3500, still more preferably from 550 to 3000. Having a molecular weight of at least 500, the thermal volatility of the compound could be well low; and having a molecular weight of at most 4000, the miscibility of the compound with cellulose acylate is good.

As the stabilizer, herein usable are commercial products. For example, preferred for use herein are pentaerythritol skeleton structure-having phosphate antioxidants such as cyclic neopentanetetraylbis(2,6-di-t-butyl-4-methylphenyl)phosphite (ADEKA's “Adekastab PEP-36”), etc.

### Other Additives:

The dope to be used in the invention may contain at least one additive along with a cellulose acylate, a main ingredient, and the aromatic group-containing oligomer as far as the effect of the invention is lowered. Examples of the additive include a retardation controlling agent (a preferable amount of it is from 0.01 to 10% by mass with respect to the amount of the cellulose acylate. The numerical ranges in the following parenthesises are same meanings), UV absorber (from 0.01 to 20% by mass), fine particles having a mean particle size of from 5 to 3000 nm (from 0.001 to 1% by mass), fluorosurfactant (from 0.001 to 1% by mass), release agent (from 0.0001 to 1% by mass), anti-degradation agent (from 0.0001 to 1% by mass) and infrared absorber (from 0.001 to 1% by mass).

However, the invention can achieve high Re and Rth by using only the cellulose acylate and the aromatic group-containing oligomer or by using only the cellulose acylate, the aromatic group-containing oligomer and other additive(s) not influencing Re/Rth of the film, which is one of the feature of the invention.

Next, the properties and applications of the cellulose acylate film produced according to the process of the invention are described in detail.

### 2. Properties of Cellulose Acylate Film

### (Optical Properties)

As described above, according to the process of the invention, a cellulose acylate film having high Re and Rth can be produced.

More specifically, a cellulose acylate film having Re of from 5 to 20 nm and Rth of from 90 to 150 nm can be produced. The film is useful as an optical element to be used in liquid crystal display devices, and is especially useful as optical compensation element to be used in liquid crystal display devices employing a twisted-alignment mode such as TN-mode.

A cellulose acylate film having Re of from 5 to 50 nm and Rth of from 90 to 150 nm can be also produced. The film is useful as an optical element to be used in liquid crystal display devices, and is especially useful as optical compensation element to be used in liquid crystal display devices employing a vertical-alignment mode such as VA-mode.

The cellulose acylate film produced according to the process of the invention preferably satisfies the following relation

0.9<Rth(450)/Rth(550)≦1.5 (1),

more preferably satisfies the following relation

1.0<Rth(450)/Rth(550)<1.5 (1′), or

even more preferably satisfies the following relation

1.1<Rth(450)/Rth(550)<1.5 (1′″),

in terms of yellowish in the middle tone state observed in oblique directions of a liquid crystal display device employing a twisted-alignment mode.

Rth (550) means retardation along the thickness direction at 550 nm wavelength, and Rth(450) means retardation along the direction at 450 nm wavelength.

In this description, Re and Rth (unit: nm) are obtained according to the following method. A film to be analyzed is conditioned at 25 degrees Celsius and a relative humidity of 60% for 24 hours. Using a prism coupler (Model 2010 Prism Coupler, by Metricon) and using a solid laser at 532 nm, the mean refractivity (n) of the film, which is represented by the following formula (2), is obtained at 25 degrees Celsius and a relative humidity of 60%.

n=(n_{TE}×2+n+n_{TM})/3 (2)

[n_{TE} is the refractive index measured with polarized light in the in-plane direction of the film; and n_{TM} is the refractive index measured with polarized light in the normal direction to the face of the film.]

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments).

When a film to be analyzed is expressed by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (3) and (4):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( 3 ) \\ Rth = ( - \frac{nx + ny}{2} - nz ) \times d & ( 4 )\end{matrix}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

### (Slow Axis)

According to the process of the invention, the slow axis of the cellulose acylate film is decided depending on the stretching direction in the stretching to be carried out before the heat-treatment step. The cellulose acylate film having the slow axis along the direction perpendicular to the long direction (MD) is preferable, in terms of the productivity of polarizing plates. Preferably, in the cellulose acylate film, the angle between the long direction of the film and the slow axis is preferably 0±10 degrees or 90±10 degrees, more preferably 0±5 degrees or 90±5 degrees, even more preferably 0±3 degrees or 90±3 degrees, as the case may be, still more preferably 0±1 degree or 90±1 degrees, most preferably 90±1 degrees.

### (Film Thickness)

Preferably, the thickness of the cellulose acylate film is from 20 micro meters to 180 micro meters, more preferably from 30 micro meters to 160 micro meters, even more preferably from 40 micro meters to 120 micro meters. When the film thickness is at least 20 micro meters, then the film is favorable in terms of the handlability thereof in working the film into polarizer or the like and of the ability thereof to prevent curling of polarizer. Also preferably, the thickness unevenness of the cellulose acylate film is from 0 to 2% both in the MD and in the TD, more preferably from 0 to 1.5%, even more preferably from 0 to 1%.

### (Moisture Permeability)

The moisture permeability of the cellulose acylate film is preferably at least 100 g/(m²·day) in terms of the film having a thickness of 80 micro meters. Having the moisture permeability of at least 100 g/(m²·day) in terms of the film having a thickness of 80 micro meters, the film may be readily stuck to a polarizing film. The moisture permeability in terms of the film having a thickness of 80 micro meters is more preferably from 100 to 1500 g/(m²·day), even more preferably from 200 to 1000 g/(m²·day), still more preferably from 300 to 800 g/(m²·day).

In case where the cellulose acylate film is used as an outer protective film that is not disposed between a polarizing film and a liquid crystal cell as in the embodiment described below, the moisture permeability of the cellulose acylate film is preferably less than 500 g/(m²·day) in terms of the film having a thickness of 80 micro meters, more preferably from 100 to 450 g/(m²·day), even more preferably from 100 to 400 g/(m²·day), most preferably from 150 to 300 g/(m²·day). Within the range, the durability of polarizer to moisture or to wet heat may be improved, and liquid crystal display devices of high reliability can be provided.

### (ΔHc)

Preferably, the heat of crystallization, ΔHc, of the cellulose acylate film is from 0 to 4.0 J/g, more preferably from 2.0 to 3.0 J/g. Within the range, the Re expressibility of the film can be expanded.

### (Coloration)

Preferably, the cellulose acylate film is colored little and is excellent in colorless transparency. Concretely, the absorption at 400 nm of the film is at most 0.2, more preferably at most 0.1

### 3. Applications of Cellulose Acylate Films

The cellulose acylate film produced according to the process of the invention may be used in various applications. Especially, the film is useful as an optical element to be used in liquid crystal display devices. For example, the film may be used as an optical compensation film or a part thereof, or a protective film of polarizing plates. Preferable embodiments to be used in liquid crystal display devices employing any mode include, but are not limited, those described below.

### Cellulose Acylate Film for Liquid Crystal Display Device Employing Twisted-Alignment Mode:

In a liquid crystal display device (LCD) employing a twisted-alignment mode such as TN-mode, the cellulose acylate film produced according to the process of the invention may be used as an optical compensation film or a part thereof, or a protective film, which is preferably disposed at the liquid crystal side, of a polarizing plate. Preferably, the cellulose acylate film to be used in a LCD employing a twisted-alignment mode has Re of from 5 to 20 nm and Rth of from 90 to 150 nm.

An embodiment of the cellulose acylate film for a twisted-alignment mode LCD is a support of an optical compensation film having an optically anisotropic layer formed of a liquid crystal composition on the support. The cellulose acylate film may be used after being subjected to any surface treatment.

The liquid crystal composition to be used for preparing the optically anisotropic is preferably capable of forming a nematic or smectic phase. Usually, liquid crystal compounds are classified into rod-like or discotic liquid crystal compounds depending on their molecular shapes. According to the invention, liquid crystal compounds having any molecular shape may be used.

The thickness of the optically anisotropic layer formed of the liquid crystal composition is not limited, is preferably from 0.1 to 10 micro meters, or more preferably from 0.5 to 5 micro meters.

### (Materials of Optically Anisotropic Layer)

### (1) Discotic Liquid Crystal Compound

Examples of the discotic liquid crystalline compound which can be used in the invention include benzene derivatives described in the Research Report of C. Destrade, et al., Mol. Cryst. vol. 71, p. 111 (1981), -truxene derivatives described in Research Report by C. Destrade, et al., Mol. Cryst. vol. 122, p. 141 (1985), Physics, lett, A, vol. 78, p. 82 (1990), cyclohexane derivatives described in Research Report of B. Kohne, et al., Angew. Chem. vol. 96, p. 70 (1984) and aza crown type or phenyl acetylene type macrocycles described in Research Report of M. Lehn, J. Chem. Commun., p. 1794 (1985), and Research Report of J. Zhang, J. Am. Chem. Soc., vol. 116, p. 2655 (1994).

The discotic liquid crystalline compounds also include compounds showing liquid crystallinity of a structure in which linear alkyl groups, alkoxy groups or substituted benzoyloxy groups are substituted radially as side chains of a scaffold at the center of a molecule. Compounds in which a molecule or an aggregate of molecules have a rotational symmetry and can be provided with a certain alignment are preferred.

In a case of forming an optical anisotropic layer from a discotic liquid crystalline compound, it is no more necessary that the compound contained finally in the optically anisotropic layer shows crystallinity.

Preferable examples of the discotic liquid-crystal compound include the compounds described in JP-A-8-50206, in JP-A 2006-76992, paragraph [0052], and in JP-A 2007-2220, paragraphs [0040] to [0063]. The details of polymerization of discotic liquid crystal compounds are described in JP-A-8-27284. For example, the compounds of the formula (DI) are especially preferable since they show high birefringence.

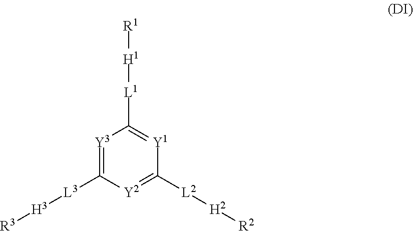

In formula (DI), Y¹, Y² and Y³ each independently represent a methine group or a nitrogen atom.

When each of Y¹, Y² and Y³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Of those, preferred are an alkyl group, an alkoxy group, an alkoxycarbonyl group, an acyloxy group, a halogen atom and a cyano group; more preferred are an alkyl group having from 1 to 12 carbon atoms (the term “carbon atoms” means hydrocarbons in a substituent, and the terms appearing in the description of the substituent of the discotic liquid crystal compound have the same meaning), an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹, Y² and Y³ are all methine groups, more preferably non-substituted methine groups, in terms of ease to cost of preparation.

In formula (DI), L¹, L² and L³ each independently represent a single bond or a bivalent linking group.

The bivalent linking group is preferably selected from —O—, —S—, —C(═O)—, —NR⁷—, —CH═CH—, —C≡C—, a bivalent cyclic group, and their combinations. R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group, occasionally referred to as cyclic group, represented by L¹, L² or L³ means any bivalent linking group having a cyclic structure. The cyclic group is preferably a 5-membered, 6-membered or 7-membered group, more preferably a 5-membered or 6-membered group, even more preferably a 6-membered group. The ring in the cyclic group may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring and a naphthalene ring. An example of the aliphatic ring is a cyclohexane ring. Examples of the hetero ring are a pyridine ring and a pyrimidine ring. Preferably, the cyclic group contains an aromatic ring or a hetero ring. In the invention, the bivalent cyclic group is preferably a bivalent cyclic group formed of only a cyclic structure which may have at least one substituent. The same is applied to the following description.

Of the bivalent cyclic group, the benzene ring-having cyclic group is preferably a 1,4-phenylene group. The naphthalene ring-having cyclic group is preferably a naphthalene-1,5-diyl group or a naphthalene-2,6-diyl group. The pyridine ring-having cyclic group is preferably a pyridine-2,5-diyl group. The pyrimidine ring-having cyclic group is preferably a pyrimidin-2,5-diyl group.

The bivalent cyclic group for L¹, L² and L³ may have a substituent. Examples of the substituent are a halogen atom (preferably a fluorine or chlorine atom), cyano, nitro, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, *—CH═CH—, *-“bivalent cyclic group”-, *—O—CO-“bivalent cyclic group”-, *—CO—O-“bivalent cyclic group”-, *—CH═CH-“bivalent cyclic group”-, *—C≡C—“bivalent cyclic group”-, *-“bivalent cyclic group”-O—CO—, *-“bivalent cyclic group”-CO—O—, *-“bivalent cyclic group”-CH═CH—, or *-“bivalent cyclic group”-C≡C—. More preferably, they are a single bond, *—CH═CH—, *—C≡C—, *—CH═CH-“bivalent cyclic group”- or *—C≡C-“bivalent cyclic group”-, even more preferably a single bond. In the examples, “*” indicates the position at which the group bonds to the 6-membered ring of formula (DI) that contains Y¹¹, Y¹² and Y¹³.

In formula (DI), H¹, H² and H³ each independently represent the following formula (I-A) or (I-B):

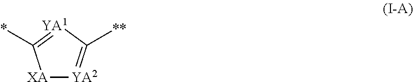

In formula (I-A), YA¹ and YA² each independently represent a methine group or a nitrogen atom; XA represents an oxygen atom, a sulfur atom, a methylene group or an imino group; * indicates the position at which the formula bonds to any of L¹ to L³ in formula (DI); and ** indicates the position at which the formula bonds to any of R¹ to R³ in formula (DI).

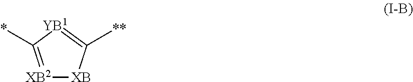

In formula (I-B), YB¹ and YB² each independently represent a methine group or a nitrogen atom; XB represents an oxygen atom, a sulfur atom, a methylene group or an imino group; * indicates the position at which the formula bonds to any of L¹ to L³ in formula (DI); and ** indicates the position at which the formula bonds to any of R¹ to R³ in formula (DI).

In the formula, R¹, R² and R³ each independently represent the following formula (I-R):

*-(L¹⁰¹-Q²)ₙ₁-L¹⁰²-L¹⁰³-Q¹ (I-R)

In formula (I-R), * indicates the position at which the formula bonds to H¹, H² or H³ in formula (DI).

L¹⁰¹ represents a single bond or a bivalent linking group. When L¹⁰¹ is a bivalent linking group, it is preferably selected from a group consisting of —O—, —S—, —C(═O)—, —NR⁷—, —CH═CH—, —C≡C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L¹⁰¹ is preferably a single bond, **—O—CO—, **—CO—O—, **—CH═CH— or **—C≡C— (in which ** indicates the side indicated by “*” in formula (I-R)). More preferably it is a single bond.

In formula (I-R), Q² represents a bivalent cyclic linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring, a naphthalene ring, an anthracene ring, a phenanthrene ring. An example of the aliphatic ring is a cyclohexane ring. Examples of the hetero ring are a pyridine ring and a pyrimidine ring.

The benzene ring-having group for Q² is preferably a 1,4-phenylene group. The naphthalene ring-having group is preferably a naphthalene-1,4-diyl group, a naphthalene-1,5-diyl group, a naphthalene-1,6-diyl group, a naphthalene-2,5-diyl group, a naphthalene-2,6-diyl group, or a naphthalene-2,7-diyl group. The cyclohexane ring-having group is preferably a 1,4-cyclohexylene group. The pyridine ring-having group is preferably a pyridine-2,5-diyl group. The pyrimidine ring-having group is preferably a pyrimidin-2,5-diyl group. More preferably, Q² is a 1,4-phenylene group, a naphthalene-2,6-diyl group, or a 1,4-cyclohexylene group.

In the formula, Q² may have a substituent. Examples of the substituent are a halogen atom (e.g., fluorine atom, chlorine atom, bromine atom, iodine atom), cyano, nitro, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n1 indicates an integer of from 0 to 4. n1 is preferably an integer of from 1 to 3, more preferably 1 or 2.

In the formula, L¹⁰² represents **—O—, **—O—CO—, **—CO—O—, **—O—CO—, **—CH₂—, **—NH—, **—SO₂—, **—CH₂—, **—CH═CH— or **—C═C—, where “**” indicates the site linking to the Q² side.

L¹⁰² preferably represents **—O—, **—O—CO—, **—CO—O—, **—O—CO—O—, **—CH₂—, **—CH═CH— or **—C≡C—, or more preferably **—O—, **—O—CO—, **—O—CO—O— or **—CH₂—.

When the above group has a hydrogen atom, then the hydrogen atom may be substituted with a substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L¹⁰³ represents a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms. The group substituted with the substituent improves the solubility of the compound of formula (DI) in solvent, and therefore the composition of the invention containing the compound can be readily prepared as a coating liquid.

In the formula, L¹⁰³ is preferably a linking group selected from a group consisting of —O—, —C(═O)—, —CH₂—, —CH═CH— and —C═C—, and a group formed by linking two or more of these. L¹⁰³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizable group or a hydrogen atom. When the compound of formula (DI) is used in producing optical films of which the retardation is required not to change by heat, such as optical compensatory films, Q¹ is preferably a polymerizable group. The polymerization for the group is preferably addition polymerization (including ring-cleavage polymerization) or polycondensation. In other words, the polymerizing group preferably has a functional group that enables addition polymerization or polycondensation. Examples of the polymerizing group are shown below.

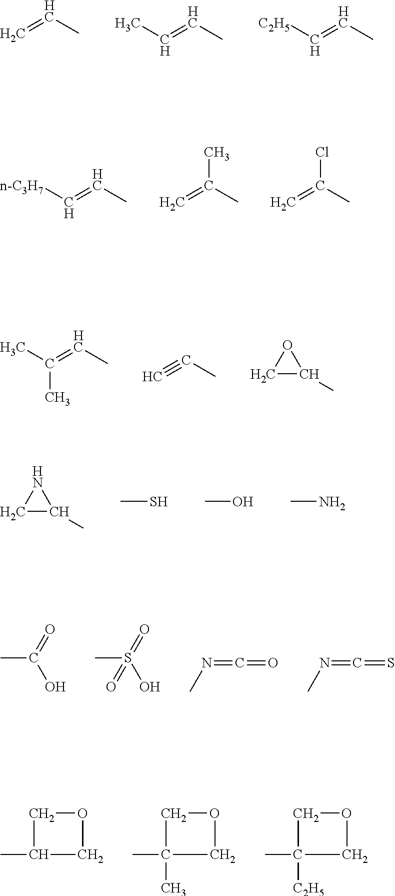

More preferably, the polymerizable group is addition-polymerizable functional group. The polymerizable group of the type is preferably a polymerizable ethylenic unsaturated group or a ring-cleavage polymerizable group.

Examples of the polymerizable ethylenic unsaturated group are the following (M-1) to (M-6):

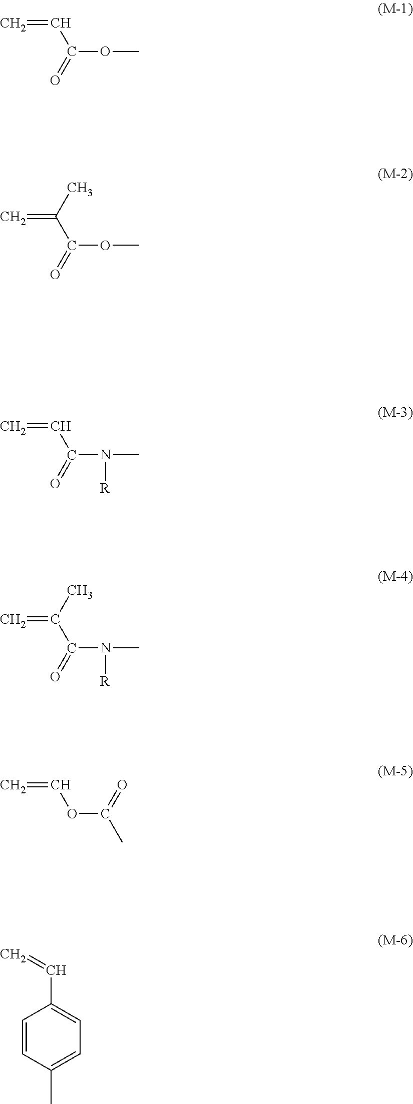

In formulae (M-3) and (M-4), R represents a hydrogen atom or an alkyl group. R is preferably a hydrogen atom or a methyl group. Of formulae (M-1) to (M-6), preferred are formulae (M-1) and (M-2), and more preferred is formula (M-1).

The ring-cleavage polymerizable group is preferably a cyclic ether group, or more preferably an epoxy group or an oxetanyl group.

Among the compounds represented by formula (DI), the compounds represented by formula (DI′) are preferable.

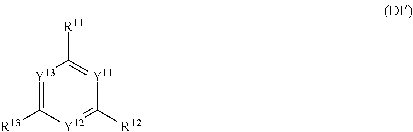

In formula (DI′), Y¹¹, Y¹² and Y¹³ each independently represent a methine group or a nitrogen atom, preferably represent a methine, or even more preferably represent a non-substituted methine.

In the formula, R¹¹, R¹² and R¹³ each independently represent the following formula represent the following formula (I′-A), (I′-B) or (I′-C). When the small wavelength dispersion of birefringence is needed, preferably, R¹¹, R¹² and R¹³ each represent the following formula (I′-A) or (I′-C), more preferably the following formula (I′-A). Preferably, R¹¹, R¹² and R¹³ are same (R¹¹=R¹²=R¹³).

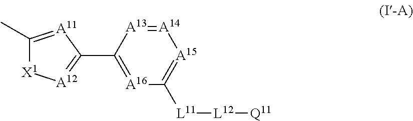

In formula (I′-A), A¹¹, A¹², A¹³, A¹⁴, A¹⁵ and A¹⁶ each independently represent a methine group or a nitrogen atom.

Preferably, at least one of A¹¹ and A¹² is a nitrogen atom; more preferably the two are both nitrogen atoms.

Preferably, at least three of A¹³, A¹⁴, A¹⁵ and A¹⁶ are methine groups; more preferably, all of them are methine groups. Non-substituted methine is more preferable.

Examples of the substituent that the methine group represented by A¹¹, A¹², A¹³, A¹⁴, A¹⁵ or A¹⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X¹ represents an oxygen atom, a sulfur atom, a methylene group or an imino group, but is preferably an oxygen atom.

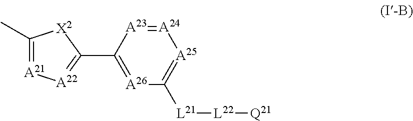

In formula (I′-B), A₂₁, A²², A²³, A²⁴, A²⁵ and A²⁶ each independently represent a methine group or a nitrogen atom.

Preferably, at least either of A²¹ or A²² is a nitrogen atom; more preferably the two are both nitrogen atoms.

Preferably, at least three of A²³, A²⁴, A²⁵ and A²⁶ are methine groups; more preferably, all of them are methine groups.

Examples of the substituent that the methine group represented by A²³, A²⁴, A²⁵ or A²⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X² represents an oxygen atom, a sulfur atom, a methylene group or an imino group, but is preferably an oxygen atom.

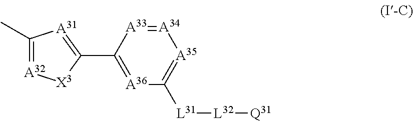

In formula (I′-C), A³¹, A³², A³³, A³⁴, A³⁵ nd A³⁶ each independently represent a methine group or a nitrogen atom.

Preferably, at least either of A³¹ or A³² is a nitrogen atom; more preferably the two are both nitrogen atoms.

Preferably, at least three of A³³, A³⁴, A³⁵ and A³⁶ are methine groups; more preferably, all of them are methine groups.

When A³³, A³⁴, A³⁵ and A³⁶ are methine groups, the hydrogen atom of the methine group may be substituted with a substituent. Examples of the substituent that the methine group may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X³ represents an oxygen atom, a sulfur atom, a methylene group or an imino group, but is preferably an oxygen atom.

L¹¹ in formula (I′-A), L²¹ in formula (I′-B) and L³¹ in formula (I′-C) each independently represent —O—, —O—CO—, —CO—O—, —O—CO—O—, —S—, —NH—, —SO₂—, —CH₂—, —CH═CH— or —C≡C—; preferably —O—, —O—CO—, —CO—O—, —O—CO—O—, —CH₂—, —CH═CH— or —C≡C—; more preferably —O—, —O—CO—, —CO—O—, —O—CO—O— or —C≡C—. L¹¹ in formula (I′-A) is especially preferable O—, —CO—O— or —C≡C— in terms of the small wavelength dispersion of birefringence; among these, —CO—O— is more preferable because the discotic nematic phase may be formed at a higher temperature. When above group has a hydrogen atom, then the hydrogen atom may be substituted with a substituent. Preferred examples of the substituent are a halogen atom, cyano, nitro, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

L¹² in formula (I′-A), L²² in formula (I′-B) and L³² in formula (I′-C) each independently represent a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with a substituent. Preferred examples of the substituent are a halogen atom, cyano, nitro, hydroxy, carboxyl, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. More preferred are a halogen atom, hydroxy and an alkyl group having from 1 to 6 carbon atoms; and especially preferred are a halogen atom, methyl and ethyl.

Preferably, L¹², L²² and L³² each independently represent a bivalent linking group selected from —O—, —C(═O)—, —CH₂—, —CH═CH— and —C≡C—, and a group formed by linking two or more of these.

Preferably, L¹², L²² and L³² each independently have from 1 to 20 carbon atoms, more preferably from 2 to 14 carbon atoms. Preferably, L¹², L²² and L³² each independently have from 1 to 16 (—CH₂—)'s, more preferably from 2 to 12 (—CH₂—)'s.

The number of carbon atoms constituting the L¹², L²² or L³² may influence both of the liquid crystal phase transition temperature and the solubility of the compound. Generally, the compound having the larger number of the carbon atoms has a lower phase transition temperature at which the phase transition from the discotic nematic phase (Nd phase) transits to the isotropic liquid occurs. Furthermore, generally, the solubility for solvent of the compound, having the larger number of the carbon atoms, is more improved.

Q¹¹ in formula (I′-A), Q²¹ in formula (I′-B) and Q³¹ in formula (I′-C) each independently represent a polymerizable group or a hydrogen atom. Preferably, Q¹¹, Q²¹ and and Q³¹ each represent a polymerizable group. The polymerization for the group is preferably addition polymerization (including ring-cleavage polymerization) or polycondensation. In other words, the polymerizing group preferably has a functional group that enables addition polymerization or polycondensation. Examples of the polymerizable group are same as those exemplified above. Their preferred ranges are the same as that of Q¹ in formula (I-R). Q¹¹, Q²¹ and Q³¹ may be same or different, and preferably, they are same.

Examples of the compound represented by formula (DI) include the compounds exemplified as [Compound 13]-[Compound 43], described in JP-A-2006-76992, [0052]; and the compounds exemplified as [Compound 13]-[Compound 36], described in JP-A-2007-2220, [0040]-[0063].

The compounds may be prepared according to any process. For example, the compounds may be prepared according to the method described in JP-A-2007-2220, [0064]-[0070].

The compound represented by formula (DII) may be used along with or in place of the compound represented by formula (DI) as a discotic liquid crystal compound.

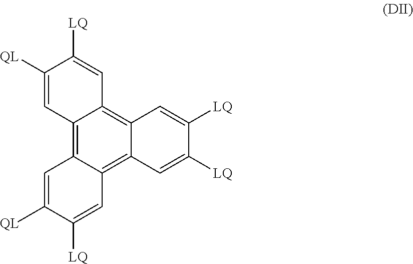

In formula (DII), LQ (or QL) represents a combination of a bivalent linking group (L) and a polymerizable group (Q).

In formula (DII), the bivalent linking group (L) preferably represents a linking group selected from the group consisting of an alkylene, alkenylene, arylene, —CO—, —NH—, —O—, —S— and any combinations thereof. More preferably, the bivalent linking group (L) represents a linking group formed by combining at least two selected from the group consisting of an alkylene, arylene, —CO—, —NH—, —O—, and —S—. Even more preferably, the bivalent linking group (L) represents a linking group formed by combining at least two selected from the group consisting of an alkylene, arylene, —CO— and —O—. The number of the carbon atoms in the alkylene is preferably from 1 to 12. The number of the carbon atoms in the alkenylene is preferably from 2 to 12. The number of the carbon atoms in the arylene group is preferably from 6 to 10.

Examples of the bivalent linking group (L) include those described below. The left site links to the discotic core (D), and the right site links to the polymerizable group (Q). AL represents an alkylene or alkenylene; and AR represents an arylene.

The alkylene, alkenylene or arylene may have at least one substituent such as an alkyl.

### L1: -AL-CO—O-AL-,

### L2: -AL-CO—O-AL-O—,

### L3: -AL-CO—O-AL-O-AL-,

### L4: -AL-CO—O-AL-O—CO—,

### L5: —CO-AR—O-AL-,

### L6: —CO-AR—O-AL-O—,

### L7: —CO-AR—O-AL-O—CO—,

### L8: —CO—NH-AL-,

### L9: —NH-AL-O—,

### L10:—NH-AL-O—CO—,

### L11: —O-AL-,

### L12: —O-AL-O—,

### L13: —O-AL-O—CO—,

### L14: —O-AL-O—CO—NH-AL-,

### L15: —O-AL-S-AL-,

### L16: —O—CO-AL-AR—O-AL-O—CO—,

### L17: —O—CO-AR—O-AL—CO—,

### L18: —O—CO-AR—O-AL-O—CO—,

### L19: —O—CO-AR—O-AL-O-AL-O—CO—,

### L20: —O—CO-AR—O-AL-O-AL-O-AL-O—CO—,

### L21: —S-AL-,

### L22: —S-AL-O—,

### L23: —S-AL-O—CO—,

### L24: —S-AL-S-AL-, and

### L25: —S-AR-AL-.

In formula (DII), the polymerizable group (Q) may be selected depending on the manner of the polymerization. Examples of the polymerizable group (Q) include those described below.

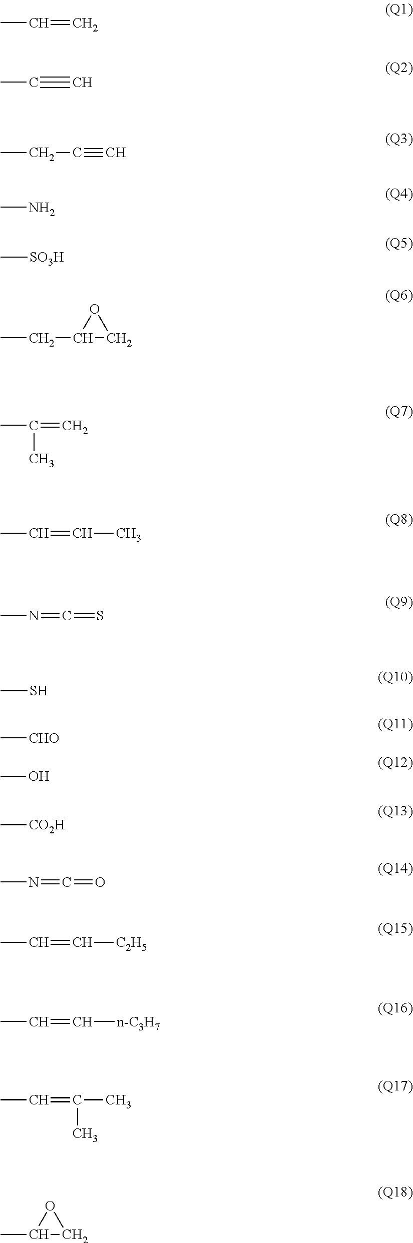

The polymerizable group (Q) is preferably selected from an unsaturated polymerizable group (Q1, Q2, Q3, Q7, Q8, Q15, Q16, and Q17) or from an epoxy group (Q6 and Q18), is more preferably selected from an unsaturated polymerizable group, or is even more preferably from ethylene-unsaturated polymerizable group (Q1, Q7, Q8, Q15, Q16 and Q17).

The liquid crystalline compound to be used in the invention preferable exhibits a good monodomain property. If the monodomain property is bad, a polydomain structure results to cause alignment defects at the boundary between domains and in turn cause scattering of light. By exhibiting a good monodomain property, the retardation film tends to have a high light transmittance property.

The liquid-crystal phase that the liquid-crystal compound to be used in the invention expresses includes a columnar phase and a discotic nematic phase (ND phase). Of those liquid-crystal phases, preferred is a discotic nematic phase (ND phase) having a good monodomain property.

According to the invention, the liquid crystal compounds having smaller wavelength dispersion characteristics are more preferable. More specifically, the liquid crystal compounds having Re(450)/Re(650) of smaller than 1.25, equal to or smaller than 1.20, or equal to or smaller than 1.15 are preferable, where Re(λ) is retardation of the liquid crystal compound (retardation (nm) in-plane at a wavelength λ of a liquid crystal layer).

### (2) Rod-Like Liquid Crystal Compound

Examples of the rod-like liquid-crystalline compound which can be used as the liquid crystal compound include azomethine compounds, azoxy compounds, cyanobiphenyl compounds, cyanophenyl esters, benzoate esters, cyclohexanecarboxylic acid phenyl esters, cyanophenylcyclohexane compounds, cyano-substituted phenylpyrimidine compounds, alkoxy-substituted phenylpyrimidine compounds, phenyldioxane compounds, tolan compounds and alkenylcyclohexylbenzonitrile compounds. Not only the low-molecular-weight, liquid-crystalline compound as listed in the above, high-molecular-weight, liquid-crystalline compound may also be used.

The rod-like liquid crystal molecules in the optically anisotropic layer are preferably fixed in an alignment state, or is more preferably fixed through polymerization reaction. Examples of the rod-like liquid-crystalline compound which can be used in the present invention include compounds described in Makromol. Chem., 190, p. 2255 (1989), Advanced Materials, 5, p. 107 (1993), U.S. Pat. No. 4,683,327, ditto U.S. Pat. No. 5,622,648, ditto U.S. Pat. No. 5,770,107, International Patent (WO) No. 95/22586, ditto No. 95/24455, ditto No. 97/00600, ditto No. 98/23580, ditto No. 98/52905, JP-A No. 1-272551, ditto No. 6-16616, ditto No. 7-110469, ditto No. 11-80081, and No. 2001-328973.

Two or more species of the rod-like liquid crystal compounds are preferably used for achieving the optical properties which the optically anisotropic layer is required to have. Preferable examples of the combination include the combination of at least one rod-like liquid crystal compound represented by formula (1) and at least one rod-like liquid crystal compound represented by formula (2).

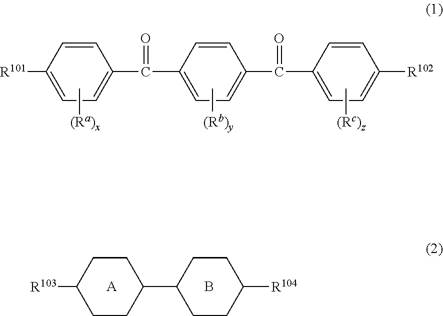

In the formulas (1) and (2), A and B each represent a group of an aromatic or aliphatic hydrocarbon ring or a hetero ring; R¹⁰¹ to R¹⁰⁴ each represent a substituted or un-substituted, C₁₋₁₂ (preferably C₃₋₇) alkylene chain-containing alkoxy, acyloxy, alkoxycarbonyl or alkoxycarbonyloxy group; R^{a}, R^{b} and R^{c} each represent a substituent; x, y and z each indicate an integer of from 1 to 4.

In the formulae, the alkylene chain contained in R¹⁰¹ to R¹⁰⁴ may be linear or branched. Preferably, the chain is linear. For curing the composition, preferably, R¹⁰¹ to R¹⁰⁴ have a polymerizing group at the terminal thereof. Examples of the polymerizing group include an acryloyl group, a methacryloyl group, an epoxy group, etc.

In formula (1), preferably, x and z are 0 and y is 1. Preferably, one R^{b} is a meta- or ortho-positioned substituent relative to the oxycarbonyl group or the acyloxy group. Preferably, R^{b} is a C₁₋₁₂ alkyl group (e.g., methyl group), a halogen atom (e.g., fluorine atom), etc.

In the formula (2), preferably, A and B each are a phenylene group or a cyclohexylene group. Preferably, both of A and B are phenylene groups, or one of them is a cyclohexylene group and the other is a phenylene group.

### (Surface-Treatment of Cellulose Acylate Film)

The cellulose acylate film is preferably subjected to a surface treatment. It is possible to improve the adhesion with any functional layer (e.g., under coating layer, back layer, or optically anisotropic layer). Examples of such surface treatment include a glow discharge treatment, UV irradiation treatment, corona discharge treatment, flame treatment and saponification treatment (including acid-saponification treatment and alkali-saponification treatment). Especially, a glow discharge treatment and alkali-saponification treatment are preferable. The glow discharge treatment referred to herein means the treatment applying plasma to a film surface under an excited plasma gas. Details on these treatments can be found e.g. in the description given by Journal of Technical Disclosure No. 2001-1745, pp. 30-31 (published in Mar. 15, 2001), which may be used in the invention.

For improving the adhesiveness between the film and the functional layer, in place of or along with the surface-treatment, an under-coating layer (adhesion layer) may be formed on the film, as described in JP-A 7-333433. Details of the under-coating layer are described in Journal of Technical Disclosure No. 2001-1745, pp. 32 (published in Mar. 15, 2001), which may be used in the invention. Details of the functional layer which can be formed on the cellulose acylate film are described in Journal of Technical Disclosure No. 2001-1745, pp. 32-45 (published in Mar. 15, 2001), which may be used in the invention.

In terms of maintaining the surface smoothness of the film, preferably, the cellulose acylate film is at a temperature not higher than Tg (glass transition temperature) thereof, concretely not higher than 150 degrees Celsius during the treatment.

In case where the film is used as a transparent protective film for polarizing plate, especially preferred for the film is acid treatment or alkali treatment, or that is, saponification of cellulose acylate in the film, in terms of enhancing the adhesiveness of the film to a polarizing element.

As an example, alkali saponification of the film is concretely described below.

Preferably, the cellulose acylate film is alkali-saponified according to the cycle as follows: The film surface is dipped in an alkali solution, then neutralized with an acid solution, washed with water and dried.

The alkali solution includes potassium hydroxide solution, and sodium hydroxide solution. The hydroxide ion concentration in the solution is preferably within a range of from 0.1 to 3.0 mol/liter, more preferably within a range of from 0.5 to 2.0 mol/liter. The alkali solution temperature is preferably within a range of from room temperature to 90 degrees Celsius, more preferably within a range of from 40 to 70 degrees Celsius.

The surface energy is preferably at least 55 mN/m, more preferably from 60 mN/m to 75 mN/m.

The surface energy of the solid may be determined according to a contact angle method, a wet heat method or an adsorption method as in “Basis and Application of Wetting Technology” (by Realize, issued on Dec. 10, 1989). For the cellulose acylate film, preferred is a contact angle method.

Concretely, two solutions of which the surface energy is known are separately dropped onto the cellulose acylate film; of the angle between the contact line drawn to the liquid drop and the film surface at the point at which the surface of the liquid drop crosses the film surface, the angle on the side of the liquid drop is defined as a contact angle, and the surface energy of the film can be computed through calculation.

### (Preparation of Alignment Layer)

The alignment layer has a function deciding the alignment direction of liquid crystal molecules. The alignment layer that can be employed in the present invention may be provided by rubbing a layer formed of an organic compound (preferably a polymer), oblique vapor deposition, the formation of a layer with microgrooves, or the deposition of organic compounds (for example, omega-tricosanoic acid, dioctadecylmethylammonium chloride, and methyl stearate) by the Langmuir-Blodgett (LB) film method. Further, alignment layers imparted with orientation functions by exposure to an electric or magnetic field or irradiation with light are also known. The alignment film is preferably formed by a rubbing treatment of polymer. Examples of the material of the alignment layer include polyvinyl alcohols, modified polyvinyl alcohols, polyimides, modified polyimides, acrylate monomers, methacrylate monomers, and polystyrenes, which may adjust the averaged tilt angle of the optically anisotropic layer at the alignment-layer interface to the preferred range. The examples are not limited to those exemplified above, and other materials can be used for the alignment layer as long as achieving the preferred averaged tilt angle. The copolymers described in JP-A No. 2002-98836, [0014]-[0016], especially, the copolymers described in JP-A No. 2002-98836, [0024]-[0029] and [0173]-[0180], are more preferable as the material of the alignment layer, in terms of reducing the minor distribution in alignment-axes. The copolymers described in JP-A No. 2005-99228, [0007]-[0012], especially, the copolymers described in JP-A No. 2005-99228, [0016]-[0020], are more preferable as the material of the alignment layer, in terms of reducing the minor distribution in alignment-axes. More preferably, one or more constitutive units in each of the copolymers, described in the two documents, are replaced with the unit having any polymerizable group such as vinyl group, in terms of improving the adhesion between the alignment layer and the optically anisotropic layer.

Preferably, Re of the optically anisotropic layer is preferably less than 60 nm, more preferably from 55 to 20 nm.

The optically anisotropic layer may be formed of a fixed liquid crystal composition in a hybrid alignment. The preferable hybrid alignment state is that the mean tilt angle of liquid crystal molecules at the alignment-layer side is larger than that at the opposite side. The liquid crystal molecules are preferably tilted at the alignment-layer side with a tile angle of equal to or larger than 45 degrees, or that is, the mean tile angle at the alignment-layer side is preferably equal to or larger than 45 degrees. More preferably, the mean tilt angle is equal to or larger than 50 degrees since the stability for the alignment controlling ability in the rubbing direction may be improved, and since the fine dispersion of the alignment axis may be reduced. On the other hand, the DLC molecules are tilted at the side opposite to the alignment-layer side with a tilt angle of equal to or smaller than 45 degrees, or that is, the mean tile angle at the side opposite to the alignment-layer side is preferably equal to or smaller than 45 degrees. More preferably, the mean tilt angle is equal to or smaller than 40 degrees since light in oblique directions may be optically compensated accurately, since the higher viewing angle contrast ratio may be achieved.

The alignment state, in which discotic liquid crystal molecules are tilted with an angle of equal to or larger than 45 degrees, means the alignment state in which the angle between the discotic faces of the molecules and the layer plane is equal to or larger than 45 degrees.

For adjusting the mean tilt angle of liquid crystal molecules at the alignment layer side to 45 degrees or more, any additive capable of adjusting the tilt angle may be added to the optically anisotropic layer; any alignment layer capable of adjusting the mean tilt angle may be used; or two or more other means such as oblique evaporation and light-alignment layer may be performed.

The optically-anisotropic layer preferably satisfies the characteristics that it does not have a direction in which its retardation at 550 nm is 0 nm and that the direction in which the absolute value of its retardation at 550 nm is the smallest is neither in the normal line direction of the layer nor in the in-plane direction thereof. Furthermore, the optically-anisotropic layer is preferably formed of a liquid crystal composition, containing a discotic liquid crystal compound, fixed in a hybrid alignment state, disposed on an alignment layer subjected to an alignment treatment, formed on the cellulose acylate film.

In terms of optical compensation of a liquid crystal cell, the optically-anisotropic layer, formed of the liquid crystal composition, containing any discotic liquid crystal compound, is preferable.

The optically-anisotropic layer formed of the liquid crystal composition having Re(550) of equal to or more than 20 nm may achieve the optical compensation ability sufficiently as well as previous one having the same construction. Or the optically-anisotropic layer, having Re(550) of equal to or less than 60 nm and satisfying the characteristics that it does not have a direction in which its retardation at 550 nm is 0 nm and that the direction in which the absolute value of its retardation at 550 nm is the smallest is neither in the normal line direction of the layer nor in the in-plane direction thereof, is preferable since it may achieve the optical compensation of a liquid crystal cell sufficiently, and the contrast viewing angle and the colorant may be improved.

Re(550) of the optically-anisotropic layer is preferably from 20 to 40 nm, or more preferably from 25 to 40 nm.

The process of preparing the optical compensation film may comprise the step of forming an optically-anisotropic layer on a surface of an alignment layer disposed on the cellulose acylate film by using a liquid crystal composition. More specifically, the optically-anisotropic layer is preferably produced as follows. A liquid crystal composition containing at least one liquid crystal compound is disposed on a surface of an alignment layer formed on the cellulose acylate film. Then, molecules of the liquid crystal compound are aligned in a desired alignment state, and the alignment is fixed by polymerization to form the optically-anisotropic layer. In order that the optically-anisotropic layer satisfies the characteristics that it does not have a direction in which its retardation at 550 nm is 0 nm and that the direction in which the absolute value of its retardation at 550 nm is the smallest is neither in the normal line direction of the layer nor in the in-plane direction thereof, the molecules of the liquid-crystal compound (including both rod-shaped and discotic molecules) are preferably fixed in a hybrid alignment state. The hybrid alignment means that the direction of the director of the liquid-crystal molecules continuously changes in the thickness direction of the layer. In rod-shaped molecules, the director is in the direction of the major axis thereof; and in discotic molecules, the director is a diameter of the discotic face thereof.

In order that the molecules of a liquid-crystal compound are aligned in a desired alignment state, and for the purpose of bettering the coating applicability and the curability of the composition, the composition may contain one or more additives.

For hybrid alignment of the molecules of a liquid-crystal compound (especially a rod-shaped liquid-crystal compound), an additive for controlling the alignment on the air interface side of the layer (hereinafter this may be referred to as “air-interface alignment controlling agent”) may be added. The additive includes a low-molecular-weight or high-molecular-weight compounds having a hydrophilic group such as a fluoroalkyl group or a sulfonyl group. Specific examples of the air-interface alignment controlling agent usable herein are described in JPA No. 2006-267171.

When the liquid crystal composition is prepared as a coating liquid and the optically-anisotropic layer is formed by coating with it, a surfactant may be added thereto for bettering the coating applicability of the liquid. As the surfactant, preferred is a fluorine compound concretely including, for example, the compounds described in JPA No. 2001-330725, paragraphs [0028] to [0056]. Also usable is a commercial product, Megafac F780 (by Dai-Nippon Ink).

The compounds exemplified in JP-A-2006-11350, [0010]-[0016], and [0042]-[0063], and the compounds exemplified in JP-A-2006-195140, [0209]-[0238] may be added to the composition for adjusting the tilt angle at the alignment-layer side.

Preferably, the coating composition contains a polymerization initiator. The polymerization initiator may be either a thermal polymerization initiator or a photo-polymerization initiator; but preferred is a photo-polymerization initiator as it is easy to control. Examples of the photo-polymerization initiator capable of generating radicals under irradiation with light include .alpha.-carbonyl compounds (those described in U.S. Pat. Nos. 2,367,661 and 2,367,670), acyloin ethers (those described in U.S. Pat. No. 2,448,828), .alpha.-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in JPA No. S60-105667 and U.S. Pat. No. 4,239,850), oxadiazole compounds (those described in U.S. Pat. No. 4,212,970), acetophenone-type compounds, benzoin ether-type compounds, benzyl-type compounds, benzophenone-type compounds and thioxanthone-type compounds. Examples of the acetophenone-type compound include 2,2-diethoxy acetophenone, 2-hydroxymethyl-1-phenylpropane-1-on, 4′-isopropyl-2-hydroxy-2-methyl-propiophenone, 2-hydroxy-2-methyl-propiophenone, p-dimethylamino acetone, p-tert-butyl dichloro acetophenone, p-tert-butyl trichloro acetophenone, and p-azidebenzal acetophenone. Examples of the benzyl-type compound include benzyl, benzyl dimethyl ketal, benzyl-.beta.-methoxy ethyl acetal and 1-hydroxy cyclohexyl phenyl ketone. Examples of the benzoin ether compound include benzoin, benzoin methyl ether, benzoin ethyl ether, benzoin-n-propyl ether, benzoin isopropyl ether, benzoin-n-butyl ether, and benzoin isobutyl ether. Examples of the benzophenone-type compound include benzophenone, o-benzoyl methyl benzoate, 4,4′-bis diethylamino benzophenone and 4,4′-dichloro benzophenone. Examples of the thioxanthone-type compound include thioxanthone, 2-methyl thioxanthone, 2-ethyl thioxanthone, 2-isopropyl thioxanthone, 4-isopropyl thioxanthone, 2-chloro thioxanthone and 2,4-diethyl thioxanthone. Among the aromatic ketones functioning as a photo-sensitive radical polymerization initiator, acetophenone-type compounds and benzyl-type compounds are preferable, in terms of hardening properties, preservation stabilities, and odor. One or more selected from these photo-sensitive radical polymerization initiators maybe used depending on the desirable properties.

For the purpose of enhancing the effect, one or more sensitizers may be used in addition to the polymerization initiator. Examples of the sensitizer include n-butyl amine, triethyl amine, tri-n-butyl phosphine and thioxanthone.

Two or more polymerization initiators may be used in combination. The amount of the polymerization initiator in the coating liquid is preferably from 0.01 to 20% by mass, and more preferably from 0.5 to 5% by mass, with respect to the solid content of the coating liquid. Light-irradiation for polymerization of the liquid crystal compound is preferably carried out with UV-light.

The composition may further comprise at least one non-liquid-crystal polymerizable monomer along with the polymerizable liquid crystal compound. Examples of the polymerizable monomer include any compounds having a vinyl, vinyloxy, acryloyl or methacryloyl. Poly-functional monomers, having two or more polymerizable groups in a molecule, such as ethylene oxide-modified trimethylol propane acrylate are preferable in terms of durability.

The amount of the non-liquid-crystal polymerizable monomer is less than 15% around by mass, more preferably from 0 to 10% around by mass, with respect to the amount of the liquid crystal compound.

The optically anisotropic layer may be prepared as follows. The composition is prepared as a coating liquid. The coating liquid is applied to a surface of an alignment layer formed on the cellulose acylate film to be used as the support, and dried to remove the solvent therefrom. Then, the molecules of the liquid crystal compound are aligned in a desired state. The polymerization and curing is carried out to fix the alignment. In this way, the optically anisotropic layer is prepared. Examples of the alignment layer include polyvinyl alcohol films and polyimide films.

Any coating methods may be employed for applying the coating liquid to a surface. Examples of the coating method include a curtain coating method, a dip coating method, a spin-coating method, a printing coating method, a spray coating method, a slot coating method, a roll coating method, a slide coating method, a blade coating method, a gravure coating method and a wire-bar coating method.

Drying of the layer may be carried out under heat. When the solvent in the layer is removed from the layer by drying, the molecules of the liquid crystal compound are aligned. Then, the desired alignment state is obtained. Next, polymerization is carried out with irradiation of UV-light and the alignment is fixed. In this way, the first optically anisotropic layer is prepared. The irradiation energy is preferably from 20 mJ/cm² to 50 J/cm², more preferably from 20 to 5000 mJ/cm² and much more preferably from 100 to 800 mJ/cm². Irradiation may be carried out under heat to accelerate the photo-polymerization reaction.

In the embodiment employing the cellulose acylate film produced according to the process of the invention used in a twisted-alignment mode liquid crystal display device, it may be used as a protective film, especially an inner protective film, of a polarizing plate. The cellulose acylate film may be used as both of a support of an optical compensation film and an inner protective film of a polarizing plate. In particular, a polarizing plate having the cellulose acylate film and a polarizing film may be used. The polarizing plate is preferably combined with a liquid crystal display device, so that the cellulose acylate film is disposed at the liquid crystal cell. The cellulose acylate film is preferably combined with a polarizing film so that the surface of the cellulose acylate film is attached to the surface of the polarizing film, and so that the angle between the in-plane slow axis of the cellulose acylate and the transmission angle of the polarizing film is about 0 degree. It is not necessary that the angle is 0 degree exactly, and the error within the range about ±5 may be allowed in terms of productivity since the error within the range may not lower the effect of the invention. Another protective film is preferably attached to another surface of the polarizing film.

### (Polarizing Film)

Examples of a polarizing film include an iodine-base polarizing film, a dye-base polarizing film with a dichroic dye, and a polyene-base polarizing film, and any of these is usable in the invention. The iodine-base polarizing film and the dye-base polarizing film are produced generally by the use of polyvinyl alcohol films.

### (Protective Film)

As the protective film to be stuck to the other surface of the polarizing film, preferably used is a transparent polymer film. “Transparent” means that the film has a light transmittance of at least 80%. As the protective film, preferred are cellulose acylate films and polyolefin films containing polyolefin. Of cellulose acylate films, preferred are cellulose triacetate film. Of polyolefin films, preferred are cyclic polyolefin-containing films such as poly-norbornene films.

Preferably, the thickness of the protective film is from 20 to 500 micro meters, more preferably from 50 to 200 micro meters.

### (Light Scattering Layer)

The polarizing plate may have a light scattering film on one of the surfaces thereof. The light scattering film may be a monolayer film or multilayered film. One embodiment of the light scattering film is a light scattering film having a light scattering layer on a light-transmission polymer film. The light scattering film may contribute to improving the viewing angle characteristics while the viewing angle is changed along the vertical or horizontal direction. And the embodiment in which an anti-reflective layer is disposed at the outside of the displaying-plane side polarizing film achieves the effect of the invention remarkably. The light scattering film (or the light scattering layer thereof) may be formed of a composition prepared by dispersing fine particles in binder. The fine particles which can be used are organic or inorganic fine particles. The difference in refractive index between the binder and the fine particles is preferably from about 0.02 to about 0.20. The light scattering film (or the light scattering layer thereof) may have also a hard-coat function. Examples thereof include those specifying the front scattering coefficient described in JP-A-11-38208, those specifying the range of the relative refractive indices of a transparent resin and fine particles described in JP-A-2000-199809, and those specifying the haze at 40% or higher described in JP-A-2002-107512. (Hard Coat Film, Anti-Glare Film, Anti-Reflective Film)

As the case may be, the cellulose acylate film may be applied to a hard coat film, an antiglare film and an antireflection film. For the purpose of improving the visibility of flat panel displays such as LCD, PDP, CRT, EL, any or all of a hard coat layer, an antiglare layer and an antireflection layer may be given to one or both surfaces of the cellulose acylate film. Preferred embodiments of such antiglare film and antireflection film are described in detail in Hatsumei Kyokai Disclosure Bulletin (No. 2001-1745, issued Mar. 15, 2001, Hatsumei Kyokai), pp. 54-57, and are preferably employed also for the cellulose acylate film.

### (Preparation of Polarizing Plate)

The polarizing plate can be produced in the shape of a long-size polarizing plate. For example, the cellulose acylate film is used and on its surface, a coating liquid for alignment film formation is optionally applied to form an alignment film thereon, and subsequently, a coating liquid for the optically anisotropic layer of the liquid crystal composition formation is continuously applied onto it and dried to make the coating film have a desired alignment state, and thereafter through irradiation with light, the alignment state is fixed to form the optically anisotropic layer of the liquid crystal composition. In that manner, the retardation film the shape of which is long-size is fabricated, and this can be wound up as a roll. Separately, a roll of a long-size polarizing film and a roll of a long-size polymer film for protective film are prepared and, while unrolled, they are stuck together according to a roll-to-roll method to fabricate a long-size polarizing plate. The long-size polarizing plate may be, for example, wound up as a roll and may be transported or stored; and before it is incorporated into a liquid crystal display device, it may be cut into a desired size. The shape of the polarizing plate is not limited to the long-size and the above process is an example of the method for producing a polarizing plate.

In producing the cellulose acylate film, when it is stretched in the machine direction, then the polarizing plate may be produced in a roll-to-roll process with the film, and this is favorable for simplifying the polarizing plate production process and for enhancing the axial alignment accuracy in sticking the polarizing film and the cellulose acylate film.

The polarizing plate to be used in a vertical-alignment mode liquid crystal display device may have no alignment layer and no optically-anisotropic layer of the polarizing plate to be used in a twisted-alignment mode liquid crystal display device.

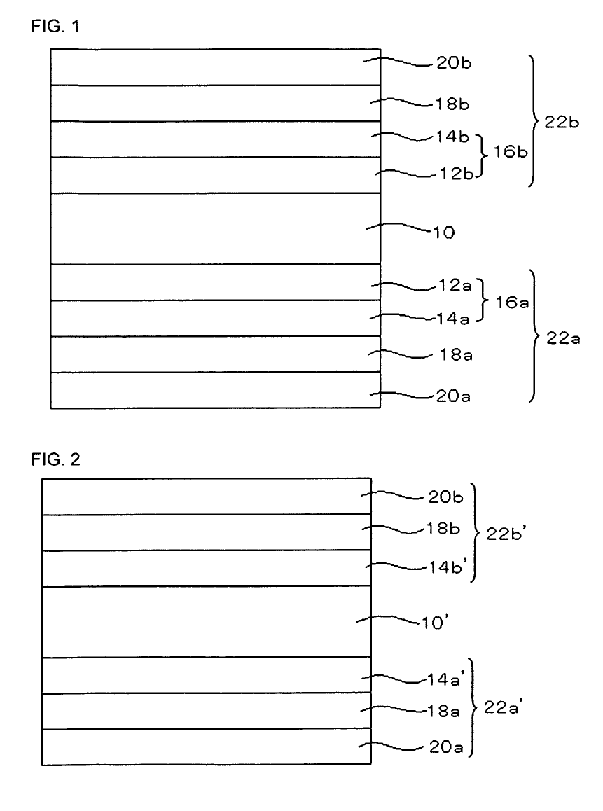

FIG. 1 shows a schematic cross-sectional view of a twisted-alignment mode liquid crystal display device employing the cellulose acylate film produced according to the process of the invention.

The liquid crystal display device shown in FIG. 1 has a liquid crystal cell 10 employing a twisted-alignment mode such as a TN-mode, and has two elliptical polarizing plates 22a and 22b disposed above and below the liquid crystal cell 10. The elliptical polarizing plates 22a and 22b have linear polarizing films 18a and 18b respectively, and optical compensation films 16a and 16b respectively. The optical compensation films 16a and 16b contain optically-anisotropic layers 12a and 12b, formed of a liquid crystal composition, and cellulose acylate films 14a and 14b, which are the supports, respectively. The optically anisotropic layers 12a and 12b exhibit a function of optically compensating birefringence occurring in the oblique directions due to the tilt-alignment of the liquid crystal molecules in the area close to the substrate of the liquid crystal cell 10 employing a twisted-alignment mode; and from this viewpoint, the optically anisotropic layers 12a and 12b preferably contain the discotic liquid crystal compound fixed in the hybrid-alignment state. The cellulose acylate films 14a and 14b, having high Re and Rth, are films prepared according to the process of the invention, share Rth with the optically anisotropic layers 12a and 12b needed for optical compensation, and contribute to optical compensation.

The cellulose acylate films 14a and 14b are used also as protective films of the linear polarizers 18a and 18b respectively. The linear polarizers 18a and 18b are disposed so that the absorption axes thereof are perpendicular to each other. The in-plane slow axes of the cellulose acylate films 14a and 14b are perpendicular to the absorption axes of the linear polarizers 18a and 18b which are disposed close to each other respectively. The outer surfaces of the linear polarizers 18a and 18b are disposed outer protective films 20a and 20b. The outer protective films 20a and 20b may be films produced according to the process of the invention or other films. The outer protective film may be selected various polymer films in terms of the durability or the cost since it doesn't contribute to optical compensation.

The TN-mode liquid crystal cell to be used in the invention preferably has a color filter on the inner surface of the cell substrate, which is disposed so that the transparent major different wavelengths of the color filter correspond to the three or more pigments. The pigments preferably consist of three pigments of R, G and B. According to the invention, for reducing the yellow tinge in the horizontal direction, the thicknesses of the liquid crystal layer are different among at least the two thicknesses corresponding to pigments. The preferable thickness of the liquid crystal layer corresponding to each of the pigments may vary depending on the value of Δnd of the liquid crystal cell, the wavelength dispersion of the liquid crystal or the transmittance value of the color filter; and the relation of the thickness of the B pigments≦The thickness of G pigment≦The thickness of R pigments is preferably satisfied. The value of d_{B} (the thickness of the B pigment)/d_{R} (the thickness of the R pigment) is preferably equal to or smaller than 0.95, more preferably equal to or smaller than 0.9, or even more preferably equal to or smaller than 0.8. The thickness of the liquid crystal layer may be varied by changing the thickness of each of the colors of the color filter. The ratio of the Δnd of the B pigment to the Δnd of the R pigment, “Lnd_{B} (wavelength: 450 nm)/Δnd_{R} (wavelength: 630 nm)”, is preferably equal to or smaller than 1.05, more preferably equal to or smaller than 1.0, or even more preferably equal to or smaller than 0.9.

### Cellulose Acylate Film for Liquid Crystal Display Device Employing Vertical-Alignment Mode:

In a liquid crystal display device (LCD) employing a vertical-alignment mode such as VA-mode, the cellulose acylate film produced according to the process of the invention may be used as an optical compensation film or a part thereof, or a protective film, which is preferably disposed at the liquid crystal side, of a polarizing plate. Preferably, the cellulose acylate film to be used in a LCD employing a verical-alignment mode has Re of from 5 to 50 nm and Rth of from 90 to 150 nm.

An embodiment of the cellulose acylate film for a twisted-alignment mode LCD is a support of an optical compensation film having an optically anisotropic layer formed of a liquid crystal composition on the support. The cellulose acylate film may be used after being subjected to any surface treatment.

The liquid crystal composition to be used for preparing the optically anisotropic is preferably capable of forming a nematic or smectic phase. Usually, liquid crystal compounds are classified into rod-like or discotic liquid crystal compounds depending on their molecular shapes. According to the invention, liquid crystal compounds having any molecular shape may be used.

The thickness of the optically anisotropic layer formed of the liquid crystal composition is not limited, is preferably from 0.1 to 10 micro meters, or more preferably from 0.5 to 5 micro meters.

FIG. 2 shows a schematic cross-sectional view of a vertical-alignment mode liquid crystal display device employing the cellulose acylate film produced according to the process of the invention.

The liquid crystal display device shown in FIG. 2 has a liquid crystal cell 10′ employing a vertical-alignment mode such as a VA-mode, and has two elliptical polarizing plates 22a′ and 22b′ disposed above and below the liquid crystal cell 10′. The elliptical polarizing plates 22a′ and 22b′ have linear polarizing films 18a and 18b respectively, and cellulose acylate films 14a′ and 14b′ as the inner protective film.

The cellulose acylate films 14a′ and 14b′, having high Re and Rth, are films prepared according to the process of the invention, and contribute to reducing the light leakage in the black state occurring when the absorption axes of the linear polarizing films 18a and 18b are shifted from the perpendicular relation. The cellulose acylate films 14a′ and 14b′ are used also as protective films of the linear polarizers 18a and 18b respectively. The linear polarizers 18a and 18b are disposed so that the absorption axes thereof are perpendicular to each other. The in-plane slow axes of the cellulose acylate films 14a′ and 14b′ are perpendicular to the absorption axes of the linear polarizers 18a and 18b which are disposed close to each other respectively. The outer surfaces of the linear polarizers 18a and 18b are disposed outer protective films 20a and 20b. The outer protective films 20a and 20b may be films produced according to the process of the invention or other films. The outer protective film may be selected various polymer films in terms of the durability or the cost since it doesn't contribute to optical compensation.

### EXAMPLES

The present invention will be explained to further detail, referring to Examples. Note that the materials, reagents, amounts and ratios of substances, operations and so forth explained in Examples below may appropriately be modified without departing from the spirit of the present invention. The scope of the present invention is, therefore, not limited to the specific examples described below.

### <<Measurement Methods>>

Evaluation methods for the properties used in the following Examples are described below.

### (1) Degree of Substitution

The degree of acyl substitution of a cellulose acylate is determined by ¹³C-NMR according to the method described in Carbohydr. Res., 273 (1995), 83-91 (Tezuka, et al).

### (2) Quantity of Crystallization Heat (ΔHc)

A differential scanning calorimeter (DSC, “DSC8230”, produced by Rigaku Corporation) is used and 5 or 6 mg of a cellulose acylate film is put into a sample pan made of aluminum for DSC, this is heated from 25 degrees Celsius up to 120 degrees Celsius at a rate of 20 degrees Celsius/min in a nitrogen stream atmosphere at a rate of 50 ml/min, then kept as such for 15 minutes, and thereafter cooled down to 30 degrees Celsius at a rate of −20 degrees Celsius/min, and further, this is again heated from 30 degrees Celsius up to 320 degrees Celsius at a rate of 20 degrees Celsius/min, and the area surrounded by the exothermic peak appearing in the heat cycle and the base line of the sample is measured. This is the quantity of crystallization heat of the cellulose acylate film.

### 1. Production of Cellulose Acylate Film:

### (1-1) Preparation of Dope

Each of the cellulose acylate solutions having the following formulation, containing the oligomer having the number-averaged molecular weight in the amount shown in the following table, was prepared.

Formulation of Cellulose Acylate Solution

| | |
|---|---|
| Cellulose Acetate having a mean degree of substitution | 100.0 mas. pts. |
| of 2.86 | |
| Methylene Chloride (first solvent) | 475.9 mas. pts. |
| Methanol (second solvent) | 113.0 mas. pts. |
| Butanol (third solvent) | 5.9 mas. pts. |
| Silica Particles having a mean particle size of 16 nm | 0.13 mas. pts. |
| (AEROSIL R972, by Nippon Aerosil) | |
| Oligomer (shown in the following Table) | shown in the |
| | following Table |

Each of the prepared solutions was cast on the mirrored surface of a support, which was a drum having a diameter of 3 m, through a casting die under the PIT-draw condition shown in the following table.

When the residual solvent amount and the film surface temperature of each of the webs on the support became the values shown in the following table, the web is stretched along the TD at the stretching ratio shown in the following table. The TD stretching was performed according to the manner that both edges of the web were grasped with pins and stretched along the direction perpendicular to the MD.

When the residual solvent amount became the value shown in the following table after the stretching, the web was subjected to the heat treatment at the temperature shown in the following table. The heat-treatment was performed while the temperature of the dry air in the drying zone was controlled. And the heat-treatment was performed while the pin-like tenter was fixed.

The producing conditions and the optical properties of each of the produced films are shown in the following tables. The Re is shown in the following tables as the positive value for the direction perpendicular to the casting direction.

| | | | | | | | | | | | | | Conditions of Steps | | | | | |
|---|---|---|---|---|---|---|---|---|---|---|---|---|---|---|---|---|---|---|
| | Formulation | | | | | | | | | | | | | Stretching | | | Heat-treatment | |
| | Formulation of Oligomer | | | | | | | | | | | | | | Film- | | | Film- |
| | Dicarboxylic Acid | | | | Diol | | | | Properties | | | | | Re- | Surface | | | Surface |
| Ex- | Unit *1 | | | | Unit *2 | | | Amount | | | | Thick- | Casting | sidual | Tem- | | Residual | Tem- |
| am- | TPA | PA | AA | SA | EG | PG | Mw | Parts | Re | Rth | ΔHc | ness | PIT | Solvent | perature | TD | Solvent | perature |
| ple | *4 | *4 | *4 | *4 | *4 | *4 | *3 | by mass | (nm) | (nm) | (J/g) | (μm) | draw | Amount | (° C.) | Stretching | Amount | (° C.) |
| 1 | 25 | 0 | 0 | 75 | 50 | 50 | 2000 | 15 | 10 | 100 | 2 | 80 | 104% | 80% | 40 | 110% | 50% | 100 |
| 2 | 45 | 5 | 20 | 30 | 50 | 50 | 1000 | 10 | 15 | 100 | 3 | 80 | 104% | 80% | 40 | 10% | 50% | 80 |
| 3 | 50 | 0 | 50 | 0 | 50 | 50 | 1000 | 15 | 100 | 100 | 3 | 80 | 104% | 80% | 40 | 10% | 50% | 80 |
| 4 | 55 | 0 | 0 | 45 | 50 | 50 | 1000 | 15 | 15 | 100 | 3 | 80 | 104% | 80% | 40 | 10% | 50% | 80 |
| 5 | 70 | 0 | 0 | 30 | 50 | 50 | 1000 | 8 | 15 | 100 | 3 | 80 | 104% | 80% | 40 | 10% | 50% | 80 |
| 6 | 100 | 0 | 0 | 0 | 50 | 50 | 1000 | 5 | 20 | 105 | 3 | 80 | 104% | 80% | 40 | 10% | 50% | 80 |

*1: “TPA” indicates terephthalic acid; “AA” indicates adipic acid; “SA” indicates succin acid.
*2: “EG” indicates ethane diol; and “PG” indicates 1,3-propane diol.
*3: The number-averaged molecular weight.
*4: The unit of “TPA”, “PA”, “AA”, “SA”, “EG” or “PG” is a molar ratio.

| | | | | | | | | | | | | | Conditions of Steps | | | | | |
|---|---|---|---|---|---|---|---|---|---|---|---|---|---|---|---|---|---|---|
| | Formulation | | | | | | | | | | | | | Stretching | | | Heat-treatment | |
| | Formulation of Oligomer | | | | | | | | | | | | | | Film- | | | Film- |
| | Dicarboxylic Acid | | | | Diol | | | | Properties | | | | | Re- | Surface | | | Surface |
| Ex- | Unit *1 | | | | Unit *2 | | | Amount | | | | Thick- | Casting | sidual | Tem- | | Residual | Tem- |
| am- | TPA | PA | AA | SA | EG | PG | Mw | Parts | Re | Rth | ΔHc | ness | PIT | Solvent | perature | TD | Solvent | perature |
| ple | *4 | *4 | *4 | *4 | *4 | *4 | *3 | by mass | (nm) | (nm) | (J/g) | (μm) | draw | Amount | (° C.) | Stretching | Amount | (° C.) |
| 7 | 70 | 0 | 0 | 30 | 50 | 50 | 1000 | 8 | 15 | 125 | 2 | 80 | 104% | 80% | 40 | 10% | 50% | 100 |
| 8 | 70 | 0 | 0 | 30 | 50 | 50 | 1000 | 8 | 10 | 95 | 3 | 80 | 104% | 120% | 40 | 10% | 100% | 50 |
| 9 | 70 | 0 | 0 | 30 | 50 | 50 | 1000 | 8 | 10 | 110 | 3 | 80 | 104% | 80% | 40 | 10% | 10% | 150 |
| 10 | 70 | 0 | 0 | 30 | 50 | 50 | 1000 | 8 | 15 | 100 | 3 | 80 | 104% | 80% | 40 | 10% | 50% | 80 |
| 11 | 70 | 0 | 0 | 30 | 50 | 50 | 1000 | 8 | 20 | 125 | 1 | 65 | 104% | 220% | 40 | 10% | 220% | 80 |
| 12 | 70 | 0 | 0 | 30 | 50 | 50 | 1000 | 10 | 45 | 120 | 3 | 80 | 104% | 80% | 40 | 15% | 50% | 75 |

*1: “TPA” indicates terephthalic acid; “AA” indicates adipic acid; “SA” indicates succin acid.
*2: “EG” indicates ethane diol; and “PG” indicates 1,3-propane diol.
*3: The number-averaged molecular weight.
*4: The unit of “TPA”, “PA”, “AA”, “SA”, “EG” or “PG” is a molar ratio.

| | Formulation | | | | | | | | | | | |
|---|---|---|---|---|---|---|---|---|---|---|---|---|
| | Formulation of Oligomer | | | | | | | | | | | |
| | Dicarboxylic Acid | | | | Diol | | | | | | | |
| | Unit *1 | | | | Unit *2 | | | | Properties | | | |
| Omparative | TPA | PA | AA | SA | EG | PG | Mw | Amount | Re | Rth | ΔHc | Thickness |
| Example | *4 | *4 | *4 | *4 | *4 | *4 | *3 | Parts by mass | (nm) | (nm) | (J/g) | (μm) |
| 1 | 0 | 0 | 100 | 0 | 100 | 0 | 1000 | 10 | 2 | 10 | 3 | 80 |
| 2 | TPP | BDP | — | — | — | — | 326, 402 | 11.7 | 2 | 85 | 3 | 80 |
| | *5 | *5 | | | | | | | | | | |
| | 7.8 | 3.9 | — | — | — | — | | | | | | |
| 3 | 70 | 0 | 0 | 30 | 50 | 50 | 1000 | 8 | 2 | 60 | 4 | 80 |

| | Conditions of Steps | | | | | |
|---|---|---|---|---|---|---|
| | | Stretching | | | Heat-treatment | |
| | | | Film- | | | Film- |
| | Casting | Residual | Surface | | Residual | Surface |
| Omparative | PIT | Solvent | Temperature | TD | Solvent | Temperature |
| Example | draw | Amount | (° C.) | Stretching | Amount | (° C.) |
| 1 | 104% | 80% | 40 | 10% | 50% | 80 |
| 2 | 104% | 80% | 40 | 10% | 50% | 80 |
| 3 | 104% | 80% | 40 | 10% | 50% | 30 |

*1: “TPA” indicates terephthalic acid; “AA” indicates adipic acid; “SA” indicates succin acid.
*2: “EG” indicates ethane diol; and “PG” indicates 1,3-propane dol.
*3: The number-averaged molecular weight
*4: The unit of “TPA”, “PA”, “AA”, “SA”, “EG” or “PG” is a molar ratio.
*5: “TPP” indicates triphenyl phosphate; and “BDP” indicates biphenyl diphenyl phosphate.

From the data in the tables, it is understandable that the cellulose acylate films of Examples 1-12, which were produced according to the process of the invention, exhibit Re of from 5 to 20 nm and Rtn of from 90-150 nm and are useful as the optical film for a liquid crystal display device employing a twisted-alignment mode. It is understandable also that the cellulose acylate films of Examples 10 and 11, which were produced according to the process of the invention, exhibit Re of from 5 to 50 nm and Rtn of from 90-150 nm and are useful as the optical film for a liquid crystal display device employing a vertical-alignment mode.

It is understandable that the cellulose acylate films of Comparative Examples 1 and 2, which were produced under the same conditions as those of Example 2, except that the plasticizer other than aromatic group-containing oligomer was used, exhibit low Re and Rth and are not suitable as the optical film for a liquid crystal display device employing a twisted-alignment or vertical-alignment mode.

It is understandable that the cellulose acylate film of Comparative Example 3, which was produced without the heat-treatment at the sufficient temperature for increasing the alignment degree of the oligomer even by using the aromatic group-containing oligomer as the plasticizer, is not suitable as the optical film for a liquid crystal display device employing a twisted-alignment or vertical-alignment mode.

### 2. Fabrication of TN-mode Liquid Crystal Display Device

### (2)-1 Saponification of Cellulose Acylate Film

Each of the cellulose acylate films obtained in Examples 1-6, 8 and 9 the above was led to pass through a dielectric heating roll at a temperature of 60 degrees Celsius so that the film surface temperature was elevated up to 40 degrees

Celsius, and then, using a bar coater, an alkali solution having the formulation mentioned below was applied to it in an amount of 14 ml/m²; thereafter this was kept staying below a steam-type far-infrared heater (by Noritake Company) heated at 110 degrees Celsius for 10 seconds, and then also using a bar coater, pure water was applied thereto in an amount of 3 ml/m². In this stage, the film temperature was 40 degrees Celsius. Next, this was washed with water using a fountain coater and treated with an air knife for water removal, repeatedly three times each, and then dried in a drying zone at 70 degrees Celsius for 2 seconds.

Formulation of Alkali Solution for Saponification

| | |
|---|---|
| Potassium hydroxide | 4.7 parts by mass |
| Water | 15.7 parts by mass |
| Isopropanol | 64.8 parts by mass |
| Propylene glycol | 14.9 parts by mass |
| Surfactant (C₁₆H₃₃O(CH₂CH₂₀)₁₀H) | 1.0 part by mass |

### (2)-2 Formation of Alignment Film

On the cellulose acylate film, a coating liquid for alignment film having the formulation mentioned below was applied in an amount of 24 mL/m², using a wire bar coater of #14. This was dried with hot air at 100 degrees Celsius for 120 seconds. The thickness of the alignment film was 1.2 micro meters. Next, with the machine direction (MD direction) of the cellulose acylate film regarded as 0 degree, the coated alignment film formed on it was rubbed with rubbing roller of 2000 mm width at a rate of 400 rounds per minutes in the direction of 0 degree. The conveying speed was 40 m/min. Then, the rubbed surface was subjected to ultrasonic dust removing.

Formulation of Coating Liquid for Alignment

| | | |
|---|---|---|
| Modified polyvinyl alcohol shown below | 40 | parts by mass |
| Water | 728 | parts by mass |
| Methanol | 228 | parts by mass |
| Glutaraldehyde (Crosslinking agent) | 2 | parts by mass |
| Citrate (AS3, by Sankyo Chemical) | 0.69 | part by mass |

Modified polyvinyl alcohol

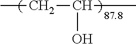

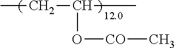

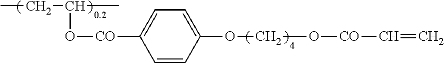

### (2)-3 Formation of the Optically Anisotropic Layer

A coating liquid for the optically anisotropic layer having the formulation mentioned below was continuously applied onto the rubbed surface of the alignment film with a wire bar after being subjected to the ultrasonic dust removing. Then the film was heated in the constant temperature bath of 130 degrees Celsius for 120 seconds, to thereby align the discotic liquid crystal compound. Next, this was irradiated with UV rays by using a high-pressure mercury lamp of which output power was 160 W/cm for 40 seconds at 80 degrees Celsius to thereby carry out the crosslinking reaction to fix the aligned discotic liquid crystal compound. Next, this was left cooled to room temperature.

Re of the obtained optically-anisotropic layer measured at a 550 nm wavelength was 45 nm. The thickness of the optically-anisotropic layer was shown in the following table. The values of retardation of the optically-anisotropic layer were measured for incoming light of a 550 nm wavelength in the 11 directions by a 10 degrees-step from the normal direction to the 50-degrees direction at the either side; and on the basis of the obtained retardation values, the hypothetical mean refractive index and the inputted thickness of the layer, it was confirmed by using KOBRA 21ADH that the discotic liquid crystal molecules in the optically-anisotropic layer were fixed in the hybrid-alignment, that the layer did not have a direction in which its retardation at 550 nm is 0 nm and that the direction in which the absolute value of its retardation at 550 nm was the smallest was neither in the normal line direction of the layer nor in the in-plane direction thereof. By using KOBRA 21ADH, the tilt angle of the discotic face of the discotic liquid crystal compound in the optically-anisotropic layer was also measured. The upper tilt angle means the tilt angle at the air-interface side, and the lower tilt angle means the tilt angle at the alignment-layer side.

Formulation of Coating Liquid for Optically Anisotropic Layer

| | | |
|---|---|---|
| Methyl ethyl ketone | 270 | parts by mass |
| First discotic liquid crystal compound shown | 90 | parts by mass |
| below | | |
| Second discotic liquid crystal compound shown | 10 | parts by mass |
| below | | |
| Agent for controlling alignment at the air- | 1.0 | part by mass |
| interface side shown below | | |
| Photopolymerization initiator (Irgacure 907, | 3.0 | parts by mass |
| by Chiba Japan) | | |
| Sensitizer (Kayacure DETX, by Nippon Kayaku | 1.0 | part by mass |
| co. ltd) | | |

In this way, Optical compensation films 21-28 were produced. The cellulose acylate films, used as the support, and the discotic liquid crystal compounds used for preparing the optically anisotropic layers were shown in the following table.

| | | Optically Anisotropic Layer | | | | |
|---|---|---|---|---|---|---|
| | Support | | Second | | | |
| Optical | (Cellulose | First Liquid | Liquid | | Upper | Lower |
| Compensation | Acylate | Crystal | Crystal | Thickness | Tilt Angle | Tilt Angle |
| Film No. | Film) | Compound | Compound | (μm) | (°) | (°) |
| 21(Example) | Example | Compound | Compound | 1.2 | 70 | 10 |
| | 1 | (1) | (2) | | | |
| 22(Example) | Example | Compound | Compound | 0.9 | 70 | 10 |
| | 2 | (2) | (1) | | | |
| 23(Example) | Example | Compound | Compound | 1 | 70 | 10 |
| | 3 | (2) | (1) | | | |
| 24(Example) | Example | Compound | Compound | 1 | 70 | 10 |
| | 4 | (3) | (1) | | | |
| 25(Example) | Example | Compound | Compound | 1 | 70 | 10 |
| | 5 | (4) | (1) | | | |
| 26(Example) | Example | Compound | Compound | 1 | 70 | 10 |
| | 6 | (5) | (1) | | | |
| 27(Example) | Example | Compound | Compound | 1 | 70 | 10 |
| | 8 | (6) | (1) | | | |
| 28(Example) | Example | Compound | Compound | 1 | 70 | 10 |
| | 9 | (7) | (1) | | | |

Compound (1) 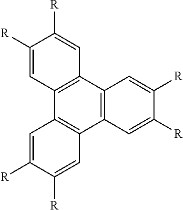 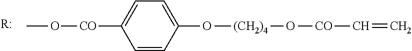
Compound (2) 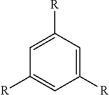 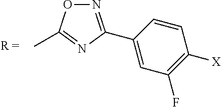
X = —O(CH₂)₂CH(CH₃)OCOCH═CH₂
Compound (3) 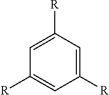 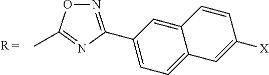
X = —OCOO(CH₂CH₂O)₂COCH═CH₂
Compound (4) 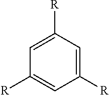 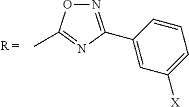
X = —COO(CH₂)₂OCOCH═CH₂
Compound (5) 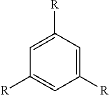 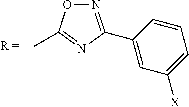
X = —COO(CH₂)₅OCOCH═CH₂
Compound (6) 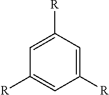 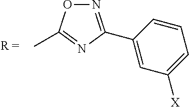
X = —O(CH₂)₅OCOCH═CH₂
Compound (7) 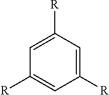 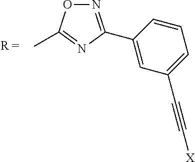
X = —(CH₂)₃OCOCH═CH₂

Agent for controlling alignment at the air-interface

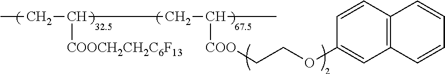

### (2)-4 Preparation of Optical Compensation Film 29

Optical compensation film 29 was prepared by forming an optically anisotropic layer on the cellulose acylate film prepared in Example 7 as follow. Saponification of Cellulose Acylate Film:

The cellulose acylate film was led to pass through a dielectric heating roll at a temperature of 60 degrees Celsius so that the film surface temperature was elevated up to 40 degrees Celsius, and then, using a bar coater, an alkali solution having the formulation mentioned below was applied to it in an amount of 14 ml/m²; thereafter this was kept staying below a steam-type far-infrared heater (by Noritake Company) heated at 110 degrees Celsius for 10 seconds, and then also using a bar coater, pure water was applied thereto in an amount of 3 ml/m². In this stage, the film temperature was 40 degrees Celsius. Next, this was washed with water using a fountain coater and treated with an air knife for water removal, repeatedly three times each, and then dried in a drying zone at 70 degrees Celsius for 2 seconds.

Formulation of Alkali Solution for Saponification

| | |
|---|---|
| Potassium hydroxide | 4.7 parts by mass |
| Water | 15.7 parts by mass |
| Isopropanol | 64.8 parts by mass |
| Propylene glycol | 14.9 parts by mass |
| Surfactant (C₁₆H₃₃O(CH₂CH₂₀)₁₀H) | 1.0 part by mass |

### Formation of Alignment Film:

On the saponified surface of the cellulose acylate film, a coating liquid for alignment film having the formulation mentioned below was applied in an amount of 24 mL/m², using a wire bar coater of #14. This was dried with hot air at 100 degrees Celsius for 120 seconds. The thickness of the alignment film was 1.2 micro meters. Next, with the machine direction of the cellulose acylate film regarded as 0 degree, the coated alignment film formed on it was rubbed with rubbing roller of 2000 mm width at a rate of 400 rounds per minutes in the direction of 0 degree. The conveying speed was 40 m/min. Then, the rubbed surface was subjected to ultrasonic dust removing.

Formulation of Coating Liquid for Alignment

| | | |
|---|---|---|
| Polymer for alignment layer shown below | 40 | parts by mass |
| Water | 700 | parts by mass |
| Methanol | 300 | parts by mass |
| Triethylamine | 20 | parts by mass |

Polymer for alignment layer 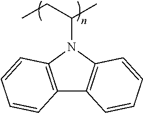 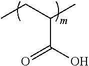 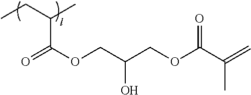
n = 40, m = 50, l = 10

### Formation of the Optically Anisotropic Layer:

A coating liquid for the optically anisotropic layer having the formulation mentioned below was continuously applied onto the rubbed surface of the alignment film with a wire bar after being subjected to the ultrasonic dust removing. Then the film was heated in the constant temperature bath of 130 degrees Celsius for 120 seconds, to thereby align the discotic liquid crystal compound. Next, this was irradiated with UV rays by using a high-pressure mercury lamp of which output power was 160 W/cm for 40 seconds at 80 degrees Celsius to thereby carry out the crosslinking reaction to fix the aligned discotic liquid crystal compound. Next, this was left cooled to room temperature.

Formulation of Coating Liquid for Optically Anisotropic Layer

| | | |
|---|---|---|
| Methyl ethyl ketone | 270 | parts by mass |
| Discotic liquid crystal compound A1 shown below | 100 | parts by mass |
| Agent B1 for controlling alignment at the air-interface | 1.0 | part by mass |
| side shown below | | |
| Photo-polymerization initiator (Irgacure 907, by Chiba | 3.0 | parts by mass |
| Japan) | | |
| Sensitizer (Kayacure DETX, by Nippon Kayaku co. | 1.0 | part by mass |
| ltd) | | |

(A1) 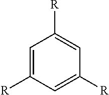 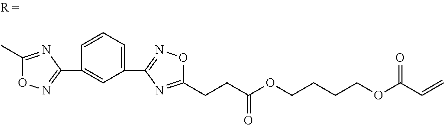
(B1)

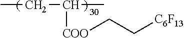

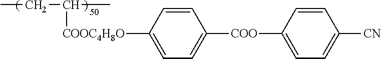

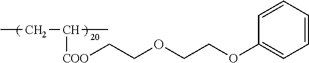

The thickness of the optically anisotropic layer was 1 micro meter, and the upper and lower tilt angles were 20 degrees and 70 degrees respectively.

### (2)-5 Fabrication of Polarizing Plates

A polyvinyl alcohol (PVA) film having a thickness of 80 micro meters was dyed by dipping it in an aqueous iodine solution having an iodine concentration of 0.05% by mass at 30 degrees Celsius for 60 seconds, and then while dipped in an aqueous boric acid solution having a boric acid concentration of 4% by mass, this was stretched in the machine direction by 5 times the original length, and thereafter dried at 50 degrees Celsius for 4 minutes to give a polarizing film having a thickness of 20 micro meters.

The exposed surface of the cellulose acylate film of each of optical compensation films 21-29 produced in the above (the face thereof not coated with the optically anisotropic layer of the liquid crystal composition) was dipped in an aqueous sodium hydroxide solution (1.5 mol/L) at 55 degrees Celsius, and then fully washed with water to remove sodium hydroxide. Next, this was dipped in an aqueous diluted sulfuric acid solution (0.005 mol/L) at 35 degrees Celsius for 1 minute, then dipped in water to fully remove the aqueous diluted sulfuric acid solution. Finally, the sample was fully dried at 120 degrees Celsius.

The film saponified in the manner as above was combined with a commercial cellulose acetate film that had been saponified also in the same manner as above, the above-mentioned polarizing film was sandwiched between them, and these were bonded together with a polyvinyl alcohol adhesive so that the saponified surfaces of the films were faced to each other, thereby fabricating a polarizing plate. The commercial cellulose acetate film was Fujitac TF80UL (by FUJIFILM Corporation). In this, the polarizing film and the protective film on both surfaces of the polarizing film were produced all as rolls, and therefore, the machine direction of every roll was parallel to each other, and the rolls were unrolled and continuously bonded together. Accordingly, the absorption axis of the polarizer was parallel to the machine direction of the film roll (the casting direction in film formation).

In this way, Polarizing plates 31-39 having Optical compensation films 21-29 respectively were produced.

### (2)-6 Fabrication of TN-Mode Liquid Crystal Display Device

TN-mode liquid crystal display devices having the same constructions as shown in FIG. 1 were produced. A pair of polarizing plates was removed from a TN-mode liquid crystal display device (Nippon Acer's AL2216W), and in place of them, the polarizing plate fabricated in the above was bonded to each one on both the viewers' side and the backlight side of the TN-mode liquid crystal cell, using an adhesive, so that its optically anisotropic layer faced the side of the liquid crystal cell. In this, the two polarizing plates were disposed so that the transmission axis of the polarizing plate on the viewers' side was perpendicular to the transmission axis of the polarizing plate on the backlight side.

In this way, TN-mode liquid crystal display devices 101-109 were produced respectively.

### 3. Fabrication of VA-mode Liquid Crystal Display Device

### (3)-1 Fabrication of Polarizing Plate for VA-mode

A polyvinyl alcohol (PVA) film having a thickness of 80 micro meters was dyed by dipping it in an aqueous iodine solution having an iodine concentration of 0.05% by mass at 30 degrees Celsius for 60 seconds, and then while dipped in an aqueous boric acid solution having a boric acid concentration of 4% by mass, this was stretched in the machine direction by 5 times the original length, and thereafter dried at 50 degrees Celsius for 4 minutes to give a polarizing film having a thickness of 20 micro meters.

Commercial cellulose acetate film, Fujitac TF80UL (by FUJIFILM Corporation), was prepared. The exposed surface of the cellulose acylate film was dipped in an aqueous sodium hydroxide solution (1.5 mol/L) at 55 degrees Celsius, and then fully washed with water to remove sodium hydroxide. Next, this was dipped in an aqueous diluted sulfuric acid solution (0.005 mol/L) at 35 degrees Celsius for 1 minute, then dipped in water to fully remove the aqueous diluted sulfuric acid solution. Finally, the sample was fully dried at 120 degrees Celsius. The cellulose acylate film prepared in Example 11 was saponified in the same manner as above.

The above-mentioned polarizing film was sandwiched between the commercially available triacetyl cellulose film, TD80, and the cellulose acylate film of Example 11, so that the saponified surfaces of the films were faced to each other, thereby fabricating a polarizing plate, Polarizing plate 41.

### (3)-2 Fabrication of VA-Mode Panel

A pair of polarizing plates was removed from a VA-mode liquid crystal display device (Sharp's LC-46LX1), and in place of them, Polarizing plate 41 was bonded to the backlight side of the VA-mode liquid crystal cell, using an adhesive, so that its absorption axis was perpendicular to the slow axis of the liquid crystal cell and so that the cellulose acylate film of Example 11 faced the side of the liquid crystal cell; and Polarizing plate 41 was bonded also to the opposite side of the VA-mode liquid crystal cell, using an adhesive, so that its absorption axis was perpendicular to the slow axis of the liquid crystal cell and so that the cellulose acylate film of Example 11 faced the side of the liquid crystal cell. In this way, a VA-mode liquid crystal display device having the same constructions as shown in FIG. 2 was produced.

### 4. Evaluation of Liquid Crystal Display Device

The viewing angles of the produced TN-mode liquid crystal display devices in the vertical (upper and lower) and horizontal (right and left) directions were calculated; and the viewing angle of the produced VA-mode liquid crystal display device in the 45-degrees oblique direction was calculated, as follows.

The contrast-viewing angles in the black state (L1) and the white state (L8) of each of the liquid crystal display devices produced in the examples were measured by using a measurement (EZ-Contrast160D of ELDIM). The averaged contrast ratios (white transmittance ratio/black transmittance ratio) at a polar angle of 80 degrees in the vertical and horizontal directions (for TN) and in the 45-degree oblique direction (for VA) were calculated. And the devices were evaluated according to the following criteria:

AA: The obtained value was equal to or more than 50.

A: The obtained value was smaller than 50 and equal to or more than 40.

B: The obtained value was smaller than 40 and equal to or more than 30.

C: The obtained value was smaller than 30.

All of the TN-mode and VA-mode liquid crystal display devices having the cellulose acylate film produced according to the process of the invention were evaluated as “A” or “AA”. The TN-mode liquid crystal display device employing Optical compensation film 29 or 30, containing the cellulose acylate film of Example 7 or 11, exhibited the higher contrast ratio in the normal line direction (more specifically, 1.5 times), compared with that employing the cellulose acylate film of any one of Examples 1-6, 8 and 9.

### 5. Fabrication of TN-mode Liquid Crystal Display Device

### (5)-1 Production of Cellulose Acylate Film (Example 14)

A cellulose acylate film of Example 14 was produced in the same manner as Example 3, except that the agent for controlling the wavelength dispersion was further added in an amount of 3.2% by mass.

Cellulose acylate films of Examples 12, and 15-28 were produced according to the conditions shown in the following tables respectively. The optical properties of each of the films are also shown in the following tables. The Re is shown in the following tables as the positive value for the direction perpendicular to the casting direction.

Regarding each of the films, Rth(450) and Rth(550) were measured and the value of Rth(450)/Rth(550) was calculated on the basis of them.

The residual amount of the agent for controlling the wavelength dispersion was calculated as follows.

Each of the cellulose acylate films was set in “Super Xenon Weather Meter SX75” (by Suga Test Instruments), and irradiated with light under the condition of 150 W/m² for 200 hours. Then the residual amount of the agent for controlling the wavelength dispersion was measured. The measurement was performed while the optical film described in JP-A-2008-116788, [0080]-[0082], was disposed between the cellulose acylate film and the light source of the weather meter. The residual ratio after the irradiation of light was calculated by assigning the obtained values to the following formula.

{(the residual amount of the agent for controlling the wavelength dispersion after the irradiation of light)/(the residual amount of the agent for controlling the wavelength dispersion before the irradiation of light)}×100

### (5)-2 Saponification of Cellulose Acylate Film

The cellulose acylate films of Examples 13-48 were subjected to the saponification treatment in the same manner as the (2)-1 describe above respectively.

### (5)-3 Formation of Alignment Film

To the saponified surface of each of the cellulose acylate films, a coating liquid for alignment film having the formulation mentioned below was applied in an amount of 24 mL/m², using a wire bar coater of #14. This was dried with hot air at 100 degrees Celsius for 120 seconds. The thickness of the alignment film was 1.2 micro meters. Next, with the machine direction (MD direction) of the cellulose acylate film regarded as 0 degree, the coated alignment film formed on it was rubbed with rubbing roller of 2000 mm width at a rate of 400 rounds per minutes in the direction of 0 degree. The conveying speed was 40 m/min. Then, the rubbed surface was subjected to ultrasonic dust removing.

Formulation of Coating Liquid for Alignment

| | | |
|---|---|---|
| Modified polyvinyl alcohol shown below | 40 | parts by mass |
| Water | 728 | parts by mass |
| Methanol | 228 | parts by mass |

Modified polyvinyl alcohol

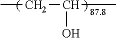

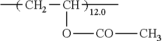

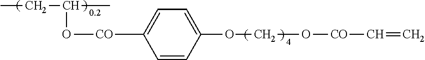

### (5)-4 Formation of the Optically Anisotropic Layer

A coating liquid for the optically anisotropic layer having the formulation mentioned below was continuously applied onto the rubbed surface of the alignment film with a wire bar after being subjected to the ultrasonic dust removing. Then the film was heated in the constant temperature bath of 130 degrees Celsius for 120 seconds, to thereby align the discotic liquid crystal compound. Next, this was irradiated with UV rays by using a high-pressure mercury lamp of which output power was 160 W/cm for 40 seconds at 80 degrees Celsius to thereby carry out the crosslinking reaction to fix the aligned discotic liquid crystal compound. Next, this was left cooled to room temperature.

Formulation of Coating Liquid for Optically Anisotropic Layer

| | | |
|---|---|---|
| Methyl ethyl ketone | 270 | parts by mass |
| Discotic liquid crystal compound A1 shown below | 100 | parts by mass |
| Fluoro-aliphatic group containing polymer 1 | 1.0 | part by mass |
| Agent 1 for controlling alignment at the alignment | 0.5 | part by mass |
| layer side | | |
| Agent 2 for controlling alignment at the alignment | 1.5 | parts by mass |
| layer side | | |
| 4-biphenyl boronic acid | 0.1 | part by mass |
| Photopolymerization initiator (lrgacure 907, by Chiba | 3.0 | parts by mass |
| Japan) | | |
| Sensitizer (Kayacure DETX, by Nippon Kayaku co. ltd) | 1.0 | part by mass |

(A1) 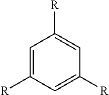 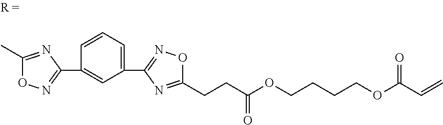
Fluoro-aliphatic group containing polymer 1 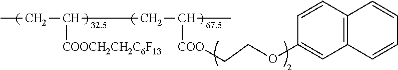
Agent 1 for controlling alignment at the alignment layer side 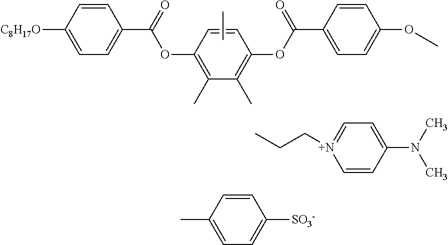
Agent 2 for controlling alignment at the alignment layer side

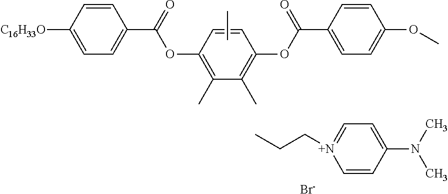

The thickness of the optically anisotropic layer was 1 micro meter, and the upper and lower tilt angles were 20 degrees and 65 degrees respectively.

In this way, Optical compensation film 31 was produced, and Optical compensation films 30 and 32-65 were produced in the same manner as Optical compensation film 31.

### (5)-5 Fabrication of Polarizing Plate

Polarizing plates 42-77 were produced in the same manner as the (2)-5 described above.

### (5)-6 Fabrication of TN-mode Liquid Crystal Display Device

TN-mode liquid crystal display devices 110-145 were produced in the same manner as the (2)-6 described above.

### 6. Evaluation of TN-mode Liquid Crystal Display Device

### (6)-1 Evaluation of Viewing Angle Contrast Ratio

Regarding each of the fabricated TN-mode liquid crystal display devices, the averaged contrast ratios (the white transmittance ratio/the black transmittance ratio) in the vertical (upper and lower) and horizontal (right and left) directions were calculated in the same manner as described above, and then each of the devices was evaluated according to the following criteria.

AA: The obtained value was equal to or more than 50.

A: The obtained value was smaller than 50 and equal to or more than 40.

B: The obtained value was smaller than 40 and equal to or more than 30.

C: The obtained value was smaller than 30.

All of the TN-mode liquid crystal display devices having the cellulose acylate film produced according to the process of the invention were evaluated as “A” or “AA”.

### (6)-2 Evaluation of Yellow Tinge in Oblique-Cross Direction

The brightness of each of the liquid crystal display devices 110-145 was divided equally among eight of from the black state (L1) to the white state (L8); in the second stage (L2) from the black state, the color shift, Δu′v′ (the averaged value in the horizontal direction), was measured in the direction of from the direction at a polar angle 0 degree (the normal line direction) to the direction at a polar angle of 60 degrees; and the level of the yellow tinge was evaluated according to the following criteria. The results were shown in the following tables.

AA: 0.000≦Δu′v′≦0.085

A: 0.085<Δu′v′≦0.090

B: 0.090<Δu′ v′≦0.100

C: 0.100<Δu′v′≦0.105

* Δu′v′: Σ{(u′ₙ− u′ₙ−u′ₙ₋₁)²+(v′ₙ−v′ₙ−u′ₙ₋₁)²}(10 degrees-step from 0 degree to a polar angle of 60 degrees)

| | | | | Example | | | | | | | |
|---|---|---|---|---|---|---|---|---|---|---|---|
| | | | | 13 | 14 | 15 | 16 | 17 | 18 | 19 | 20 |
| Composition | Agent for | Compound | | — | 1 | 2 | 2 | 2 | 2 | 2 | — |
| | controlling | amount (% by mass) | | — | 3.2 | 2.5 | 3.5 | 5 | 7.5 | 3.5 | — |
| | wavelength | | | | | | | | | | |
| | dispersion | | | | | | | | | | |
| | Formulation of | Dicarboxylic | TPA*⁴ | 50 | 50 | 50 | 50 | 50 | 50 | 50 | 50 |
| | Oligomer | acid unit*¹ | PA*⁴ | 0 | 0 | 0 | 0 | 0 | 0 | 0 | 0 |
| | | | AA*⁴ | 50 | 50 | 50 | 50 | 50 | 50 | 50 | 50 |
| | | | SA*⁴ | 0 | 0 | 0 | 0 | 0 | 0 | 0 | 0 |
| | | Diol unit*² | EG*⁴ | 50 | 50 | 50 | 50 | 50 | 50 | 50 | 50 |
| | | | PG*⁴ | 50 | 50 | 50 | 50 | 50 | 50 | 50 | 50 |

| | | Molecular weight*³ | 1000 | 1000 | 1000 | 1000 | 1000 | 1000 | 1000 | 1000 |
|---|---|---|---|---|---|---|---|---|---|---|
| | | amount (% by mass) | 15 | 15 | 15 | 15 | 15 | 15 | 15 | 8 |
| Properties | Re (nm) | | 15 | 15 | 15 | 15 | 15 | 15 | 15 | 15 |
| | Rth (nm) | | 100 | 100 | 100 | 100 | 100 | 100 | 100 | 100 |
| | Rth(450)/Rth(550) | | 0.9 | 1.0 | 1.1 | 1.2 | 1.3 | 1.5 | 1.2 | 0.8 |
| | ΔHc (J/g) | | 3 | 3 | 3 | 3.5 | 3 | 3 | 4 | 4 |
| | Thickness (μm) | | 80 | 65 | 80 | 80 | 70 | 60 | 60 | 100 |
| Conditions | Stretching | PIT draw (%) | 104 | 104 | 104 | 104 | 104 | 104 | 104 | 104 |
| of | | Film-Surface Temperature | 45 | 45 | 45 | 45 | 45 | 45 | 45 | 45 |
| Steps | | (° C.) | | | | | | | | |
| | | TD Stretching (%) | 10 | 10 | 10 | 10 | 10 | 10 | 13 | 10 |
| | | Residual Solvent Amount (%) | 50 | 55 | 45 | 35 | 40 | 40 | 40 | 40 |
| | Heat-treatment | Residual Solvent Amount (%) | 30 | 30 | 30 | 30 | 30 | 30 | 30 | 30 |
| | | Film-Surface Temperature | 80 | 80 | 80 | 70 | 80 | 80 | 60 | 60 |
| | | (° C.) | | | | | | | | |

| | | | | | | | | |
|---|---|---|---|---|---|---|---|---|
| Residual amount of the agent for controlling | — | 99 | 43 | 43 | 43 | 43 | 43 | — |
| wavelength dispersion (% by mass) | | | | | | | | |
| Optical Compensation Film No. | 30 | 31 | 32 | 33 | 34 | 35 | 36 | 37 |
| Polarizing Plate No. | 42 | 43 | 44 | 45 | 46 | 47 | 48 | 49 |
| TN Liquid crystal display device No. | 110 | 111 | 112 | 113 | 114 | 115 | 116 | 117 |
| Evaluation of Yellow Tinge | B | A | AA | AA | AA | AA | AA | C |

| | | | | Example | | | | | | | |
|---|---|---|---|---|---|---|---|---|---|---|---|
| | | | | 21 | 22 | 23 | 24 | 25 | 26 | 27 | 28 |
| Composition | Agent for | Compound | | — | 1 | 2 | 2 | 2 | 2 | 2 | — |
| | controlling | amount (% by mass) | | — | 3.2 | 2.5 | 3.5 | 5 | 7.5 | 3.5 | 1.4 |
| | wavelength | | | | | | | | | | |
| | dispersion | | | | | | | | | | |
| | Formulation | Dicarboxylic | TPA*⁴ | 50 | 50 | 50 | 50 | 50 | 50 | 50 | 50 |
| | of | acid unit*¹ | PA*⁴ | 0 | 0 | 0 | 0 | 0 | 0 | 0 | 0 |
| | Oligomer | | AA*⁴ | 50 | 50 | 50 | 50 | 50 | 50 | 50 | 50 |
| | | | SA*⁴ | 0 | 0 | 0 | 0 | 0 | 0 | 0 | 0 |
| | | Diol unit*² | EG*⁴ | 50 | 50 | 50 | 50 | 50 | 50 | 50 | 50 |
| | | | PG*⁴ | 50 | 50 | 50 | 50 | 50 | 50 | 50 | 50 |

| | | Molecular weight*³ | 1000 | 1000 | 1000 | 1000 | 1000 | 1000 | 1000 | 1000 |
|---|---|---|---|---|---|---|---|---|---|---|
| | | amount (% by mass) | 15 | 15 | 15 | 15 | 15 | 15 | 20 | 22 |
| Properties | Re (nm) | | 15 | 15 | 15 | 15 | 15 | 15 | 15 | 15 |
| | Rth (nm) | | 125 | 125 | 125 | 125 | 125 | 125 | 125 | 125 |
| | Rth(450)/Rth(550) | | 0.9 | 1.0 | 1.1 | 1.2 | 1.3 | 1.5 | 1.2 | 1.0 |
| | ΔHc (J/g) | | 3 | 3 | 3 | 4 | 3 | 3 | 4 | 3 |
| | Thickness (μm) | | 100 | 80 | 100 | 80 | 90 | 75 | 60 | 60 |
| Conditions | Stretching | PIT draw (%) | 104 | 104 | 104 | 104 | 104 | 104 | 104 | 104 |
| of | | Film-Surface Temperature | 45 | 45 | 45 | 45 | 45 | 45 | 45 | 45 |
| Steps | | (° C.) | | | | | | | | |
| | | TD Stretching (%) | 10 | 8 | 10 | 10 | 10 | 10 | 10 | 10 |
| | | Residual Solvent Amount (%) | 40 | 40 | 40 | 40 | 40 | 40 | 40 | 40 |
| | Heat-treatment | Residual Solvent Amount (%) | 25 | 25 | 25 | 25 | 25 | 25 | 25 | 25 |
| | | Film-Surface Temperature | 80 | 60 | 80 | 60 | 80 | 80 | 60 | 80 |
| | | (° C.) | | | | | | | | |

| | | | | | | | | |
|---|---|---|---|---|---|---|---|---|
| Residual amount of the agent for controlling | — | 99 | 45 | 42 | 44 | 43 | 43 | 99 |
| wavelength dispersion (% by mass) | | | | | | | | |
| Optical Compensation Film No. | 38 | 39 | 40 | 41 | 42 | 43 | 44 | 45 |
| Polarizing Plate No. | 50 | 51 | 52 | 53 | 54 | 55 | 56 | 57 |
| TN Liquid crystal display device No. | 118 | 119 | 120 | 121 | 122 | 123 | 124 | 125 |
| Evaluation of Yellow Tinge | B | A | AA | AA | AA | AA | AA | A |

| | | | | Example | | | | |
|---|---|---|---|---|---|---|---|---|
| | | | | 29 | 30 | 31 | 32 | 33 |
| Composition | Agent for | Compound | | — | 1 | 2/3/4 | 2/3/4 | 2/3/4 |
| | Controlling | | | | | (ratio: | (ratio: | (ratio: |
| | Wavelength | | | | | 2/1/2) | 2/2/1) | 2/2/1) |
| | dispersion | amount (% by mass) | | — | 4.0 | 4 | 5 | 5 |
| | Formulation of | Dicarboxylic | TPA*⁴ | 50 | 50 | 50 | 50 | 50 |
| | Oligomer | acid unit*¹ | PA*⁴ | 0 | 0 | 0 | 0 | 0 |
| | | | AA*⁴ | 50 | 50 | 50 | 50 | 50 |
| | | | SA*⁴ | 0 | 0 | 0 | 0 | 0 |
| | | Diol unit*² | EG*⁴ | 50 | 50 | 50 | 50 | 50 |
| | | | PG*⁴ | 50 | 50 | 50 | 50 | 50 |

| | | Molecular weight*³ | 1000 | 1000 | 1000 | 1000 | 1000 |
|---|---|---|---|---|---|---|---|
| | | amount (% by mass) | 8 | 15 | 16 | 15 | 13 |
| Properties | Re (nm) | | 15 | 20 | 10 | 20 | 10 |
| | Rth (nm) | | 125 | 140 | 120 | 150 | 140 |
| | Rth(450)/Rth(550) | | 0.8 | 1.0 | 1.1 | 1.2 | 1.2 |
| | ΔHc (J/g) | | 4 | 2 | 2 | 2 | 2 |
| | Thickness (μm) | | 125 | 80 | 60 | 80 | 80 |
| Conditions | Stretching | PIT draw (%) | 104 | 104 | 103 | 110 | 110 |
| of | | Film-Surface Temperature (° C.) | 45 | 45 | 40 | 45 | 45 |
| Steps | | TD Stretching (%) | 10 | 8 | 10 | 15 | 15 |
| | | Residual Solvent Amount (%) | 45 | 35 | 40 | 40 | 40 |
| | Heat-treatment | Residual Solvent Amount (%) | 25 | 25 | 25 | 25 | 30 |
| | | Film-Surface Temperature (° C.) | 60 | 60 | 85 | 65 | 60 |

| | | | | | |
|---|---|---|---|---|---|
| Residual amount of the agent for controlling | — | 100 | 90 | 95 | 95 |
| wavelength dispersion (% by mass) | | | | | |
| Optical Compensation Film No. | 46 | 47 | 48 | 49 | 50 |
| Polarizing Plate No. | 58 | 59 | 60 | 61 | 62 |
| TN Liquid crystal display device No. | 126 | 127 | 128 | 129 | 130 |
| Evaluation of Yellow Tinge | C | A | AA | AA | AA |

| | | | | Example | | | | |
|---|---|---|---|---|---|---|---|---|
| | | | | 34 | 35 | 36 | 37 | 38 |
| Composition | Agent for | Compound | | 2/3/4 | 4 | 3 | 2/3 | 2/4 |
| | controlling | | | (ratio: 2/2/1) | | | (ratio: 1/1) | (ratio: 1/1) |
| | Wavelength | amount (% by mass) | | 5 | 3 | 3.5 | 3.5 | 5 |
| | dispersion | | | | | | | |
| | Formulation of | Dicarboxylic | TPA*⁴ | 50 | 50 | 50 | 50 | 50 |
| | Oligomer | acid unit*¹ | PA*⁴ | 0 | 0 | 0 | 0 | 0 |
| | | | AA*⁴ | 50 | 50 | 50 | 50 | 50 |
| | | | SA*⁴ | 0 | 0 | 0 | 0 | 0 |
| | | Diol unit*² | EG*⁴ | 50 | 50 | 50 | 50 | 50 |
| | | | PG*⁴ | 50 | 50 | 50 | 50 | 50 |

| | | Molecular weight*³ | 1000 | 1000 | 1000 | 1000 | 1000 |
|---|---|---|---|---|---|---|---|
| | | amount (% by mass) | 10 | 15 | 10 | 15 | 13 |
| Properties | Re (nm) | | 10 | 20 | 10 | 20 | 10 |
| | Rth (nm) | | 135 | 150 | 135 | 150 | 140 |
| | Rth(450)/Rth(550) | | 1.2 | 1.0 | 1.2 | 1.2 | 1.1 |
| | ΔHc (J/g) | | 2 | 2 | 2 | 2 | 2 |
| | Thickness (μm) | | 80 | 80 | 80 | 80 | 80 |
| Conditions | Stretching | PIT draw (%) | 110 | 108 | 110 | 106 | 110 |
| of | | Film-Surface Temperature | 45 | 45 | 45 | 45 | 45 |
| Steps | | (° C.) | | | | | |
| | | TD Stretching (%) | 15 | 12 | 15 | 15 | 15 |
| | | Residual Solvent Amount (%) | 40 | 40 | 40 | 40 | 40 |
| | Heat-treatment | Residual Solvent Amount (%) | 23 | 25 | 28 | 25 | 25 |
| | | Film-Surface Temperature | 60 | 65 | 60 | 65 | 60 |
| | | (° C.) | | | | | |

| | | | | | |
|---|---|---|---|---|---|
| Residual amount of the agent for controlling | 95 | 99 | 98 | 90 | 75 |
| wavelength dispersion (% by mass) | | | | | |
| Optical Compensation Film No. | 51 | 52 | 53 | 54 | 55 |
| Polarizing Plate No. | 63 | 64 | 65 | 66 | 67 |
| TN Liquid crystal display device No. | 131 | 132 | 133 | 134 | 135 |
| Evaluation of Yellow Tinge | AA | A | AA | AA | AA |

| | | | | Example | | | |
|---|---|---|---|---|---|---|---|
| | | | | 39 | 40 | 41 | 42 |
| Composition | Agent for | Compound | | 2/4 | 2/4 | 2/5/4 | 5 |
| | Controlling | | | (ratio: 1/1) | (ratio: 1/1) | (ratio: 2/2/1) | |
| | Wavelength | amount (% by mass) | | 5 | 5 | 5 | 3.5 |
| | dispersion | | | | | | |
| | Formulation of | Dicarboxylic | TPA*⁴ | 50 | 50 | 50 | 50 |
| | Oligomer | acid unit*¹ | PA*⁴ | 0 | 0 | 0 | 0 |
| | | | AA*⁴ | 50 | 50 | 50 | 50 |
| | | | SA*⁴ | 0 | 0 | 0 | 0 |
| | | Diol unit*² | EG*⁴ | 50 | 50 | 50 | 50 |
| | | | PG*⁴ | 50 | 50 | 50 | 50 |

| | | Molecular weight*³ | 1000 | 1000 | 1000 | 1000 |
|---|---|---|---|---|---|---|
| | | amount (% by mass) | 10 | 13 | 10 | 12 |
| Properties | Re (nm) | | 10 | 20 | 10 | 20 |
| | Rth (nm) | | 135 | 150 | 135 | 150 |
| | Rth(450)/Rth(550) | | 1.1 | 1.1 | 1.2 | 1.2 |
| | ΔHc (J/g) | | 2 | 2 | 2.5 | 2 |
| | Thickness (μm) | | 80 | 80 | 60 | 80 |
| Conditions | Stretching | PIT draw (%) | 110 | 110 | 104 | 108 |
| of | | Film-Surface Temperature | 45 | 45 | 45 | 45 |
| Steps | | (° C.) | | | | |
| | | TD Stretching (%) | 15 | 12 | 10 | 12 |
| | | Residual Solvent Amount (%) | 40 | 40 | 40 | 40 |
| | Heat-treatment | Residual Solvent Amount (%) | 28 | 25 | 30 | 25 |
| | | Film-Surface Temperature | 60 | 60 | 80 | 60 |
| | | (° C.) | | | | |

| | | | | |
|---|---|---|---|---|
| Residual amount of the agent for controlling | 78 | 76 | 96 | 99 |
| wavelength dispersion (% by mass) | | | | |
| Optical Compensation Film No. | 56 | 57 | 58 | 59 |
| Polarizing Plate No. | 68 | 69 | 70 | 71 |
| TN Liquid crystal display device No. | 136 | 137 | 138 | 139 |
| Evaluation of Yellow Tinge | AA | AA | AA | AA |

| | | | | Example | | | |
|---|---|---|---|---|---|---|---|
| | | | | 43 | 44 | 45 | 46 |
| Composition | Agent for | Compound | | 2/5 | 2/4 | 2/5/4 | 2/5 |
| | controlling | | | (ratio: 1/1) | (ratio: 1/1) | (ratio: 2/2/1) | (ratio: 1/1) |
| | Wavelength | amount (% by mass) | | 3.5 | 5 | 5 | 5 |
| | dispersion | | | | | | |
| | Formulation of | Dicarboxylic | TPA*⁴ | 50 | 60 | 55 | 50 |
| | Oligomer | acid unit*¹ | PA*⁴ | 0 | 0 | 5 | 0 |
| | | | AA*⁴ | 50 | 40 | 40 | 40 |
| | | | SA*⁴ | 0 | 0 | 10 | 10 |
| | | Diol unit*² | EG*⁴ | 50 | 40 | 50 | 50 |
| | | | PG*⁴ | 50 | 60 | 50 | 50 |

| | | Molecular weight*³ | 1000 | 800 | 900 | 900 |
|---|---|---|---|---|---|---|
| | | amount (% by mass) | 12 | 12 | 13 | 14 |
| Properties | Re (nm) | | 10 | 20 | 10 | 10 |
| | Rth (nm) | | 135 | 150 | 140 | 135 |
| | Rth(450)/Rth(550) | | 1.2 | 1.1 | 1.2 | 1.3 |
| | ΔHc (J/g) | | 2 | 2 | 2 | 2 |
| | Thickness (μm) | | 80 | 80 | 80 | 80 |
| Conditions | Stretching | PIT draw (%) | 108 | 110 | 110 | 108 |
| of | | Film-Surface Temperature | 45 | 45 | 45 | 45 |
| Steps | | (° C.) | | | | |
| | | TD Stretching (%) | 15 | 15 | 15 | 12 |
| | | Residual Solvent Amount | 40 | 40 | 40 | 40 |
| | | (%) | | | | |
| | Heat-treatment | Residual Solvent Amount | 25 | 30 | 23 | 25 |
| | | (%) | | | | |
| | | Film-Surface Temperature | 60 | 60 | 60 | 65 |
| | | (° C.) | | | | |

| | | | | |
|---|---|---|---|---|
| Residual amount of the agent for controlling | 94 | 73 | 96 | 92 |
| wavelength dispersion (% by mass) | | | | |
| Optical Compensation Film No. | 60 | 61 | 62 | 63 |
| Polarizing Plate No. | 72 | 73 | 74 | 75 |
| TN Liquid crystal display device No. | 140 | 141 | 142 | 143 |
| Evaluation of Yellow Tinge | AA | AA | AA | AA |

| | | | | Example | |
|---|---|---|---|---|---|
| | | | | 47 | 48 |
| Composition | Agent for controlling | Compound | | 2/3/4 | 2/3/4 |
| | wavelength dispersion | | | (ratio: 2/1/2) | (ratio: 2/1/2) |
| | | amount (% by mass) | | 4.5 | 3 |
| | Formulation of | Dicarboxylic | TPA*⁴ | 50 | 50 |
| | Oligomer | acid unit*¹ | PA*⁴ | 0 | 0 |
| | | | AA*⁴ | 50 | 50 |
| | | | SA*⁴ | 0 | 0 |
| | | Diol unit*² | EG*⁴ | 50 | 50 |
| | | | PG*⁴ | 50 | 50 |

| | | Molecular weight*³ | 1000 | 1000 |
|---|---|---|---|---|
| | | amount (% by mass) | 12 | 14 |
| properties | Re (nm) | | 10 | 10 |
| | Rth (nm) | | 135 | 120 |
| | Rth(450)/Rth(550) | | 1.2 | 1.1 |
| | ΔHc (J/g) | | 2 | 3 |
| | Thickness (μm) | | 80 | 80 |
| Conditions | Stretching | PIT draw (%) | 103 | 103 |
| of | | Film-Surface Temperature | 50 | 45 |
| Steps | | (° C.) | | |
| | | TD Stretching (%) | 12 | 12 |
| | | Residual Solvent Amount (%) | 40 | 40 |
| | Heat-treatment | Residual Solvent Amount (%) | 23 | 23 |
| | | Film-Surface Temperature | 65 | 60 |
| | | (° C.) | | |

| | | |
|---|---|---|
| Residual amount of the agent for controlling wavelength | 90 | 90 |
| dispersion (% by mass) | | |
| Optical Compensation Film No. | 64 | 65 |
| Polarizing Plate No. | 76 | 77 |
| TN Liquid crystal display device No. | 144 | 145 |
| Evaluation of Yellow Tinge | AA | AA |

In the tables,
*¹“TPA” indicates terephthalic acid; “AA” indicates adipic acid; “SA” indicates succin acid.
*²“EG” indicates ethane diol; and “PG” indicates 1,3-propane diol.
*³The number-averaged molecular weight
*⁴The unit of “TPA”, “PA”, “AA”, “SA”, “EG” or “PG” is a molar ratio.

And Compounds I-5 in the tables are as follows:

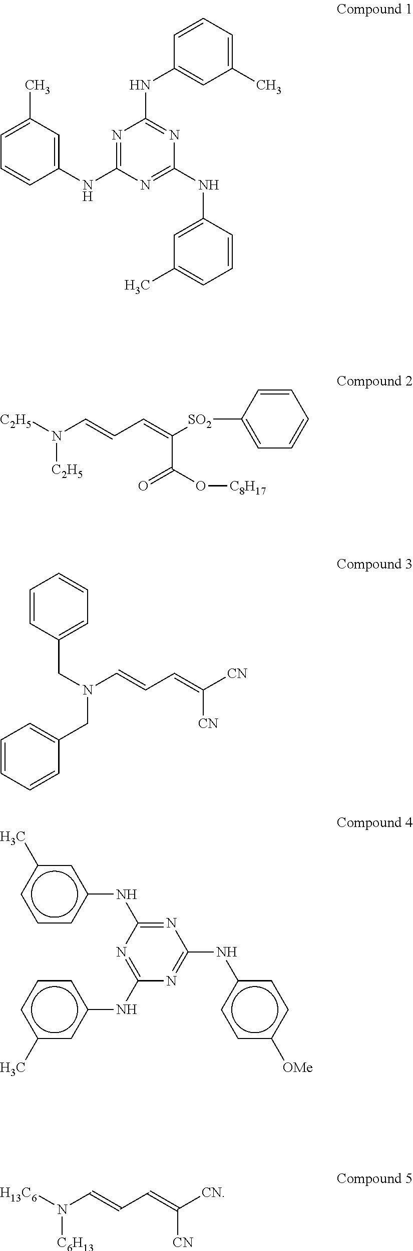

From the data in the tables, it is understandable that the cellulose acylate films of Examples 13-48, which were produced according to the process of the invention, exhibit Re of from 5 to 20 nm and Rtn of from 90-150 nm and are useful as the optical film for a liquid crystal display device employing a twisted-alignment mode. And in fact, the evaluations regarding the viewing-angle contrast ratio in the vertical and horizontal directions of the

It is understandable also that the yellow tinge occurring in the oblique cross direction can be reduced remarkably when the cellulose acylate film satisfying the relation of 0.90<Rth(450)/Rth(550)≦1.5 is used in the TN-mode liquid crystal display device as the cellulose acylate produced according to the process of the invention. And it is understandable also that adding the agent for controlling the wavelength dispersion along with the aromatic group-containing oligomer is effective for controlling the wavelength dispersion.

And it is understandable also that using the mixture of the compound represented by formula (IX) and any of the compounds (Compound 3 or 5) represented by formulas (IX-a)-(IX-d) is effective for improving the lightness.

1. A process of producing a cellulose acylate film comprising:
a forming step of forming a web of a fluid, comprising a cellulose acylate, aromatic group-containing oligomer and solvent, by casting the fluid onto a support,
a stretching step of stretching the web, thereby to align molecules of the aromatic group-containing oligomer along the stretching direction, and
a heat-treatment step of subjecting the stretched web to a heat treatment, thereby to at least increase the alignment degree of molecules of the aromatic group-containing oligomer.

2. The process of claim 1, wherein the aromatic group-containing oligomer is a polycondensation ester comprising a residue of aromatic dicarboxylic acid and a residue of aliphatic diol.

3. The process of claim 1, wherein the number-averaged molecular weight of the aromatic group-containing oligomer is from 500 to 2000.

4. The process of claim 1, wherein the fluid comprises the aromatic group-containing oligomer in an amount of from 3 to 20 parts by mass with respect to 100 parts by mass of the cellulose acylate.

5. The process of claim 1, wherein, in the stretching step, the web having a residual solvent content of from 20 to 300% by mass is stretched at a film-surface temperature of from −30 to 80 degrees Celsius.

6. The process of claim 1, wherein, in the heat-treatment step, the web having a residual solvent amount of from 10 to 120% by mass is subjected to a heat treatment at a film-surface temperature of from 40 to 200 degrees Celsius.

7. The process of claim 1, wherein, in the stretching step, the web is stretched at a stretching ratio of from 1 to 50%.

8. The process of claim 1, wherein the fluid is cast onto a surface of a drum.

9. The process of claim 1, wherein, in the stretching step, the web is stretched along a casting direction and a direction perpendicular to the casting direction.

10. The process of claim 1, wherein the web is not subjected to any stretching treatment after the stretching step.

11. The process of claim 1, wherein the fluid comprises a retardation-controlling agent having an absorption peak at a wavelength of from 250 to 400 nm in an amount of from 0.2 to 20% by mass.

12. The process of claim 11, wherein the retardation-controlling agent is a merocyanine compound represented by formula (IX): 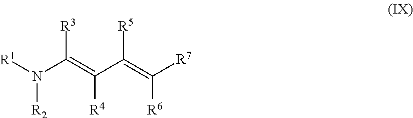
where, in formula (IX), N represents a nitrogen atom; and R¹-R⁷ respectively represents a hydrogen atom or substituent.

13. The process of claim 12, wherein the merocyanine compound represented by formula (IX) is used as a mixture with any compound(s) represented by formula (IXa-a), (IXa-b), (IXa-c) or (IXa-d): 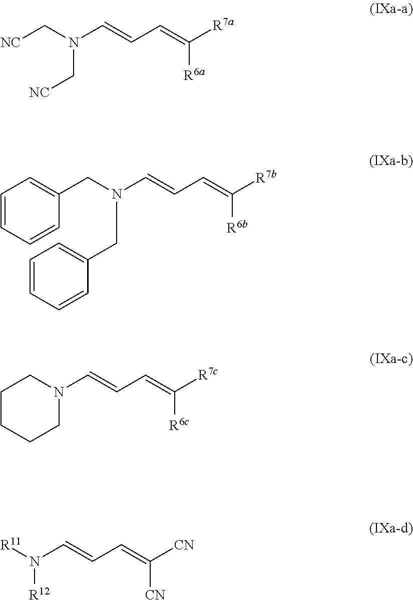
where, in formula (IXa-a), R^{6a} and R^{7a} respectively represent a hydrogen atom or substituent; in formula (IXa-b), R^{6b} and R^{7b} respectively represent a hydrogen atom or substituent; in formula (IXa-c), R^{6c} and R^{7c} respectively represent a hydrogen atom or substituent; in formula (IXa-d), R¹¹ and R¹² respectively represent an alkyl, aryl, cyano, or COOR¹³ where R¹³ represents an alkyl group, aryl group or heterocyclic group; or R¹¹ and R¹² may bond to each other to form a ring containing a nitrogen atom.

14. The process of claim 1, wherein the fluid comprises a triazine compound represented by formula (II): 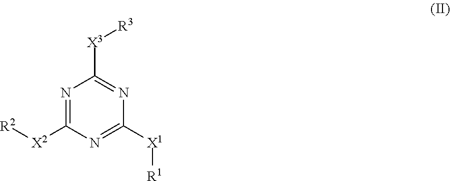
where, in formula (II), X¹ represents —NR⁴—, —O— or —S—; X² represents —NR^{S}—, —O— or —S—; X³ represents —NR⁶—, —O— or —S—; R¹, R², and R³ respectively represent an alkyl group, an alkenyl group, an aryl group or a heterocyclic group; and R⁴, R⁵ and R⁶ respectively represent a hydrogen atom, an alkyl group, an alkenyl group, an aryl group or a heterocyclic group.

15. A cellulose acylate film produced according to a process comprising:
a forming step of forming a web of a fluid, comprising a cellulose acylate, aromatic group-containing oligomer and solvent, by casting the fluid onto a support,
a stretching step of stretching the web, thereby to align molecules of the aromatic group-containing oligomer along the stretching direction, and
a heat-treatment step of subjecting the stretched web to a heat treatment, thereby to at least increase the alignment degree of molecules of the aromatic group-containing oligomer,
wherein retardation in plane at 550 nm wavelength, Re(550)m, is from 5 to 50 nm and retardation along the thickness direction at 550 nm wavelength, Rth(550), is from 90 to 150 nm.

16. The cellulose acylate film of claim 15, wherein said retardation in said plane at 550 nm wavelength, Re(550)m, is from 5 to 20 nm.

17. The cellulose acylate film of claim 15, having a long direction, in which cellulose acylate molecules are aligned along the long direction.

18. The cellulose acylate film of claim 15, of which retardation along the thickness direction at 550 nm wavelength, Rth(550)ₘ, and retardation along the thickness direction at 450 nm wavelength, Rth(450), fulfill the condition of (1) below:
0.90<Rth(450)/Rth(550)≦1.5 (1)

19. A polarizing plate comprising a polarizer and a cellulose acylate film produced according to a process comprising:
a forming step of forming a web of a fluid, comprising a cellulose acylate, aromatic group-containing oligomer and solvent, by casting the fluid onto a support,
a stretching step of stretching the web, thereby to align molecules of the aromatic group-containing oligomer along the stretching direction, and
a heat-treatment step of subjecting the stretched web to a heat treatment, thereby to at least increase the alignment degree of molecules of the aromatic group-containing oligomer, of which retardation in plane at 550 nm wavelength, Re(550)m, is from 5 to 50 nm and retardation along the thickness direction at 550 nm wavelength, Rth(550), is from 90 to 150 nm.

20. The polarizing plate of claim 19, wherein an absorption axis of the polarizer is perpendicular to a slow axis of the cellulose acylate film.

21. A liquid crystal displaying device comprising a cellulose acylate film produced according to a process comprising:
a forming step of forming a web of a fluid, comprising a cellulose acylate, aromatic group-containing oligomer and solvent, by casting the fluid onto a support,
a stretching step of stretching the web, thereby to align molecules of the aromatic group-containing oligomer along the stretching direction, and
a heat-treatment step of subjecting the stretched web to a heat treatment, thereby to at least increase the alignment degree of molecules of the aromatic group-containing oligomer, of which retardation in plane at 550 nm wavelength, Re(550)m, is from 5 to 50 nm and retardation along the thickness direction at 550 nm wavelength, Rth(550), is from 90 to 150 nm.

22. The liquid crystal displaying device of claim 21, wherein said liquid crystal displaying device further comprises a polarizing plate having a polarizer and said cellulose acylate.

23. The liquid crystal displaying device of claim 21, employing a twisted alignment or vertical alignment mode.

24. The liquid crystal displaying device of claim 22, employing a twisted alignment or vertical alignment mode.

25. An optical compensation film comprising a cellulose acylate film of produced according to a process comprising:
a forming step of forming a web of a fluid, comprising a cellulose acylate, aromatic group-containing oligomer and solvent, by casting the fluid onto a support,
a stretching step of stretching the web, thereby to align molecules of the aromatic group-containing oligomer along the stretching direction, and
a heat-treatment step of subjecting the stretched web to a heat treatment, thereby to at least increase the alignment degree of molecules of the aromatic group-containing oligomer, of which retardation in plane at 550 nm wavelength, Re(550)m, is from 5 to 50 nm and retardation along the thickness direction at 550 nm wavelength, Rth(550), is from 90 to 150 nm, and
an optically anisotropic layer formed of a composition comprising a polymerizable liquid crystal compound.
